(19) United States
(12) Patent Application Publication
(10) Pub. No.: US 2026/0279009 A1
(43) Pub. Date: Sep. 17, 2026

(54) OPEN-DOOR COLLISION DETECTION AND AVOIDANCE

(71) Applicant: Nvidia Corporation, Santa Clara, CA (US)

(72) Inventors: Lin Chen, Shanghai (CN); Yonglei Zhao, Shanghai (CN); Allen Shen, Shanghai (CN); Qiwei Song, Shanghai (CN); Yatao Zhou, Shanghai (CN); Qin Lin, Luzhou (CN); Patrick Liu, Encinitas, CA (US); Sangmin Oh, San Jose, CA (US); Feng Han, San Diego, CA (US); Minwoo Park, Saratoga, CA (US)

(21) Appl. No.: 19/566,596

(22) Filed: Mar. 13, 2026

Related U.S. Application Data
(60) Provisional application No. 63/773,165, filed on Mar. 17, 2025.

(30) Foreign Application Priority Data
Mar. 10, 2026 (CN) 2026102887987

(51) Int. Cl. G06V 10/764; B60W 30/09; G06T 15/00; G06V 10/82; G06V 20/56

(52) U.S. Cl. CPC G06V 10/764; B60W 30/09; G06T 15/00; G06V 10/82; G06V 20/56

(57) ABSTRACT

Systems and methods disclosed herein may include or may use one or more processors configured to predict an open-door of a vehicle. The prediction may be based in part on a bounding box applied to a representation of the vehicle and used with a first machine learning (ML) model. The first ML model may be trained using bounding boxes for different vehicles having one or more of closed doors or open doors. A classification may be performed for the open-door as a specific type based in part on at least one portion of the representation used with a second ML model which is trained with classes of different types of the open doors for the different vehicles.

### CROSS-REFERENCE TO RELATED APPLICATIONS

This application claims the benefit of priority to Chinese Patent Application No. 2026102887987, filed Mar. 10, 2026, and entitled “OPEN-DOOR COLLISION DETECTION AND AVOIDANCE,” and also claims the benefit of priority from U.S. Provisional Patent Application Number 63/773,165, filed Mar. 17, 2025, and entitled “OPEN-DOOR DETECTION FOR SEMI-AUTONOMOUS AND AUTONOMOUS SYSTEMS AND APPLICATIONS,” the entire disclosures of both of which are incorporated by reference herein for all intents and purposes.

### TECHNICAL FIELD

This disclosure generally relates to detection and/or prediction made by an autonomous or semi-autonomous vehicle and, in one aspect, specifically relates to open-door collision detection and avoidance for such vehicles.

### BACKGROUND

An ability to detect and identify obstacles and objects during driving or navigation is a requirement of any semi-autonomous or autonomous system—such as those of a vehicle, robot, warehouse machine, and/or other machine type. For example, the ability to detect open doors—such as those of other vehicles or machines in the environment—is important for ensuring safety of an ego (or first-person) machine, as well as the safety of those of the other vehicles or machines whose doors may be open. When an open door goes undetected, the ego machine may not maneuver around the open door and/or may not slow down prior to reaching the door, which may reduce the overall safety of the system. Open-door detection may focus on a classical object detector to identify the vehicle or machine as a wider (such as for side doors that are open) or longer (such as for trunk doors that are open) and may update an occupancy grid or other representation to indicate an amount of space occupied by the vehicle or machine. Such approaches of including the open door as part of a vehicle size may result in an inaccurate geometry for the vehicle. In addition, an increase to a bounding box and perceived geometry of the vehicle or machine may omit other contextual or useful information—such as changes in a likelihood of a person being present in front of or behind the door, or that a person is likely to exit the vehicle via the open door. The ego machine may not make appropriate corrections and take the necessary precautions, given an increased likelihood of current or imminent human presence. Similarly, for rear or trunk doors that are open, the detection of the vehicle or machine as longer than it actually is may not allow the ego machine to reason about the current situation or context, such as that the vehicle or machine is likely parked and may remain in position for some time (such as to load or unload goods) because its door is open.

### BRIEF DESCRIPTION OF DRAWINGS

The present systems and methods for detection and/or prediction made by an autonomous or semi-autonomous vehicle in support of an open-door collision detection and avoidance are described in detail below with reference to the attached drawing figures, wherein:

FIG. 1A illustrates a system for detection and/or prediction made by an autonomous or semi-autonomous vehicle in support of an open-door collision detection and avoidance, in at least some embodiments;

FIG. 1B illustrates processing aspects used for detection and/or prediction made by an autonomous or semi-autonomous vehicle in support of an open-door collision detection and avoidance, in at least some embodiments;

FIG. 2A illustrates bounding box details for detection and/or prediction made by an autonomous or semi-autonomous vehicle in support of an open-door collision detection and avoidance, in at least some embodiments;

FIG. 2B illustrates further bounding box details for detection and/or prediction made by an autonomous or semi-autonomous vehicle in support of an open-door collision detection and avoidance, in at least some embodiments;

FIG. 3 illustrates details associated with artificial intelligence (AI)/machine learning (ML) for open-door collision detection and avoidance, according to at least some embodiments;

FIG. 4 illustrates computer and processor aspects used by a system in support of open-door collision detection and avoidance, according to at least some embodiments;

FIG. 5 illustrates a process flow used by a system for open-door collision detection and avoidance, according to at least some embodiments;

FIG. 6 illustrates a further process flow used by a system for open-door collision detection and avoidance, according to at least some embodiments;

FIG. 7 illustrates a process flow using two-dimensional (2D) and three-dimensional (3D) information in support of open-door collision detection and avoidance, according to at least some embodiments;

FIG. 8 illustrates an example datacenter to apply at least one embodiment in FIGS. 1A-7;

FIG. 9 is a block diagram of an example architecture of a computing system—such as a system-on-a-chip (SoC)—applicable to at least one embodiment in FIGS. 1A-8 and in accordance with at least some embodiments herein;

FIG. 10A illustrates example autonomous or semi-autonomous machines which benefit from open-door collision detection and avoidance, in accordance with at least some embodiments of the present disclosure;

FIG. 10B illustrates an example of component and sensor locations on an autonomous or semi-autonomous vehicle which includes open-door collision detection and avoidance, in accordance with at least some embodiments of the present disclosure;

FIG. 10C is a block diagram of an example system architecture for an autonomous or semi-autonomous vehicle, robot, and/or other machine type, in accordance with at least some embodiments of the present disclosure;

FIG. 10D is a block diagram of an example architecture of a computing system—such as a system-on-a-chip (SoC)—in accordance with at least some embodiments of the present disclosure;

FIG. 10E is a system diagram for communication between cloud-based server(s) and an example autonomous or semi-autonomous vehicle, robot, and/or other machine type, in accordance with at least some embodiments of the present disclosure;

FIG. 11 is a system diagram illustrating a three computer ecosystem, including a computing system for generating or creating artificial intelligence (AI)—such as AI training and validation data, a computing system for training artificial intelligence, and a computing system deploying the AI at the edge, in accordance with at least some embodiments of the present disclosure;

FIG. 12 is a block diagram of an example computing system for generative artificial intelligence (AI), in accordance with at least some embodiments of the present disclosure; and

FIG. 13 is a block diagram of an example computing device, in accordance with at least some embodiments of the present disclosure.

### DETAILED DESCRIPTION

To address issues with respect to door detection and avoidance in vehicles, an active and explicit open-door (including open-trunk) detection may be performed. This may increase an overall safety of a system with respect to an ego machine and with vehicles in a line of sight of the ego machine. This may also allow the ego machine to more precisely reason through scenarios involving an open-door detection and/or prediction. The detection and/or prediction may be made by an autonomous or semi-autonomous vehicle which represents the ego machine. The detection and/or prediction may be made with respect to an open door detected in a line of sight during a driving route and as part of a collision avoidance system.

In some examples, the detection and/or prediction may be performed by a dual-machine learning (ML) system. A first ML model may be a predictor and a second ML model may be a classifier. The first ML model may use an image, as part of two-dimensional (2D) information, from a 2D sensor (such as one of the onboard cameras) to predict an open-door for at least one vehicle in the driving route. This prediction may be based in part on dimensions of a bounding box associated with the vehicle being captured by the 2D sensor. As such, the first ML model may include training with bounding boxes for vehicles having one or more of closed or open doors. Once predicted, a portion of the image may be used with a second ML classifier to make an explicit classification of a specific type of the open-door prediction, such as a type of door which may be a left door, a right door, a rear door or trunk, and the like. In some examples, the portion of the image may have an extended dimension taken with reference to the captured bounding box and with respect to trained bounding boxes. In some examples, the portion of the image may be at a predetermined width from an edge of a captured bounding box. Further, the second ML model may allow a tag or a label to be provided for the portion of the image once the classification is complete. The tag or label may indicate the type of door based on the classification. The tag or label may be used in a 2D-3D conversion sub-system to illustrate a specific open door for a display representation within the autonomous or semi-autonomous vehicle of the vehicle having the open door. In addition, a driving sub-system of the autonomous or semi-autonomous vehicle may indicate a status or may perform or recommend a reaction to the open door based on the tag or label. In an example, the door being open may be an indication of the vehicle being stopped and unable to move. A reaction may be for the autonomous or semi-autonomous vehicle to go around the vehicle as part of an open-door collision detection and avoidance performed in the autonomous or semi-autonomous vehicle.

In some examples, the 2D sensor may also include, other than a camera, one or more of Light Detection and Ranging (LiDARs), Radio Detection and Ranging (RADARs), ultrasonic sensors, or the like. The 2D-3D conversion sub-system may provide an illustration for the display representation as a top-down or bird's eye view (BEV) representation of the environment around the vehicle and a specific door being open according to the type of the open door. The type may be an explicit indication or signal of a door-open for a vehicle in a driving route may remove guesswork based on a geometric size alone. With a known status, the autonomous or semi-autonomous vehicle may be able to plan and control, as part of the driving sub-system, an action or a reaction, such as to perform the drive around (as the door open may be an indication of a prolonged wait behind the vehicle—for unloading items), to slow down, to stop, to maintain a larger margin or gap to the vehicle, to account for possible humans exiting the vehicle, or to nudge left or right to travel safely around the vehicle.

In some examples, the explicit open-door or open-trunk detection of a target vehicle and performed for semi-autonomous and autonomous systems and applications may include explicit prediction of a trunk- or door-open status of the target vehicle or machine, such as using 2D and/or 3D object detectors or sensors. The 2D and/or 3D object detectors or sensors may include cameras, LiDARs, RADARs, ultrasonic sensors, and/or the like. Once detected, such as using the 2D sensor or object detectors which may include front cameras of the ego machine, a 2D to 3D conversion may be performed. The 2D to 3D conversion may be used to map the trunk-open or door-open information to a 3D space. In some examples, the 3D space may include a top-down or BEV representation of the environment. As a result, the systems and methods presented herein may facilitate an explicit state of a “trunk-open” or “door-open” signal (as a status) for a specific vehicle or machine, without guessing such a status from geometric size alone. Once the state or status is known, the ego machine planning and control system (also referenced herein as a driving sub-system) may react to the target vehicle or machine in a more reasonable manner, with knowledge of whether a person is likely to be present now or imminently. This understanding may allow for better reasoning by the ego machine, such as to drive around a vehicle unloading items from the trunk, to slow down or stop when a side door is opened into the street in order to account for humans, to nudge left or right to travel safely around a vehicle or machine stopped for a delivery or other purpose, and so on. This better reasoning leads to safer planning and control for the ego machine, resulting in a more trustworthy and capable ego machine.

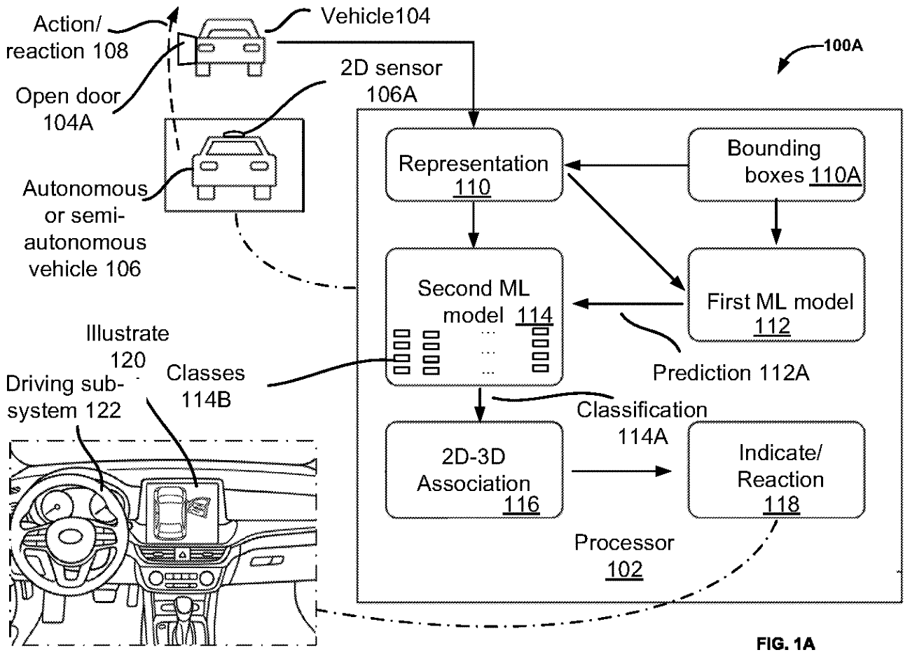

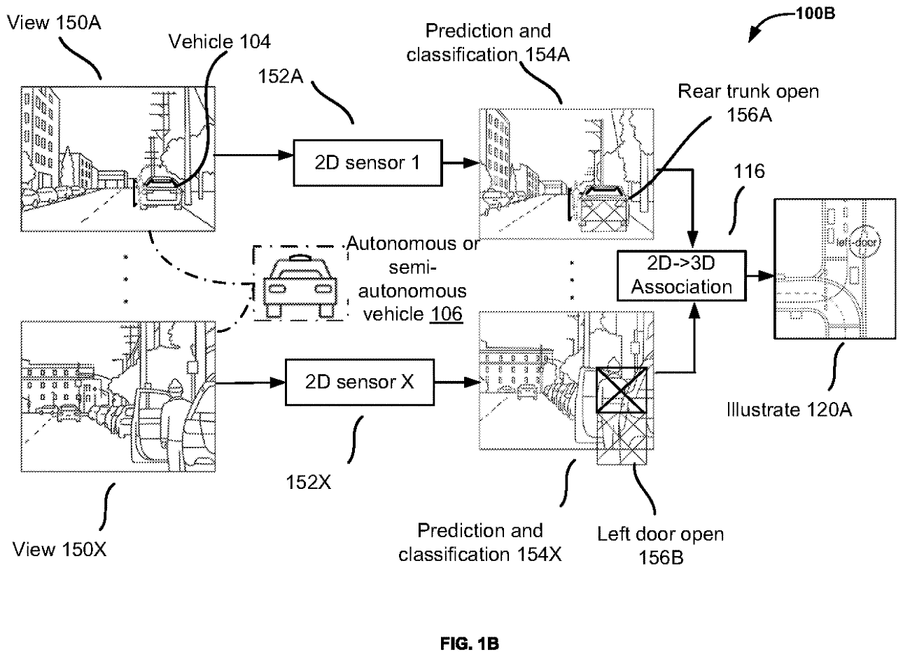

FIG. 1A illustrates a system 100A for detection and/or prediction made by an autonomous or semi-autonomous vehicle in support of an open-door collision detection and avoidance, in at least some embodiments. The system 100A may include at least one processor 102. The processor 102 may be within an autonomous or semi-autonomous vehicle 106 or may be remote from the autonomous or semi-autonomous vehicle 106 and may provide input to the autonomous or semi-autonomous vehicle 106. The processor 102 may perform instructions from a memory associated with the autonomous or semi-autonomous vehicle 106. The processor 102 performing the instructions may be caused to perform functions. For example, the processor 102 may be used to predict an open door 104A of a vehicle 104. Such a prediction 112A may occur within an autonomous or semi-autonomous vehicle 106. The prediction 112A may be used by the autonomous or semi-autonomous vehicle 106 to perform an action or reaction 108 (such as to drive around) the vehicle 104. While driving around is illustrated, the action or reaction 108 may be to slow down, to stop, to maintain a larger margin or gap to the vehicle, to account for possible humans exiting the vehicle, or to nudge left or right to travel safely around the vehicle. The prediction may be based in part on a bounding box applied to a representation 110 of the vehicle 104. For example, the representation 110 may be used with a first ML model 112 which may be trained using bounding boxes 110A for different vehicles having one or more of closed doors or open doors.

FIG. 1A illustrates that in addition to the prediction 112A, a classification 114A may be performed to classify the open door 104A as a specific type based in part on at least one portion of the representation 110 used with a second ML model 114 trained with classes 114B of different types of the open doors for the different vehicles. In addition, the processor 102 may be configured (such as by performing or executing the instructions) to provide, using a 2D sensor 106A, the representation 110 in 2D information. The processor 102 may be configured to use a 2D-to-3D conversion sub-system (illustrated by the 2D-3D association 116 in FIG. 1A) to illustrate 120 the open door 104A of the vehicle 104 (such as on the dashboard of the autonomous or semi-autonomous vehicle 106) in 3D information based in part on an output of the second ML model 114. In some examples, the 2D-to-3D conversion sub-system may allow an indication or reaction 118 through the illustration 120 or through the driving sub-system 122. In some examples, instead of or in addition to the illustration 120, the processor 102 may be part of (such as inside or included or support) the driving sub-system 122 of an autonomous or semi-autonomous vehicle 106 to perform the reaction. In some examples, the processor 102 may be configured to perform or recommend the action or reaction 108 to the open door 104A through the dashboard or through other feedback to a driver in the case of a semi-autonomous vehicle.

FIG. 1A also illustrates that the processor 102 may be part of the 2D-to-3D conversion sub-system and which may be used to generate or support the illustration 120 of a top-down or BEV representation, which may be an open-door signal of the open door 104A of the vehicle 104. In some examples, the 2D sensor 106A is an onboard camera of an autonomous or semi-autonomous vehicle 106. In some examples, the specific type supported by the classification 114A performed may be one of a left passenger door open, a right passenger door open, a left driver door open, a right driver door open, a left door open, a right door open, a rear door open, a moonroof or sunroof open, or a bonnet open.

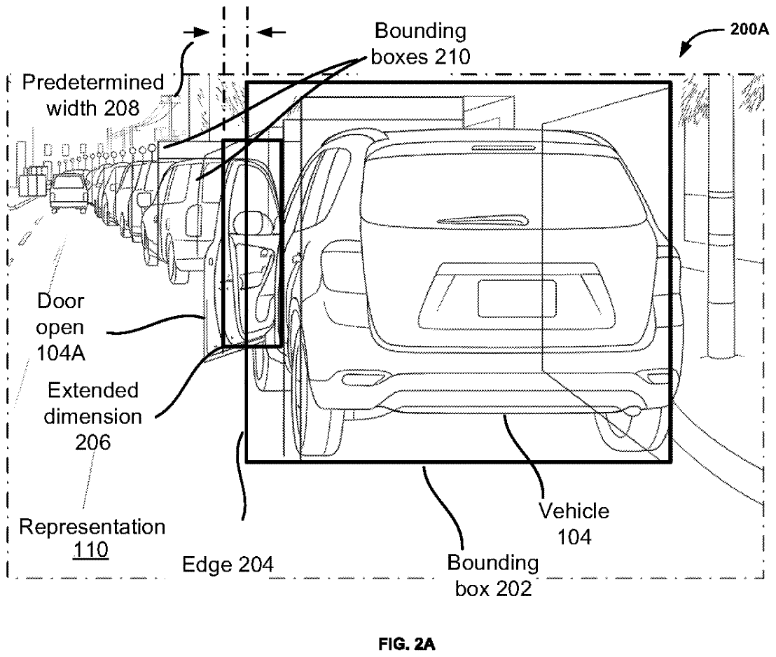

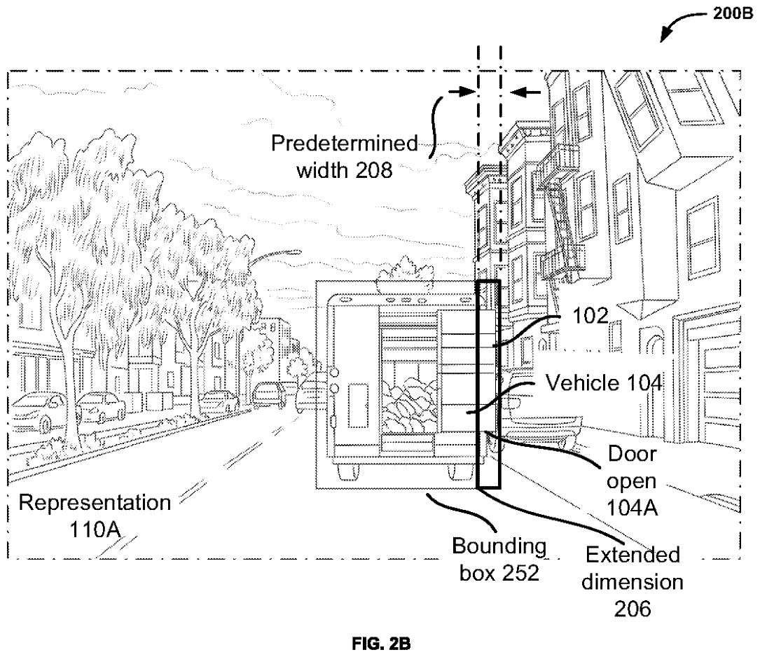

As such, in some examples, the processor 102 may be one or more processors. The one or more processors may be used to train an ML model (such as the second ML model 114) to determine a specific type of an open-door of a vehicle 104 using different classes 114B associated with different types of the open doors for different vehicles. The one or more processors may be further to train an additional ML model (such as a first ML model 112) to predict the open-door of the vehicle based in part on different bounding boxes for different vehicles having one or more of closed doors or open doors, such as described in connection with FIGS. 2A and 2B. The specific type may be one of a left passenger door open, a right passenger door open, a left driver door open, a right driver door open, a left door open, a right door open, a rear door open, a moonroof or sunroof open, or a bonnet open. The one or more processors may be used to or configured to determine a specific type of an open-door of a vehicle 104 based in part on an ML model (such as a second ML model 114) which is trained using different classes associated with different types of open doors for different vehicles, and used after a first ML model is used to make a prediction of a potential open door 104A for the vehicle 104.

FIG. 1B illustrates processing aspects 100B used for detection and/or prediction made by an autonomous or semi-autonomous vehicle in support of an open-door collision detection and avoidance, in at least some embodiments. As illustrated in the processing aspects 100B, there may be multiple 2D sensors 152A-152X for an autonomous or semi-autonomous vehicle 106. Each of the sensors may individually capture different views 150A-150X for a processor 102. The different views 150A-150X captured by the multiple 2D sensors 152A-152X may be used with the first ML model 112 and the second ML model 114, as in FIG. 1A. In some examples, the views 150A-150X may be of different zooms, from different timepoints, or from different positions with respect to the vehicle 104 and from a point of view (POV) of the autonomous or semi-autonomous vehicle 106.

The first ML model 112 may provide the prediction 112A of a potential open door 104A and the second ML model 114 may provide the classification 114A of the explicit open-door, as described in connection with at least FIG. 1A. In some examples, the prediction 112A of the potential open door 104A may be output as an open-door attribute and the further classification 114A of the open-door attribute may be output as a rear-trunk-open 156A or a left-door-open 156B indication overlaying one or more of the different views 150A-150X. In some examples, the rear-trunk-open 156A or a left-door-open 156B indication may be an explicit open-door signal and may not be overlaid or visible till the 2D to 3D association is performed. In some examples, the rear-trunk-open 156A or a left-door-open 156B indication may be made in the 2D representation. As such, the rear-trunk-open 156A or a left-door-open 156B indication may be made for the different 2D sensors 152A-152X and may be made in the perspective view.

The open-door signal may be assigned to the vehicle 104 in the BEV through the 2D-3D association 116 made for each of the different views 150A-150X. Once the assignment is made, the processor 102 (such as a downstream planner and controller or the driving sub-system 122) may trigger the action or reaction 108, such as nudging or slowing down the autonomous or semi-autonomous vehicle 106. In some examples, the action or reaction 108 may be provided in an illustration 120A (such as through a dashboard of the autonomous or semi-autonomous vehicle 106) or within the system 100A to support or record the action or reaction 108. The illustration 120A may include a route ongoing for the autonomous or semi-autonomous vehicle 106 and may include other vehicles and contexts within the route, as illustrated in FIG. 1B.

As such, the systems and methods described herein may use one or more object detectors—such as the ML models herein, neural networks, computer vision algorithms, and the like, which may be trained to predict open or closed door states or statuses—to identify open door status of left side, right side, rear, and/or other door/window locations of agent vehicles or machines in an environment. To do this, the systems and methods herein may predict the open-open attributes and further classify it to be explicit, including a “left-door-open” or “right-door-open” using, in some examples, multiple cameras (such as the 2D sensors 152A-152X) in the perspective view 150A-150X. Once the statuses have been detected, the predicted “door-open” attribute may be assigned to the target vehicle or machine (such as the vehicle 104) in a top-down or BEV representation (such as through the 2D-3D associations 116). Although primarily described as converting the 2D detections to a 3D representation (such as BEV), this is not intended to be limiting, and in other examples herein, may use the open-door signals in the perspective view and/or in other views 150A-150X. Similarly, although 2D to 3D detection is discussed, this is not intended to be limiting, and in some examples, open-door statuses may be detected directly in a 3D space support by 3D information, such as by using depth sensors (including LiDAR, RADAR, stereo cameras, and the like), and/or by training a neural network or ML model to directly predict 3D space information as output from 2D information as input. Once a specific vehicle or machine is assigned to the “open-door” attribute or signal, the downstream planner and controller can trigger the nudging, the slowing down, the evasive maneuvers, and/or the other plans or controls to safely react to the situation.

FIG. 2A illustrates bounding box details 200A for detection and/or prediction made by an autonomous or semi-autonomous vehicle in support of an open-door collision detection and avoidance, in at least some embodiments. The bounding box details 200A illustrate that, in an autonomous or semi-autonomous vehicle 106 (or machine application), when an agent vehicle or machine has an open door (such as depicted in FIGS. 1A-2A as the vehicle 104), a direct 3D detection may not be usable to predict an accurate size which may be used to incorporate the open door determination performed in FIGS. 1A and 1B. The systems and methods herein may explicitly predict the “open-door” status using 2D sensors 106A, 152A-152X as detectors, such as camera with inputs provided to the processor 102 (in FIG. 1A). Specifically, in some examples, for a given agent vehicle 104 or machine, the ego machine which may be an autonomous or semi-autonomous vehicle 106 may predict or generate signals for a left-door-open attribute (“door-open-left”), a right-door-open attribute (“door-open-right”), and rear-door-open attribute (“door-open-rear”) individually to indicate different door opening/closing status of the agent vehicle 104 or machine.

In some examples, once a prediction 112A is made of an open-door 104A of a vehicle 104 based in part on a bounding box 202 applied to a representation 110 of the vehicle 104 used with the first ML model 112, a classification 114A may be performed for the open-door 104A as a specific type. This may be based in part on at least one portion of the representation 110 used with the second ML model 114. The at least one portion of the representation may be a part of the representation 110 having extended dimensions 206, with respect to the bounding boxes 210 which may be in the first ML model (such as used for training in the first ML model). In some examples, the at least one portion may be a predetermined part (such as a predetermined width 208) of the representation 110 as determined from an edge 204 of at least one dimension (such as width) of the bounding box 202. As such, once the first ML model has considered the entire bounding box 202, the second ML model may be directed to at least one portion of the representation 110 which may be taken with respect to the bounding box 202 (such as a portion thereof or a dimension therefrom) to determine a left-door-open attribute.

In some examples, the predetermined part may be a cropped part of the representation 110. In some examples, other image features than a cropped part, such as patterns from the representation 110 may be used with the second ML model. In some examples, use of the first ML model followed by the second ML model may represent a rough prediction followed by fine-tuned classification from a representation 110 of the vehicle 104. In some examples, a boundary criterion may be used to automatically determine the edge 204. For example, a third ML model which is trained using boundary images to recognize an edge 204. The determination or recognition of the edge in the representation 110 of the vehicle 104 may be used to determine the predetermined part. For example, the determination of an edge 204 may be used to extend and extract the predetermined part which may be provided to the second ML model for the classification.

FIG. 2B illustrates further bounding box details 200B for detection and/or prediction made by an autonomous or semi-autonomous vehicle in support of an open-door collision detection and avoidance, in at least some embodiments. In some examples, a vehicle 104 (also as in FIGS. 1A, 1B) may be parked in front of the ego machine (such as the autonomous or semi-autonomous vehicle 106) with rear trunk opened, such as in the further bounding box details 200B. This may be a challenging scenario as the ego machine-using traditional approaches that merely adjust the bounding box size for open doors—may have no clue as to whether the ego machine should wait behind this vehicle or bypass it. By explicitly detecting the status of “door-open-rear”, the ego machine is able to understand the context of the situation, and make a determination that the vehicle is parked, and safely bypassing the vehicle is the best option.

Like in the case of FIG. 2A, once a prediction 112A is made of an open-door 104A of a vehicle 104 based in part on a bounding box 252 applied to a representation 110A of the vehicle 104 used with the first ML model 112, a classification 114A may be performed for the open-door 104A as a specific type. This may be based in part on at least one portion of the representation 110 used with the second ML model 114. The at least one portion of the representation may be a part of the representation 110 having extended dimensions 206, with respect to the bounding boxes 210 which may be in the first ML model (such as used for training in the first ML model). In some examples, the at least one portion may be a predetermined part (such as a predetermined width 208) of the representation 110 as determined from an edge 204 of at least one dimension (such as width) of the bounding box 202. As such, once the first ML model has considered the entire bounding box 202, the second ML model may be directed to at least one portion of the representation 110 which may be taken with respect to the bounding box 202 (such as a portion thereof or a dimension therefrom) to determine a rear-door-open attribute (“rear-trunk-open” or “door-open-rear”).

The systems and methods described maintain safety of an ego machine, such as an autonomous or semi-autonomous vehicle 106, when passing a vehicle 104 or machine with an open side-door, rear door, and/or other type of door 104A. The detection or prediction of a door or trunk open state or status may be valuable to determine a proper reaction for the ego-machine. For example, when a vehicle's side door is open, a signal may be generated for the ego machine to facilitate a nudge in order to avoid collisions. In addition or separately, the signal may facilitate warnings that a person may be outside of or may imminently be outside of the vehicle 104 when a door open determination (detection or prediction) is made. In some examples, the ego machine may slow down to pass those door-open vehicles. Similarly, when a vehicle's rear-trunk door is open, this could signal that the vehicle will stay in parking status for some time. When the vehicle 104 is blocking the way of the ego machine, the ego machine may try and pass the vehicle 104 knowing it is stationary and parked-which would be unknown by simply increasing the geometry of the vehicle (such as a bounding box in a representation) based on the trunk being open. The rear-trunk open status may be a strong signal to trigger bypassing such vehicles. Additionally, the systems and methods described herein may be used to identify target vehicles 104 which are parked in the middle of the streets, for which the ego machine may decide to go around due to their purpose for stopping-such as unloading passengers or parcels (in the case of delivery trucks). The open doors (whether side and rear) may strongly indicate that the vehicle 104 is not likely to move, and this information may be used by the system to increase the accuracy of a ‘parked’ state.

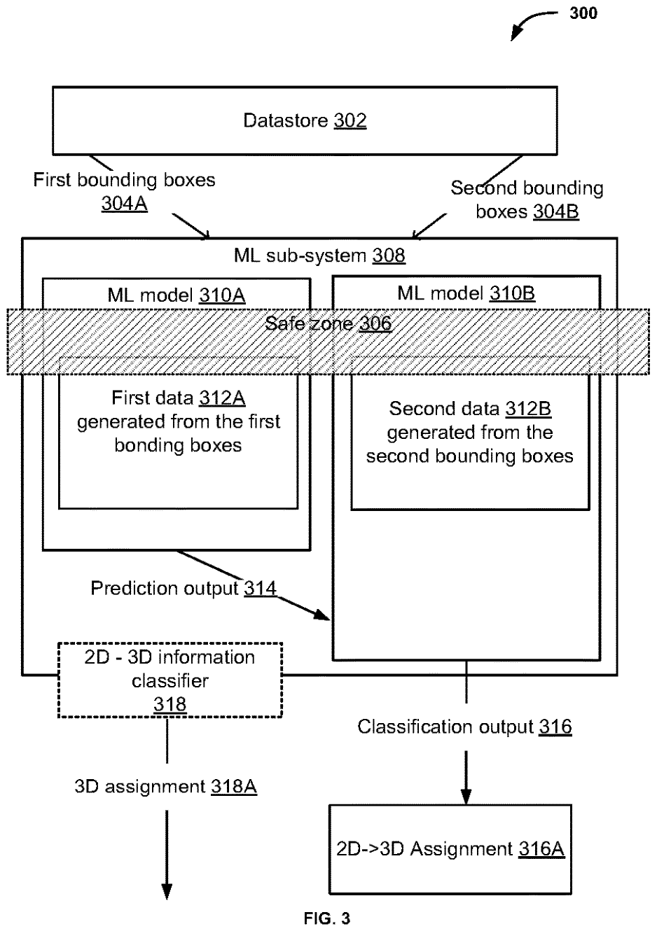

FIG. 3 illustrates details 300 associated with artificial intelligence (AI)/machine learning (ML) for open-door collision detection and avoidance, according to at least some embodiments. The AI/ML aspects may be supported or performed within an ML model 310A, 310B. The ML model 310A, 310B may be within an ML sub-system 308 which may be separate from or within the system 100A in FIG. 1A. The ML model 310A, 310B may be trained using data from a datastore 302 and may be trained within a safe zone 306 of the ML sub-system 308 so that it is independent or isolated from an inference side of the ML model 310A, 310B. The safe zone 306 may also ensure that the ML model 310A, 310B is unbiased and not poisoned, in some examples.

The ML model 310A, 310B may be trained using different parts of the data. For example, a first ML model may be an ML model 310A which may be trained using first data 312A generated from the first bonding boxes 304A. A second ML model may be an ML model 310B which may be trained using second data 312B generated from second bounding boxes 304B. The first bounding boxes 304A may be around one or more of the closed doors or the open doors of the different vehicles and may include historical data or simulated data of confirmed vehicles with open doors. This may be so that first ML model may generate an output, such as a prediction output 314, representing the prediction 112A (in FIG. 1A) of the open-door for the vehicle. The second data 312B may be generated from the second bounding boxes 304B which are different bounding boxes specifically around different types of the open doors for the different vehicles. The second bounding boxes 304B may also be include historical data or simulated data of confined to confirmed open doors of different types. This may be so that the second ML model may generate an output, such as a classification output 316, representing a classification 114B (in FIG. 1A) of the open-door as the specific type for the vehicle from the different types.

In some examples, a 2D sensor may be used to provide a representation 110 (such as in FIG. 1A) as 2D information. Depth sensors may be used with the representation in the 2D information to generate at least part of the representation in 3D information. The 2D information may be provided as input with the second ML model, such as a 2D-to-3D information classifier 318. The 2D-to-3D information classifier 318 may be trained using the 2D information and the 3D information to perform the classification of the open-door in a 3D space without need for the 2D-to-3D assignment 316A from the classification output 316 (used in the 2D-3D association 116 in FIG. 1A, for instance).

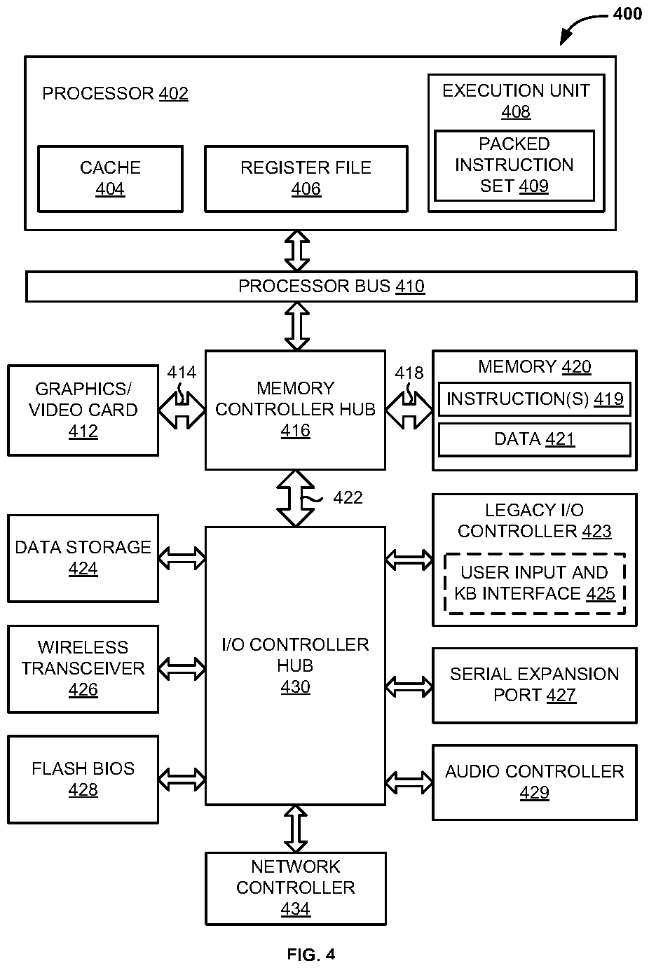

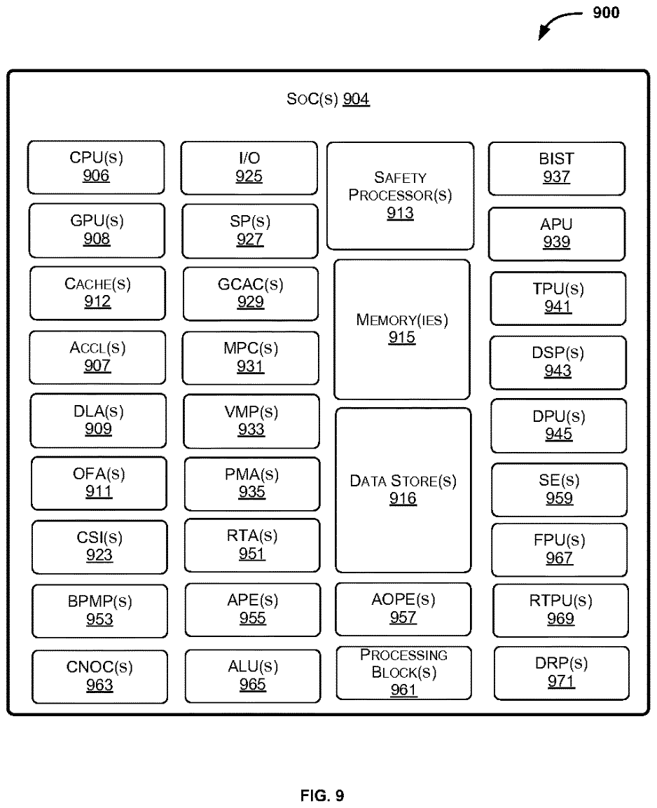

FIG. 4 illustrates computer and processor aspects used by a system in support of open-door collision detection and avoidance, according to at least some embodiments. The computer and processor aspects 400 may be performed by one or more processors that include the SoC of FIG. 9 or some combination thereof, formed with a processor that may include execution units to execute an instruction, according to at least one embodiment. Such one or more processors may include CPUs, data processing units (DPUs), and graphics processing units (GPUs), and may be associated with one or more of the processors capable of performing as the processor 102 (in FIG. 1A).

In at least one embodiment, the computer and processor aspects 400 may include, without limitation, a computing component, such as a processor 402 to employ execution units or processing elements, including logic to perform algorithms for processing data, in accordance with the present disclosure, such as in the embodiment described herein. In at least one embodiment, the computer and processor aspects 400 may include processors, such as PENTIUM® Processor family, Xeon™, Itanium®, XScale™ and/or StrongARM™, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, the computer and processor aspects 400 may execute a version of WINDOWS® operating system available from Microsoft® Corporation of Redmond, Wash., although other operating systems (UNIX® and Linux®, for example), embedded software, and/or graphical user interfaces, may also be used.

Embodiments may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (“DSP”), a system on a chip, network computers (“NetPCs”), set-top boxes, network hubs, wide area network (“WAN”) switches, or any other system that may perform one or more instructions in accordance with at least one embodiment.

In at least one embodiment, the computer and processor aspects 400 may include, without limitation, a processor 402 that may include, without limitation, one or more execution units 408, or processor(s) 102, in some examples, to perform aspects according to techniques described with respect to at least one or more of FIGS. 1A-3 and 5-9 herein. The processor 402 may include multiple threads acting as individual processors, in some examples. There may be multiple processors 402, each acting as a processor, in some examples. The computer and processor aspects 400 may be part of host machines in a datacenter, in some examples, remote from an autonomous or semi-autonomous vehicle 106. In at least one embodiment, the computer and processor aspects 400 is a single processor desktop or server system, but in another embodiment, the computer and processor aspects 400 may be a multiprocessor system.

In at least one embodiment, the processor 402 may include, without limitation, a complex instruction set computer (“CISC”) microprocessor, a reduced instruction set computing (“RISC”) microprocessor, a very long instruction word (“VLIW”) microprocessor, a processor implementing a combination of instruction sets, or any other processor device, such as a digital signal processor, for example. In at least one embodiment, a processor 402 may be coupled to a processor bus 410 that may transmit data signals between processor 402 and other components in computer and processor aspects 400.

In at least one embodiment, a processor 402 may include, without limitation, a Level 1 (“L1”) internal cache memory (“cache”) 404. In at least one embodiment, a processor 402 may have a single internal cache or multiple levels of internal cache. In at least one embodiment, cache 404 may reside external to a processor 402. Other embodiments may also include a combination of both internal and external caches depending on particular implementation and needs. In at least one embodiment, a register file 406 may store different types of data in various registers including, without limitation, integer registers, floating point registers, status registers, and an instruction pointer register.

In at least one embodiment, an execution unit 408, including, without limitation, logic to perform integer and floating point operations, also resides in a processor 402. In at least one embodiment, a processor 402 may also include a microcode (“ucode”) read only memory (“ROM”) that stores microcode for certain macro instructions. In at least one embodiment, an execution unit 408 may include logic to handle a packed instruction set 409.

In at least one embodiment, by including a packed instruction set 409 in an instruction set of a general-purpose processor, along with associated circuitry to execute instructions, operations used by many multimedia applications may be performed using packed data in a processor 402. In at least one embodiment, many multimedia applications may be accelerated and executed more efficiently by using a full width of a processor's data bus for performing operations on packed data, which may eliminate a need to transfer smaller units of data across that processor's data bus to perform one or more operations on one data element at a time.

In at least one embodiment, an execution unit 408 may also be used in microcontrollers, embedded processors, graphics devices, DSPs, and other types of logic circuits. In at least one embodiment, the computer and processor aspects 400 may include, without limitation, a memory 420. In at least one embodiment, a memory 420 may be a Dynamic Random Access Memory (“DRAM”) device, a Static Random Access Memory (“SRAM”) device, a flash memory device, or another memory device. In at least one embodiment, a memory 420 may store instruction(s) 419 and/or data 421 represented by data signals that may be executed by a processor 402.

In at least one embodiment, a system logic chip may be coupled to a processor bus 410 and a memory 420. In at least one embodiment, a system logic chip may include, without limitation, a memory controller hub (“MCH”) 416, and processor 402 may communicate with MCH 416 via processor bus 410. In at least one embodiment, an MCH 416 may provide a high bandwidth memory path 418 to a memory 420 for instruction and data storage and for storage of graphics commands, data and textures. In at least one embodiment, an MCH 416 may direct data signals between a processor 402, a memory 420, and other components in the computer and processor aspects 400 and to bridge data signals between a processor bus 410, a memory 420, and a system I/O interface 422. In at least one embodiment, a system logic chip may provide a graphics port for coupling to a graphics controller. In at least one embodiment, an MCH 416 may be coupled to a memory 420 through a high bandwidth memory path 418 and a graphics/video card 412 may be coupled to an MCH 416 through an Accelerated Graphics Port (“AGP”) interconnect 414.

In at least one embodiment, the computer and processor aspects 400 may use a system I/O interface 422 as a proprietary hub interface bus to couple an MCH 416 to an I/O controller hub (“ICH”) 430. In at least one embodiment, an ICH 430 may provide direct connections to some I/O devices via a local I/O bus. In at least one embodiment, a local I/O bus may include, without limitation, a high-speed I/O bus for connecting peripherals to a memory 420, a chipset, and processor 402. Examples may include, without limitation, an audio controller 429, a firmware hub (“flash BIOS”) 428, a wireless transceiver 426, a data storage 424, a legacy I/O controller 423 containing user input and keyboard interfaces 425, a serial expansion port 427, such as a Universal Serial Bus (“USB”) port, and a network controller 434. In at least one embodiment, data storage 424 may comprise a hard disk drive, a floppy disk drive, a CD-ROM device, a flash memory device, or other mass storage device.

In at least one embodiment, FIG. 4 illustrates computer and processor aspects 400, which includes interconnected hardware devices or “chips”, whereas in other embodiments, FIG. 4 may illustrate an exemplary SoC. In at least one embodiment, devices illustrated in FIG. 4 may be interconnected with proprietary interconnects, standardized interconnects (e.g., PCIe®) or some combination thereof. In at least one embodiment, one or more components of the computer and processor aspects 400 that are interconnected using compute express link (CXL) interconnects.

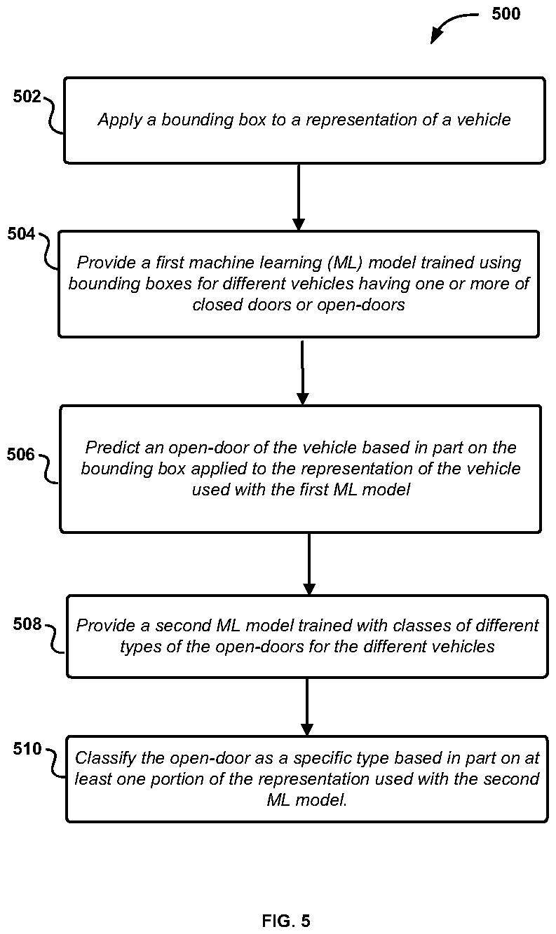

FIG. 5 illustrates a process flow or method 500 used by a system for open-door collision detection and avoidance, according to at least some embodiments. The method 500 may include a step to apply 502 a bounding box to a representation of a vehicle. The method 500 may include a step to provide 504 a first machine learning (ML) model trained using bounding boxes for different vehicles having one or more of closed doors or open-doors. The provision 504 may include allowing access to the first ML model (such as by allowing input to the first ML model). The method 500 may include a step to predict 506 an open-door of the vehicle based in part on the bounding box applied to the representation of the vehicle used with the first ML model. The method 500 may include a step to provide 508 a second ML model trained with classes of different types of the open-doors for the different vehicles. The provision 508 may including allowing access to the second ML mode (such as by allowing input to the second ML model). The method 500 may include a step to classify 510 the open-door as a specific type based in part on at least one portion of the representation used with the second ML model.

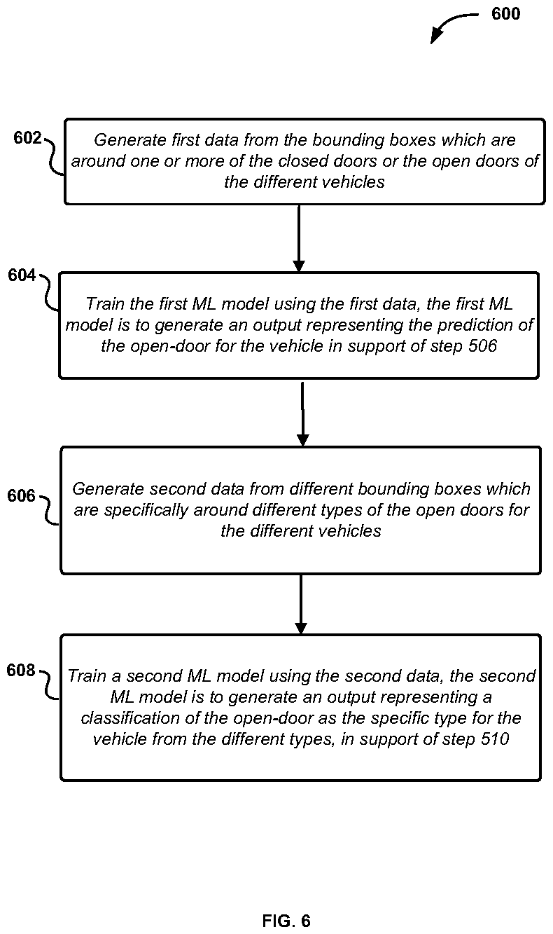

FIG. 6 illustrates a further process flow or method 600 used by a system for open-door collision detection and avoidance, according to at least some embodiments. The method 600 may be in support of the method 500 in FIG. 5. For example, the method 600 may include a step to generate 602 first data from the bounding boxes which are around one or more of the closed doors or the open doors of the different vehicles. The method 600 may include a step to train 604 the first ML model using the first data. The first ML model may generate an output representing the prediction of the open-door for the vehicle in support of step 506. The method 600 may include a step to generate 606 second data from different bounding boxes which are specifically around different types of the open doors for the different vehicles. The method 600 may include a step to train 608 a second ML model using the second data. The second ML model may generate an output representing a classification of the open-door as the specific type for the vehicle from the different types, in support of step 510.

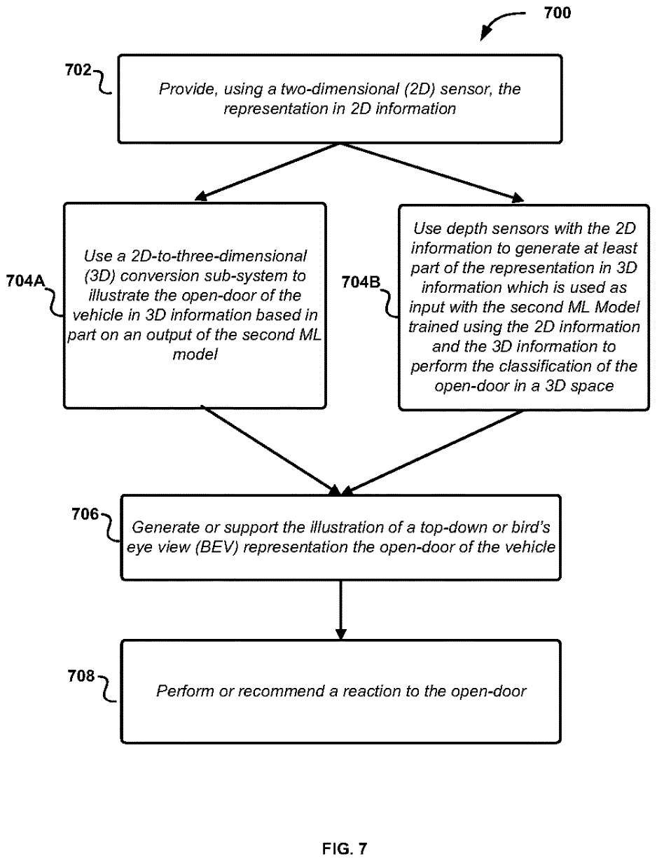

FIG. 7 illustrates a process flow or method 700 using 2D and 3D information in support of open-door collision detection and avoidance, according to at least some embodiments. The method 700 may also be in support of the method 600 in FIG. 6 or the method 500 in FIG. 5. For example, the method 700 may include a step to provide 702, using a 2D sensor, the representation in 2D information. The method 700 may include a step to use 704A a 2D-to-3D conversion sub-system to illustrate the open-door of the vehicle in 3D information based in part on an output of the second ML model. The method 700 may include a step to use 704B depth sensors with the 2D information to generate at least part of the representation in 3D information which is used as input with the second ML Model trained using the 2D information and the 3D information to perform the classification of the open-door in a 3D space. The steps 704A, 704B may be performed as two different approaches or as a verification of one approach. The method 700 may include a step to generate or support 706 the illustration of a top-down or bird's eye view (BEV) representation the open-door of the vehicle. The method 700 may include a step to perform or recommend 708 a reaction to the open-door.

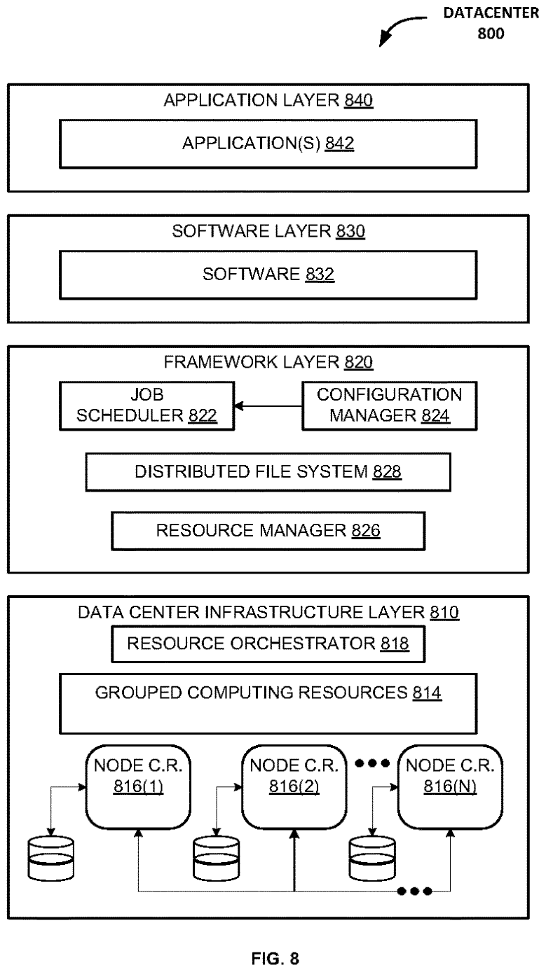

FIG. 8 illustrates an example datacenter 800 to apply at least one embodiment in FIGS. 1A-7. In at least one embodiment, datacenter 800 includes a datacenter infrastructure layer 810, a framework layer 820, a software layer 830, and an application layer 840. The example datacenter 800 may be part of or may support or allow a multi-tenant environment to support one or more aspects of at least the processor 102, as described in FIGS. 1A-7. The datacenter 800 may support the system 100A using included processors or its processing threads (such as CPUs, GPUs, DPUs, or the like (also described as node computing resources (node C.R.s 816(1)-816(N)), described with respect to the datacenter infrastructure layer 810. Further, in at least one aspect, the datacenter 800 may include at least some of the computing components capable of performing the ML algorithms herein.

In at least one embodiment, as shown in FIG. 8, datacenter infrastructure layer 810 may include a resource orchestrator 818, grouped computing resources 814, and node computing resources (“node C.R.s”) 816(1)-816(N), where “N” represents any whole, positive integer. In at least one embodiment, node C.R.s 816(1)-816(N) may include, but are not limited to, any number of central processing units (“CPUs”) or other processors (including accelerators, field programmable gate arrays (FPGAs), graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 816(1)-816(N) may be a server having one or more of above-mentioned computing resources.

In at least one embodiment, grouped computing resources 814 may include separate groupings of node C.R.s housed within one or more racks (not shown), or many racks housed in datacenters at various geographical locations (also not shown). Separate groupings of node C.R.s within grouped computing resources 814 may include grouped compute, network, memory or storage resources that may be configured or allocated to support one or more workloads. In at least one embodiment, several node C.R.s including CPUs or processors may be grouped within one or more racks to provide compute resources to support one or more workloads. In at least one embodiment, one or more racks may also include any number of power modules, cooling modules, and network switches, in any combination.

In at least one embodiment, resource orchestrator 818 may configure or otherwise control one or more node C.R.s 816(1)-816(N) and/or grouped computing resources 814. In at least one embodiment, resource orchestrator 818 may include a software design infrastructure (“SDI”) management entity for datacenter 800. In at least one embodiment, resource orchestrator 818 may include hardware, software, or some combination thereof.

In at least one embodiment, as shown in FIG. 8, framework layer 820 includes a job scheduler 822, a configuration manager 824, a resource manager 826, and a distributed file system 828. In at least one embodiment, framework layer 820 may include a framework to support software 832 of software layer 830 and/or one or more application(s) 842 of application layer 840. In at least one embodiment, software 832 or application(s) 842 may respectively include web-based service software or applications, such as those provided by Amazon Web Services, Google Cloud, and Microsoft Azure. In at least one embodiment, framework layer 820 may be, but is not limited to, a type of free and open-source software web application framework such as Apache Spark™ (hereinafter “Spark”) that may use distributed file system 828 for large-scale data processing (e.g., “big data”). In at least one embodiment, job scheduler 822 may include a Spark driver to facilitate scheduling of workloads supported by various layers of datacenter 800. In at least one embodiment, configuration manager 824 may be capable of configuring different layers such as software layer 830 and framework layer 820 including Spark and distributed file system 828 for supporting large-scale data processing. In at least one embodiment, resource manager 826 may be capable of managing clustered or grouped computing resources mapped to or allocated for support of distributed file system 828 and job scheduler 822. In at least one embodiment, clustered or grouped computing resources may include grouped computing resources 814 at datacenter infrastructure layer 810. In at least one embodiment, resource manager 826 may coordinate with resource orchestrator 818 to manage these mapped or allocated computing resources.

In at least one embodiment, software 832 included in software layer 830 may include software used by at least portions of node C.R.s 816(1)-816(N), grouped computing resources 814, and/or distributed file system 828 of framework layer 820. The one or more types of software may include, but are not limited to, Internet web page search software, e-mail virus scan software, database software, and streaming content software.

In at least one embodiment, application(s) 842 included in application layer 840 may include one or more types of applications used by at least portions of node C.R.s 816(1)-816(N), grouped computing resources 814, and/or distributed file system 828 of framework layer 820. One or more types of applications may include, but are not limited to, any number of a genomics application, a cognitive compute, and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 824, resource manager 826, and resource orchestrator 818 may implement any number and type of self-modifying actions based on any amount and type of data acquired in any technically feasible fashion. In at least one embodiment, self-modifying actions may relieve a datacenter operator of datacenter 800 from making possibly bad configuration decisions and possibly avoiding underused and/or poor performing portions of a datacenter.

In at least one embodiment, datacenter 800 may include tools, services, software, or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to datacenter 800. In at least one embodiment, trained machine learning models corresponding to one or more neural networks may be used to infer or predict information using resources described above with respect to datacenter 800 by using weight parameters calculated through one or more training techniques described herein.

In at least one embodiment, datacenter may use CPUs, application-specific integrated circuits (ASICs), GPUs, FPGAs, or other hardware to perform training and/or inferencing using above-described resources. Moreover, one or more software and/or hardware resources described above may be configured as a service to allow users to train or perform inferencing of information, such as data recognition, speech recognition, or other artificial intelligence services.

FIG. 9 is a block diagram of an example architecture of a computing system 900 (a subset of the system described with respect to FIGS. 1A-8), in accordance with at least some embodiments of the present disclosure. Although illustrated as an SoC(s) 904, this is not intended to be limiting, and the computing system may additionally or instead include multi-chip modules (MCMs), application-specific integrated circuits (ASICs), system-in-packages (SiPs), heterogeneous integration (HI), single-board computers (SBCs), and/or other components and/or architectures, without departing from the scope of the present disclosure. The SoCs 904 may represent or support the processor 102, described throughout herein.

In some embodiments, such as where the SoC(s) 904 include a GPU 908 with 2000 or more cores (e.g., 2048 cores), 60 or more tensor cores (e.g., 64 tensor cores), and a GPU max frequency of over 1 GHz (e.g., 1.3 GHZ), a CPU 906 including 10 or more cores (e.g., 12 cores), with 64 bits, 3 MB L2 and 6 MB L3 cache memory, and a max frequency of 2 or more GHz (e.g., 2.2 GHz), one or more deep learning accelerators (DLAs), deep learning accelerator clusters (XNNs), neural network accelerators (NNAs), or neural processing units (NPUs) 909 (e.g., 2 DLAs/XNNs/NNAs/NPUs 909), and an accelerator (ACCLS) 907, a single SoC 904) may be capable of 275 tera operations per second (TOPS) of AI performance. For example, NVIDIA's Jetson AGX Orin 64 GB SoC satisfies these criteria, and achieves this performance.

Similarly, in embodiments where the SoC(s) 904 include a GPU 908 with 1700 or more cores (e.g., 1792 cores), 50 or more tensor cores (e.g., 56 tensor cores), and a GPU max frequency of over 900 MHZ (e.g., 930 MHz), a CPU 906 including 8 or more cores (e.g., 8 cores), with 64 bits, 2 MB L2 and 4 MB L3 cache memory, and a max frequency of 2 or more GHz (e.g., 2.2 GHz), one or more deep learning accelerators (DLAs), deep learning accelerator clusters (XNNs), neural network accelerators (NNAs), or neural processing units (NPUs) 909 (e.g., 2 DLAs/XNNs/NNAs/NPUs 909), and a accelerator-such as a programmable accelerator 907, a single SoC 904) may be capable of 200 tera operations per second (TOPS) of AI performance. For example, NVIDIA's Jetson AGX Orin 32 GB SoC satisfies these criteria, and achieves this performance.

In some embodiments, such as where the SoC(s) 904 include a GPU 908 with 1000 or more cores (e.g., 1024 cores), 28 or more tensor cores (e.g., 32 tensor cores), and a GPU max frequency of over 900 MHZ (e.g., 1173 MHz), a CPU 906 including 8 or more cores (e.g., 8 cores), with 64 bits, 2 MB L2 and 4 MB L3 cache memory, and a max frequency of 2 or more GHz (e.g., 2 GHz), one or more deep learning accelerators (DLAs), deep learning accelerator clusters (XNNs), neural network accelerators (NNAs), or neural processing units (NPUs) 909 (e.g., 1 DLA/XNN/NNA/NPU 909), and an accelerator-such as a programmable accelerator 907, a single SoC 904) may be capable of 157 tera operations per second (TOPS) of AI performance. For example, NVIDIA's Jetson AGX Orin NX 16 GB SoC satisfies these criteria, and achieves this performance.

In various embodiments, such as where the SoC(s) 904 include a GPU 908 with 1000 or more cores (e.g., 1024 cores), 28 or more tensor cores (e.g., 32 tensor cores), and a GPU max frequency of over 900 MHZ (e.g., 1020 MHz), a CPU 906 including 6 or more cores (e.g., 6 cores), with 64 bits, 1.5 MB L2 and 4 MB L3 cache memory, and a max frequency of 1.5 or more GHz (e.g., 1.7 GHZ), a single SoC 904) may be capable of 67 tera operations per second (TOPS) of AI performance. For example, NVIDIA's Jetson Orin Nano 8 GB SoC satisfies these criteria, and achieves this performance.

The SoC(s) 904 may include one or more CPUs 906. The CPU(s) 906 may include a CPU cluster or CPU complex (alternatively referred to herein as a “CCPLEX”), in embodiments. The CPU(s) 906 may include multiple cores and/or (e.g., L2, L3) caches. For example, in some embodiments, the CPU(s) 906 may include twelve cores in a coherent multi-processor configuration. In some embodiments, the CPU(s) 906 may include four dual-core clusters where each cluster has a dedicated L2 cache (e.g., a 3 MB L2 cache). The CPU(s) 906 (e.g., the CCPLEX) may be configured to support simultaneous cluster operation enabling any combination of the clusters of the CPU(s) 906 to be active at any given time.

The SoC(s) 904 may include any type and number of GPUs 908. For example, an integrated GPU(s) (alternatively referred to herein as an “iGPU(s)”) may be used in some embodiments. The GPU(s) 908 may be programmable and may be efficient for parallel workloads. The GPU(s) 908, in some examples, may use an enhanced tensor instruction set. The GPU(s) 908 may include one or more streaming microprocessors, where each streaming microprocessor may include a cache (e.g., an L1 cache with at least 96 KB storage capacity), and two or more of the streaming microprocessors may share an L2 cache (e.g., an L2 cache with a 512 KB storage capacity). In some embodiments, the GPU(s) 908 may include at least eight streaming microprocessors. The GPU(s) 908 may use compute application programming interface(s) (API(s)). In addition, the GPU(s) 908 may use one or more parallel computing platforms and/or programming models (e.g., NVIDIA's CUDA).

The GPU(s) 908 may be power-optimized for best performance in automotive, robotics, and/or other embedded use-cases. For example, the GPU(s) 908 may be fabricated on a Fin field-effect transistor (FinFET). However, this is not intended to be limiting and the GPU(s) 908 may be fabricated using other semiconductor manufacturing or fabrication processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an (e.g., L0) instruction cache, a warp scheduler, a dispatch unit, and/or a (e.g., 64 KB) register file. In addition, the streaming microprocessors may include independent parallel integer and floating-point data paths to provide for efficient execution of workloads with a mix of computation and addressing calculations. The streaming microprocessors may include independent thread scheduling capability to enable finer-grain synchronization and cooperation between parallel threads. The streaming microprocessors may include a combined L1 data cache and shared memory unit in order to improve performance while simplifying programming.

The GPU(s) 908 may include a high bandwidth memory (HBM) and/or a (e.g., 16 GB) HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 908 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 908 to access the CPU(s) 906 page tables directly. In such examples, when the GPU(s) 908 memory management unit (MMU) experiences a miss, an address translation request may be transmitted to the CPU(s) 906. In response, the CPU(s) 906 may look in its page tables for the virtual-to-physical mapping for the address and transmit the translation back to the GPU(s) 908. As such, unified memory technology may allow a single unified virtual address space for memory of both the CPU(s) 906 and the GPU(s) 908, thereby simplifying the GPU(s) 908 programming and porting of applications to the GPU(s) 908.

The SoC(s) 904 may include any number of cache(s) 912, including those described herein. For example, the cache(s) 912 may include L0 caches, L1 caches, L2 caches, L3 caches (e.g., that are available to both the CPU(s) 906 and the GPU(s) 908 (e.g., that is connected both the CPU(s) 906 and the GPU(s) 908), etc. The cache(s) 912 may include a write-back cache that may keep track of states of lines, such as by using one or more cache coherence protocols (e.g., MEI, MESI, MSI, etc.). The (e.g., L3) cache may include 4 MB or more, depending on the embodiment, although smaller or larger cache sizes may be used.

The SoC(s) 904 may include one or more arithmetic logic units (ALUs) 965 which may be leveraged in performing processing with respect to any of the variety of tasks or operations. In addition, the SoC(s) 904 may include a floating point unit(s) (FPU(s)) 967—or other math coprocessor or numeric coprocessor types—for performing mathematical operations within the system. For example, the SoC(s) 904 may include one or more FPUs 967 integrated as execution units within a CPU(s) 906 and/or GPU(s) 908.

The SoC(s) 904 may include one or more accelerators (e.g., hardware accelerators, software accelerators, or a combination thereof). For example, the SoC(s) 904 may include a hardware acceleration cluster that may include optimized hardware accelerators and/or large on-chip memory. The large on-chip memory 915 (e.g., 4 MB of SRAM, 32 GB and/or 64 GB 256-bit LPDDR5 at 204.8 GB/s, 8 GB and/or 16 GB 128-bit LPDDR5 at 102.4 GB/s, and/or other memory types and sizes), may enable the hardware acceleration cluster to accelerate neural network processing, transformer processing, optical flow processing, data processing, and/or other calculations or processing. The hardware acceleration cluster may be used to complement the GPU(s) 908 and to off-load some of the tasks of the GPU(s) 908 (e.g., to free up more cycles of the GPU(s) 908 for performing other tasks). As an example, the accelerator(s) may be used for targeted workloads (e.g., perception, convolutional neural networks (CNNs), deep neural networks (DNNs), language models (LLMs, VLMs, MMLMs, VLAs, etc.), transformer models, diffusion models, encoder-only models, encoder-decoder models, etc. that are stable enough to be amenable to acceleration.

The accelerator(s) (e.g., the hardware acceleration cluster) may include a deep learning accelerator(s) (DLA) 909 (alternatively referred to herein as “a deep learning accelerator cluster (XNN) 909,” “neural network accelerator (NNA) 909,” or “neural processing unit (NPU) 909”). The DLA(s) 909 may include one or more Tensor processing units (TPUs) 941 that may be configured to provide an additional, e.g., ten trillion operations per second for deep learning applications and inferencing. The TPUs 941 may be accelerators configured to, and optimized for, performing processing functions (e.g., for CNNs, RCNNs, DNNs, etc.). The DLA(s) 909 may further be optimized for a specific set of neural network types and floating point operations, as well as inferencing. The design of the DLA(s) may provide more performance per millimeter than a general-purpose GPU, and vastly exceeds the performance of a CPU. The TPU(s) 941 may perform several functions, including a single-instance convolution function, supporting, for example, INT8, INT16, and FP16 data types for both features and weights, as well as post-processor functions. Although the TPU(s) 941 are described as being included as part of the DLA(s) 909, this is not intended to be limiting, and the TPU(s) 941 may be included in additional or alternative accelerator(s) and/or other components, and/or may be included as a discrete processing component(s).

The DLA(s) 909 may quickly and efficiently execute neural networks on processed or unprocessed data for any of a variety of functions, including, for example and without limitation: for feature identification and detection using data from one or more sensor modalities, for distance estimation using data from one or more sensor modalities, for identification and detection using data from microphones and/or data-based sensors, for pick and place operations, for manipulation operations, other operations using data from cameras and/or other sensor types, and/or a for security and/or safety related events, to name a few.

The DLA(s) 909 may perform any function of the GPU(s) 908, and by using an inference accelerator, for example, a designer may target either the DLA(s) 909 or the GPU(s) 908 for any function. For example, the designer may focus processing of DNNs and floating point operations on the DLA(s) 909 and leave other functions to the GPU(s) 908 and/or other accelerator(s). The DLA(s) 909 may be used to run any type of network to enhance control and safety, including, for example, a neural network that outputs a measure of confidence for each object detection.

The accelerator(s) (e.g., the hardware acceleration cluster) may include programmable accelerator(s) 907 (ACCLS), which may alternatively be referred to herein as a computer accelerator or generally a data accelerator. The accelerator(s) 907 may be designed and configured to accelerate computer algorithms for ML applications, security and surveillance applications, augmented reality (AR), virtual reality (VR), and/or mixed reality (MR) applications, etc. The accelerator(s) 907 may provide a balance between performance and flexibility. For example, each accelerator(s) 907 may include, for example and without limitation, any number of reduced instruction set computer (RISC) cores, direct memory access (DMA) systems, pixel processing engines (PPEs), vector processors or vector processing units (VPUs), and/or other components. The PVA engine may include an advanced very long instruction word (VLIW), single instruction multiple data (SIMD) digital signal processor. The accelerator(s) 907 may be optimized for the tasks of data processing and computer algorithm acceleration. For example, the accelerator(s) 907 provides excellent performance with extremely low power consumption, and may be used asynchronously and concurrently with the CPU(s) 906, GPU(s) 908, and/or other accelerators in the system (e.g., automation, etc.) as part of a heterogeneous compute pipeline.

The accelerator(s) 907 may include one or more (e.g., two) vector processing subsystems (VPS), where each VPS may include one or more vector processing unit (VPU) cores, one or more decoupled look-up units (DLUTs), one or more shared or vector memories (VMEMs), and one or more instruction caches (I-caches). The VPU core(s) may be the main processing unit, and may include a vector SIMD VLIW DSP 943 optimized for data processing. The VPU core(s) may fetch instructions through the I-cache(s), and may access data through the VMEM(s). The DLUT(s) may include a specialized hardware component that enhances the efficiency of parallel lookup operations. For example, the DLUT(s) allow parallel lookups using a single copy of the lookup table by executing these lookups in a decoupled pipeline, independent of the primary processor pipeline. By doing so, the DLUT(s) minimize or reduce memory usage and enhance throughput while avoiding data-dependent memory bank conflicts—ultimately leading to improved overall system performance. The VPU VMEM(s) may provide local data storage for the VPU, allowing efficient implementation of various data processing and computer algorithms. The VPU VMEM(s) may support access from outside-VPS hosts such as direct memory access (DMA) and the CPU(s) 906 (e.g., ARM Cortex-R5 processor), facilitating data exchange with the CPU(s) 906 and other system-level components. The VPU I-cache may supply instruction data to the VPU(s) when requested, may request missing instruction data from system memory, and/or may maintain temporary instruction storage for the VPU. For each VPU task, the CPU(s) 906 may configure the DMA system, optionally prefetch the VPU program into VPU I-cache, and/or kick off each VPU-DMA pair to process a task. The accelerator(s) 907 may also include an L2 SRAM memory to be shared between the one or more (e.g., two) sets of VPS and DMA. In some embodiments, one or more (e.g., two) DMA devices are used to move data among external memory, PVA L2 memory, the VMEMs (e.g., one in each VPS), CPU(s) tightly coupled memory (TCM), DMA descriptor memory, and/or PVA-level config registers. In a lightly loaded system, two parallel DMA accesses to DRAM may achieve a read/write bandwidth of up to 15 GB/s each and, in a heavily loaded system, this bandwidth may reach up to 10 GB/s each. With respect to compute capacity, the INT8 Giga Multiply-Accumulate Operations per Second (GMACs) may be 2048 or greater, excluding the DLUT. The FP32 GMACs may include 32 per PVA instance.

The RISC cores may interact with sensors, data signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA system may enable components of the accelerator(s) 907 to access the system memory independently of the CPU(s) 906. The DMA may support any number of features used to provide optimization to the accelerator(s) 907 including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors or VPUs may be programmable processors that may be designed to efficiently and flexibly execute programming for computer algorithms and provide signal processing capabilities. In some examples, the accelerator(s) 907 may include a core and two vector processing subsystem partitions. The core may include a processor subsystem, DMA engine(s) (e.g., two DMA engines), and/or other peripherals. The vector processing subsystem may operate as the primary processing engine of the accelerator(s) 907, and may include one or more vector processing units (VPUs), one or more pixel processing engines (PPEs)—which may include a 2D layout of interconnected (e.g., for north, south, east, west intercommunication) processing elements, one or more instruction caches, and/or one or more shared or vector memories (e.g., VMEMs). A VPU core may include a digital signal processor, such as for example, a single instruction, multiple data (SIMD), very long instruction word (VLIW) digital signal processor. The combination of the SIMD and VLIW may enhance throughput and speed.

In some embodiments, each of the vector processors may include an instruction cache and may be coupled to dedicated memory. As a result, in some examples, each of the vector processors may be configured to execute independently of the other vector processors. In other examples, the vector processors that are included in a particular accelerator(s) 907 may be configured to employ data parallelism. For example, in some embodiments, the plurality of vector processors included in a single accelerator(s) 907 may execute the same computer algorithm, but on different regions of data. In other examples, the vector processors included in a particular accelerator(s) 907 may simultaneously execute different computer algorithms, on the same data, or even execute different algorithms on sequential data or portions of data. Among other things, any number of PVAs may be included in the hardware acceleration cluster and any number of vector processors may be included in each of the PVAs. In addition, the accelerator(s) 907 may include additional error correcting code (ECC) memory, to enhance overall system safety.

The accelerator(s) (e.g., the hardware accelerator cluster) have a wide array of uses for autonomous and semi-autonomous machine control. The accelerator(s) 907 may be a programmable accelerator that may be used for key processing stages in perception, robotics understanding and reasoning, etc. Capabilities of the accelerator(s) 907 are a good match for algorithmic domains needing predictable processing, at low power and low latency. In other words, the accelerator(s) 907 perform well on semi-dense or dense regular computation, even on small data sets, which need predictable run-times with low latency and low power. Thus, the accelerator(s) 907 are designed to run classic computer ML algorithms, as they are efficient at object detection and operating on integer math.

In some examples, the accelerator(s) 907 may be used to perform dense optical flow. According to the process, raw RADAR data (e.g., using a 4D Fast Fourier Transform may be used to provide the processed raw RADAR data. In other examples, the accelerator(s) 907 is used for time-of-flight depth processing, by processing raw time of flight data to provide processed time of flight data, for example.

Although the VPU(s), DMA(s), RISC Core(s), VMEM(s), and decoupled co-processors (e.g., the DLUT(s)) are described as being included within the Accelerator(s) 907, this is not intended to be limiting. In some embodiments, these components may be included in alternative or additional processing components and/or accelerator(s), and/or may be included as discrete components of the SoC(s) 904 and/or other computing system architecture(s).

In some examples, the SoC(s) 904 may include a real-time ray-tracing hardware accelerator (RTA) 951 that may be used to quickly and efficiently determine the positions and extents of objects (e.g., within a world model), to generate real-time or near-real time visualization simulations, for RADAR signal interpretation, for sound propagation synthesis and/or analysis, for simulation of SONAR, RADAR, LiDAR, camera, and/or other sensor modalities within a simulation, for general wave propagation simulation, for comparison to LiDAR data for purposes of localization, to generate realistic training data for training neural networks, and/or other functions and uses. In some embodiments, one or more tree traversal units (TTUs) may be used for executing one or more ray-tracing related operations.

The SoC(s) 904 may include one or more camera serial interfaces (CSIs) 923. For example, the CSI(s) 923 may include a high-speed interface, and/or a data input block that may be used for input functions. The SoC(s) 904 may further include an input/output controller(s) that may be controlled by software and may be used for receiving I/O signals that are uncommitted to a specific role. For example, the CSI 923 may include a MIPI CSI-2 connector—e.g., a 16 lane MIPI CSI-2 connector, D-PHY 2.1 (up to 40 Gbps), and C-PHY 2.0 (up to 164 Gbps) for supporting 16 virtual channels and six or more cameras, an 8 lane MIPI CSI-2 connector, D-PHY 2.1 (up to 20 Gbps for supporting 8 virtual channels and 4 or more cameras, and/or a 2x MIPI CSI-2, 22 pin camera connector, depending on the embodiment and implementation.

The accelerator(s) (e.g., the hardware acceleration cluster) may include a computer network on-chip (CNOC) 963 and SRAM, for providing a high-bandwidth, low latency SRAM for the accelerator(s). In some examples, the on-chip memory may include at least 4 MB SRAM, consisting of, for example, and without limitation, eight field-configurable memory blocks, that may be accessible by the accelerator(s) 907, OFA 911, DLA 909, and/or other accelerator(s). Each pair of memory blocks may include an advanced peripheral bus (APB) interface, configuration circuitry, a controller, and a multiplexer. Any type of memory 915 may be used. The accelerator(s) 907, OFA 911, DLA 909, and/or other accelerator(s) may access the memory via a backbone that provides the accelerator(s) with high-speed access to memory. The backbone may include a computer network on-chip that interconnects the accelerator(s) to the memory (e.g., using the APB).

The CNOC 963 may include an interface that determines, before transmission of any control signal/address/data, that the accelerator(s) provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

The SoC(s) 904 may include data store(s) 916 and/or memory 915. The data store(s) 916 may be on-chip memory 915 of the SoC(s) 904, which may store neural networks and/or other algorithms to be executed on the CPU(s) 906, the GPU(s) 908, and/or one or more of the accelerator(s). In some examples, the data store(s) 916 may be large enough in capacity to store multiple instances of neural networks for redundancy and safety. The data store(s) 916 may comprise L2 and/or L3 cache(s) 912, for example. The memory (ies) 915 may include SRAM, LPDDR5, and/or other memory types. For example, the memory (ies) 915 may include 4 MB of SRAM, 32 GB and/or 64 GB 256-bit LPDDR5 at 204.8 GB/s, 8 GB and/or 16 GB 128-bit LPDDR5 at 102.4 GB/s, and/or other memory types and sizes. Reference to the data store(s) 916 may include reference to the memory associated with the accelerator(s) 907, OFA 911, DLA 909, and/or other accelerator(s), as described herein.

The data store(s) 916 may include various storage types, such as eMMC, NVMe, etc. For example, the SoC(s) 904 may include storage in the form of an embedded multimedia card (eMMC) (e.g., 64 GB eMMC 5.1) and/or an SD card slot, with external NVM express (NVMe) capability, e.g., via M.2 Key M. For example, the data store(s) 916 and/or other storage may be accessed via, e.g., NVMe, using PCI Express (PCIe), RDMA, TCP, and/or other protocols.

The SoC(s) 904 may include one or more processor(s) 402 (e.g., embedded processors). The processor(s) 402 may include a boot and power management processor (BPMP) 953, that may be a dedicated processor and subsystem to handle boot power and management functions and related security enforcement. The BPMP 953 may be a part of the SoC(s) 904 boot sequence and may provide runtime power management services. The BPMP 953 may provide clock and voltage programming, assistance in system low power state transitions, management of SoC(s) 904 thermals and temperature sensors, and/or management of the SoC(s) 904 power states. Each temperature sensor may be implemented as a ring-oscillator whose output frequency is proportional to temperature, and the SoC(s) 904 may use the ring-oscillators to detect temperatures of the CPU(s) 906, GPU(s) 908, accelerator(s), and/or other components. If temperatures are determined to exceed a threshold, BPMP 953 may enter a temperature fault routine and put the SoC(s) 904 into a lower power state.

The processor(s) 402 may further include a set of embedded processors that may serve as an audio processing engine (APE) 955. The APE 955 may be an audio subsystem that enables full hardware support for multi-channel audio over multiple interfaces, and a broad and flexible range of audio I/O interfaces. In some examples, the APE 955 is a dedicated processor core with a digital signal processor with dedicated RAM.

The processor(s) 402 may further include an always on processor engine (AOPE) 957 that may provide necessary hardware features to support low power sensor management and wake use-cases. The AOPE 957 may include a processor core, a tightly coupled RAM, supporting peripherals (e.g., timers and interrupt controllers), various I/O controller peripherals, and routing logic.

The processor(s) 402 may further include a safety processor(s) 913 (alternatively referred to as “safety island 913”), which may include a safety cluster engine that includes a dedicated processor or processor subsystem to handle safety management for automotive, robotics, and/or other applications. The safety processor(s) 913—and/or safety cluster engine—may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations. In some embodiments, the safety processor(s) 913 may include a discrete processor(s), such that faults of other system components may not impact the performance and availability of the safety processor 913.

The processor(s) 402 may further include a real-time or near real-time sensor engine (SE) 959 that may include a dedicated processor subsystem for handling real-time or near real-time data. The processor(s) 402 may further include one or more signal processors (SPs) 927, which may include a high-dynamic range signal processor and/or a hardware engine that is part of one or more sensor processing pipelines. The processor(s) 402 may include a processing block 961 (e.g., implemented on a microprocessor) that implements post-processing functions. The processing block 961 includes enhanced temporal noise reduction for both spatial and temporal noise reduction.

The SoC(s) 904 may further include a broad range of peripheral interfaces for input/output (I/O) 925, such as to enable communication with peripherals, audio codecs, power management, and/or other devices. The SoC(s) 904 may be used to process data from cameras (e.g., connected over Gigabit Multimedia Serial Link and/or Ethernet), sensors (which may be connected over Ethernet), data from processor bus 410, data from GNSS sensor(s) (e.g., connected over Ethernet or CAN bus). The SoC(s) 904 may further include dedicated high-performance mass storage controllers that may include their own DMA engines, and that may be used to free the CPU(s) 906 from routine data management tasks. In some embodiments, the SoC(s) 904 I/O 925 may include a header (e.g., a 40 pin header, or 40 pin expansion header) with support for universal asynchronous receiver/transmitter (UART), serial peripheral interface (SPI), inter-integrated circuit sound (12S), inter-integrated circuit (I2C), controller area network (CAN), pulse width modulation (PWM), digital microphone interface (DMIC), digital speaker station (DSPK), general purpose I/O (GPIO), etc., an automation header (e.g., 12 pin automation header), an audio panel header (e.g., a 10 pin audio panel header), a joint test action group (JTAG) header (e.g., a 10 pin JTAG header), a fan header (e.g., a 4 pin fan header), an RTC battery backup connector (e.g., a 2 pin battery backup connector), a microSD slot, a DC power jack, power, force, recovery, and reset buttons, one or more display connectors (e.g., DisplayPort (DP), such as a DP 1.4A (+MST), an eDP 1.41, an HDMI 2.1, and/or a 4K30 multi-model DP 1.2 (+MST) connector), and/or other I/O 925 elements, components, or features.

The SoC(s) 904 may include in-machine networking capability using, for example, Ethernet (e.g., automotive Ethernet), SERDES, controller area network (CAN), FlexRay, local interconnect network (LIN), low voltage differential signaling (LVDS), media oriented system transport (MOST), another networking type, and/or a combination thereof. For example, the SoC(s) 904 may include an RJ45 connector with up to 10 GbE, a 1 GbE connector, and/or other networking connector types.

The SoC(s) 904 may include one or more digital signal processors (DSPs) 943. For example, the DSP(s) 943 may include a dedicated or specialized microprocessor chip optimized for digital signal processing-such as in audio signal processing, telecommunications, digital data processing, and/or other sensor processing, speech recognition, and/or other applications.

The SoC(s) 904 may include one or more general compute acceleration clusters (GCAC(s)) 929. For example, the GCAC(s) 929 may include various processor types that may be used to accelerate compute, such as one or more vector microcode processors (VMPs) 933, one or more multi-threaded processing clusters (MPCs) 931, one or more programmable macro arrays (PMA(s)) 935, and/or one or more other processor types. For example, the GCAC(s) 929 may include a PMA 935, two VMPs 933, and 2 MPCs 931.

The SoC(s) 904 may include one or more vector microcode processors (VMPs) 933. The VMP(s) 933, in embodiments, may include a wide vector (very long instruction word (VLIW) and single instruction multiple data (SIMD)) machine with performing various operations, such as short integral type operations common in machine learning and deep learning algorithms, including in connection with the ML algorithms described in connection with at least FIG. 2B.

The SoC(s) 904 may include one or more multi-threaded processing clusters (MPCs) 931. The MPC(s) 931 may include a processing cluster that, in embodiments, is more versatile than a GPU, and has higher efficiency than a CPU. For example, the MPC(s) 931 may include a multi-threaded processor that allows multiple threads to share resources and execute instructions concurrently.

The SoC(s) 904 may include one or more programmable macro arrays (PMA(s)) 935. The PMA(s) 935 may include a coarse-grained reconfigurable architecture (CGRA) dataflow machine, having a unique architecture that delivers strong performance on dense computer machine learning and deep learning algorithms that may be unachievable in classic digital signal processing (DSP) architectures.

The SoC(s) 904 may include one or more display processing units (DPUs) 945 for performing hardware-accelerated processing. For example, the DPU(s) 945 may retrieve pixel data from memory 915 and send it to a display peripheral through standard interfaces. As such, the DPU(s) 945 may handle display processing and rendering for in-machine and/or on-machine displays.

The SoC(s) 904 may include one or more application processing units (APUs) 939. For example, the APU(s) 939 may include a quad or dual-core processor with 48 KB/32 KB L1 cache with parity and ECC, along with a 1 MB L2 cache with ECC. The APU(s) 939 may support NEON instructions and single and double precision floating point operations. The SoC(s) 904 may include one or more real-time processing units (RTPUs) 969. The RTPU(s) 969 may include a dual-core processor with 32 KB/32 KB L1 cache, and 256 KB TCM with ECC. The RTPU(s) 969 may support single and double precision floating point operations. The SoC(s) 904 may include one or more built-in self-test (BIST) components 937. For example, the BIST components 937 may include memory BIST (MBIST) to test memories of the system and/or logic BIST (LBIST) to test logic of the system. The BIST components 937 may include embedded logic for directly testing logic and/or memory of the system.

The SoC(s) 904 may include one or more dynamically reconfigurable processors (DRPs) 971. For example, the DRP(s) 971 may be used for accelerating various computing operations. For example, the DRP(s) 971 may be combined, in embodiments, with a MAC unit for use as an AI accelerator. In embodiments, the DRP(s) 971 may execute applications while dynamically switching the circuit connection configuration of the arithmetic units (e.g., ALUs) on the chip at each operating clock according to the content to be processed. Since only the necessary arithmetic circuits are used, the DRP(s) 971 may consume less power than with CPU processing and may achieve higher speed. Furthermore, compared to CPUs, where frequent external memory accesses due to cache misses and other causes will degrade performance, the DRP(s) 971 may build the necessary data paths in hardware ahead of time, resulting in less performance degradation and less variation in operating speed (jitter) due to memory accesses. The DRP(s) 971 may include a dynamic loading function that switches the circuit connection information each time the algorithm changes, enabling processing with limited hardware resources, even in robotic/automotive applications that require processing of multiple algorithms.

In some embodiments, the accelerator(s) may include an OpenCV accelerator for speeding up processing of OpenCV, an open-source industry standard library for computer data processing. In some embodiments, the combination of one or more DRP(s) 971 deployed as an AI accelerator along with an OpenCV accelerator(s) may enhance AI computing and other processing algorithms, enabling complex and compute-heavy operations such as Visual simultaneous localization and mapping (SLAM).

In contrast to conventional systems, by providing a CPU complex, GPU complex, and a hardware acceleration cluster, the technology described herein allows for multiple neural networks to be performed simultaneously (e.g., at least partially in parallel) and/or sequentially, and for the results to be combined together. In addition, because the SoC(s) 904 may include various compute engines (e.g., processors 402, CPUs 906, GPU(s) 908, accelerator(s), etc.), tasks may be distributed between and among the compute engines, in some instances without common cause failures due to the discrete footprint of the compute engines. Further, because the SoC(s) 904 may include a dedicated safety processor(s) 913 (or safety island 913), critical safety or redundant operations may be performed without common cause failures from the main processing components or compute engines of the SoC(s) 904.

In some examples, the machine learning model(s) (e.g., deep neural networks, language models, LLMs, VLMs, multi-modal language models, perception models, tracking models, fusion models, transformer models, diffusion models, encoder-only models, decoder-only models, encoder-decoder models, neural rendering field (NERF) models, etc.) described herein may be packaged as a microservice-such an inference microservice (e.g., NVIDIA NIMs)—which may include a container (e.g., an operating system (OS)—level virtualization package) that may include an application programming interface (API) layer, a server layer, a runtime layer, and/or a model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples—such as where the model(s) is large—the model(s) may be hosted/stored in the cloud (e.g., in a datacenter) and/or may be hosted on-premises and/or at the edge (e.g., on a local server or computing component, but outside of the container). In such embodiments, the model(s) may be accessible via one or more APIs-such as REST APIs. As such, and in some embodiments, the machine learning model(s) described herein may be deployed as an inference microservice to accelerate deployment of a model(s) on any cloud, datacenter, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring). The machine learning model(s) described herein may be included as part of the microservice along with an accelerated infrastructure with the ability to deploy with a single command and/or orchestrate and auto-scale with a container orchestration system on accelerated infrastructure (e.g., on a single device up to datacenter scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

Although examples may be described herein with respect to using machine learning models, such as neural networks, this is not intended to be limiting. For example, and without limitation, any of the various machine learning models and/or neural networks described herein may include any type of machine learning model, such as a machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoder neural networks, artificial neural networks (ANNs), convolutional neural networks (CNNs), recurrent neural networks (RNNs), perceptrons, Long/Short Term Memory (LSTM) networks, multi-layer perceptron (MLP) networks, deep stacking networks (DSNs), generative pre-training (GPT) models or networks, feed forward networks, radial basis function ANNs, self-organizing maps (SOMs), Kohonen maps, Hopfield networks, Boltzmann machine, deep belief neural networks, deconvolutional neural networks, generative adversarial networks (GANs), liquid state machines, modular neural networks, liquid state machines, sequence-to-sequence models, networks using transformer architectures, state space models (SSMs) (e.g., networks using Mamba architectures (e.g., Mamba-1, Mamba 2, etc.), networks using selective state space models, networks using structured state space sequence models, etc.), diffusion models (e.g., diffusion probabilistic models, score-based generative models, etc.), neural radiance field (NeRF) models, Gaussian splat models, Kolmogorov-Arnold networks (KANs), models with encoder-only architectures, models with decoder-only architectures, models with encoder-decoder architectures, generative machine learning models, language models, large language models (LLMs), multi-modal language models (MMLMs), large action models (LAMs), other machine learning models, etc.), and/or other types of machine learning models. All such machine learning aspects may be applicable in the ML algorithms and discussions in connection with at least FIG. 3.

In some examples, the example architecture of a computing system 900 may be used such that the at least one processor, marked as CPU 906, may perform instructions to coordinate between GPUs 908 in support of a streaming job. The CPU and GPUs may perform or support a scaler process within clusters having nodes in a data plane. The scaler process may retrieve progress information associated with a streaming job from within the data plane and may use the progress information to request a manager sub-system of a control plane to allow or support a scaling of at least one of the clusters to add or remove nodes, which perform the streaming job, from the available nodes.

In some examples, one or more of the CPU or GPUs may be used for listening to a communication for data to the nodes as part of the streaming job. One or more of the CPU or GPUs may be used to facilitate a progress report maintained in a file system. One or more of the CPU or GPUs may be used to provide all or parts of the progress report as the progress information which may be used to perform explicit detection or prediction of an open-door for collision detection and avoidance herein. One or more of the CPU or GPUs may execute instructions further to configure the one or more processors to determine a status associated with the streaming job. This may be from the progress information. One or more of the CPU or GPUs may be used to determine a number of the nodes to be added or removed, as part of the scaling, to complete the streaming job.

In some examples, one or more of the CPU or GPUs may be used for the scaling so that a first number of the nodes may be provided may perform the streaming job with a processing rate that is greater than an input rate of values of an input stream which is subject to processing as part of the streaming job. In some examples, one or more of the CPU or GPUs may be used for the scaling to provide a second number of the nodes such that a size of the input stream remains within a predetermined lag threshold. In some examples, one or more of the CPU or GPUs may be used to provide the scaling for individual ones of different input sources associated with the streaming job and which may be included in individual ones of the clusters.

In some examples, one or more of the CPU or GPUs may be such that the streaming job is performed with the processing rate including a first predetermined value provided as part of the streaming job and which may represent a measurement of rows-per-second of records to be processed in the streaming job and as part of a current configuration of the plurality of nodes. The input rate may be a second predetermined value also provided as part of the streaming job and based in part on a number of rows the records being processed per second as part of the streaming job. The predetermined lag threshold used may be a measure of a number of the records remaining in an input stream for the streaming job.

In some examples, one or more of the CPU or GPUs may be used to train a ML model with data generated from one or more of input rates, processing rates, or lag thresholds of different records subject to processing as part of different streaming jobs. In some examples, one or more of the CPU or GPUs may use the ML model to generate an output representing a prediction or an inference of one or more of an input rate, a processing rate, or a lag threshold to allow or support a reactive or proactive application of the scaling of the at least one of the clusters to add or remove the nodes, which are used to perform the stream job, from the nodes which are part of the clusters.

In some examples, one or more of the CPU or GPUs may facilitate one or more APIs between the control plane and the data plane. The APIs may allow messaging between the manager sub-system and the scaler process and in support of the scaling of at the least one of the clusters to add or remove the nodes, which are used to perform the streaming job. In addition, the APIs may perform an O-auth authentication between the manager sub-system and the scaler process to support or initiate the messaging part of the communication between the scaler process and the manager sub-system.

In some examples, the at least one processor may be such that it is included within at least one of a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system for performing one or more deep learning operations; a system implemented using an edge device; a system implemented using a robot; a system for performing one or more generative AI operations; a system for performing operations using one or more large language models (LLMs); a system for performing operations using one or more vision language models (VLMs); a system for performing operations using one or more multi-modal language models (MMLMs); a system for performing operations using one or more vision-language-action (VLA) models; a system for using or deploying one or more inference microservices; a system for performing one or more conversational AI operations; a system for generating synthetic data; a system for presenting at least one of virtual reality content, augmented reality content, or mixed reality content; a system incorporating one or more virtual machines (VMs); a system implemented at least partially in a datacenter; or a system implemented at least partially using cloud computing resources.

In some examples, the at least one processor may be such that it includes, such as part of a larger system, at least one of a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system for performing one or more deep learning operations; a system implemented using an edge device; a system implemented using a robot; a system for performing one or more generative AI operations; a system for performing operations using one or more LLMs; a system for performing operations using one or more VLMs; a system for performing operations using one or more MMLMs; a system for performing operations using one or more VLA models; a system for using or deploying one or more inference microservices; a system for performing one or more conversational AI operations; a system for generating synthetic data; a system for presenting at least one of virtual reality content, augmented reality content, or mixed reality content; a system incorporating one or more VMs; a system implemented at least partially in a datacenter; or a system implemented at least partially using cloud computing resources.

For example, in the above systems, at least one processor may be included for explicit detection or prediction of an open-door for collision detection and avoidance herein. For example, the processor may be part of a system (such as it may include or be included in a further system) for autonomous or semi-autonomous machine; simulation operations; digital twin operations; light transport simulation; collaborative content creation for 3D assets; deep learning operations; an edge device; a robot; generative AI operations; LLMs; VLMs; MMLMs; VLA models; inference microservices; conversational AI operations; synthetic data; virtual reality content, augmented reality content, or mixed reality content; VMs; datacenter; or cloud computing resources.

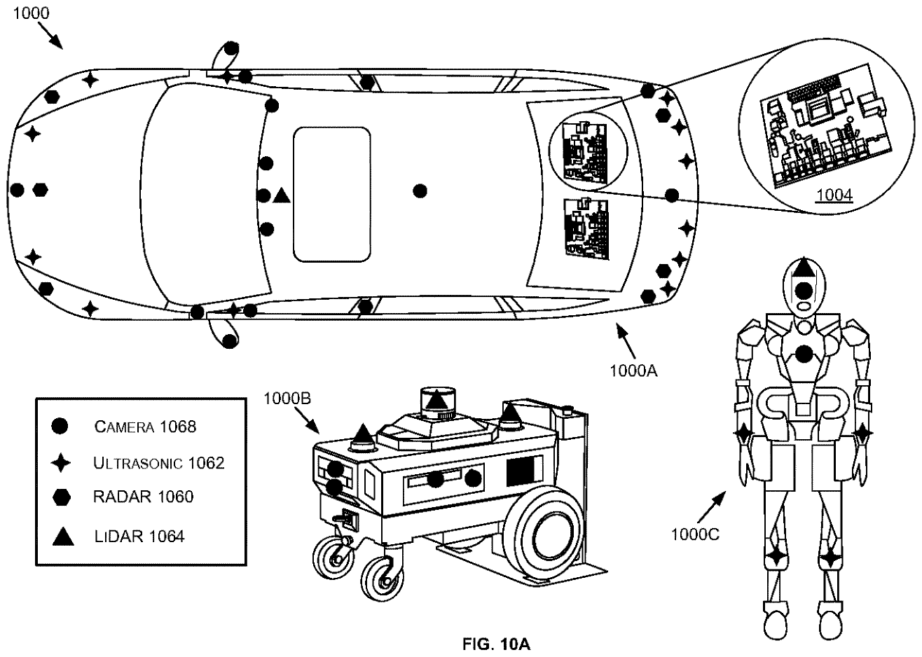

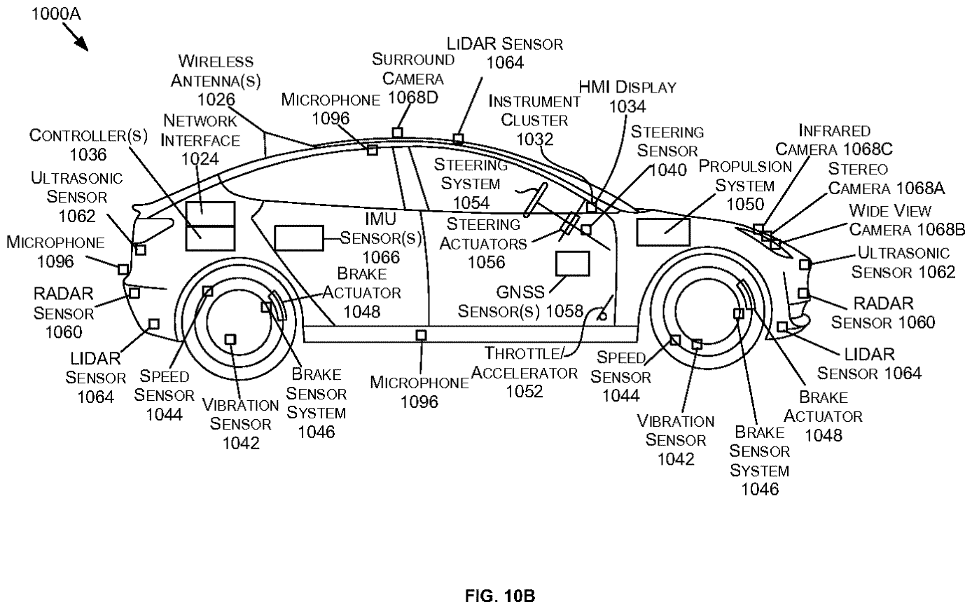

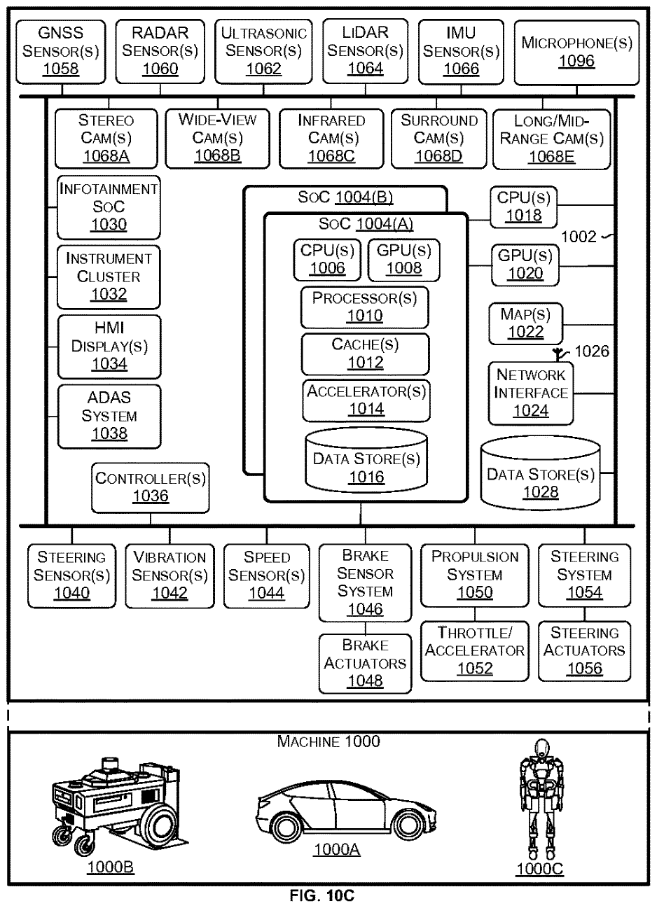

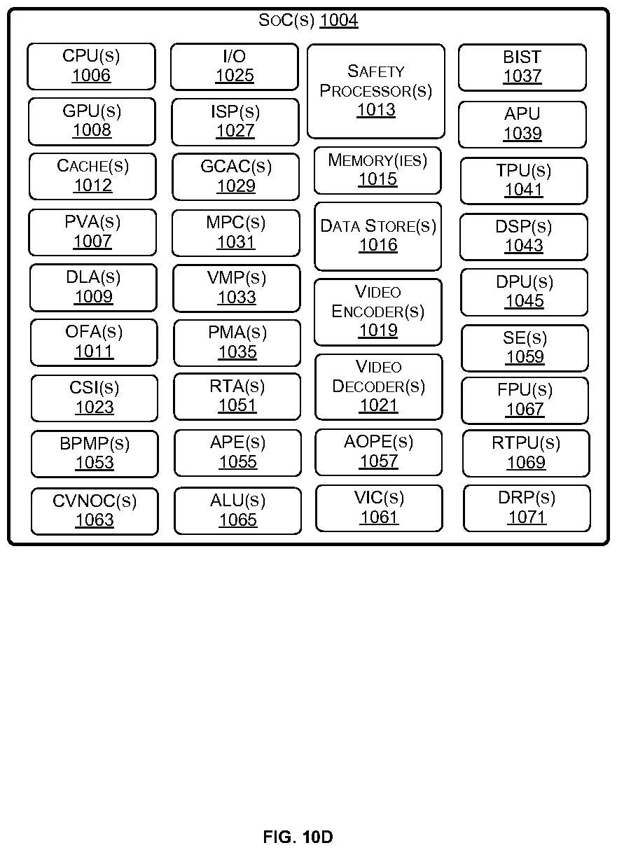

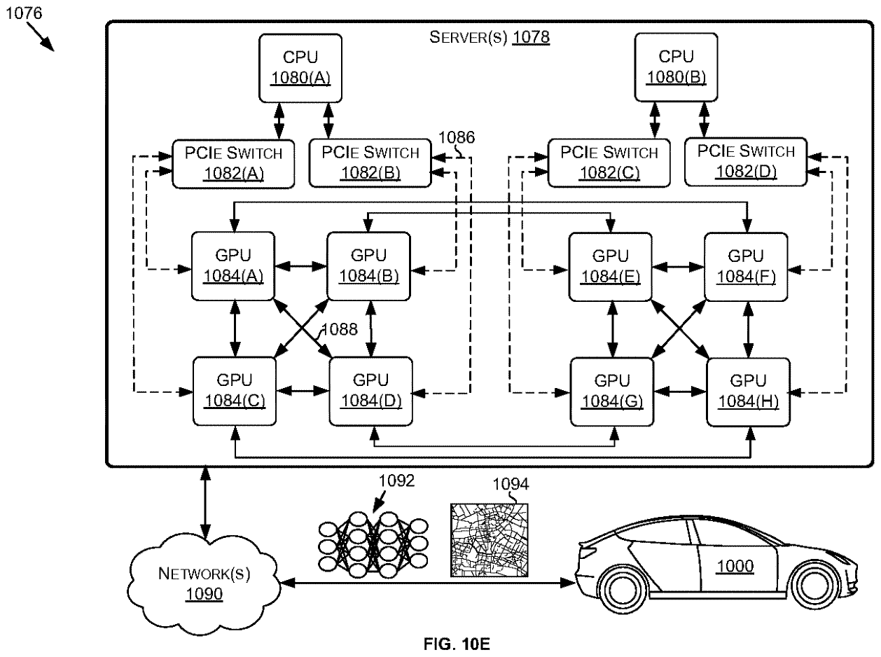

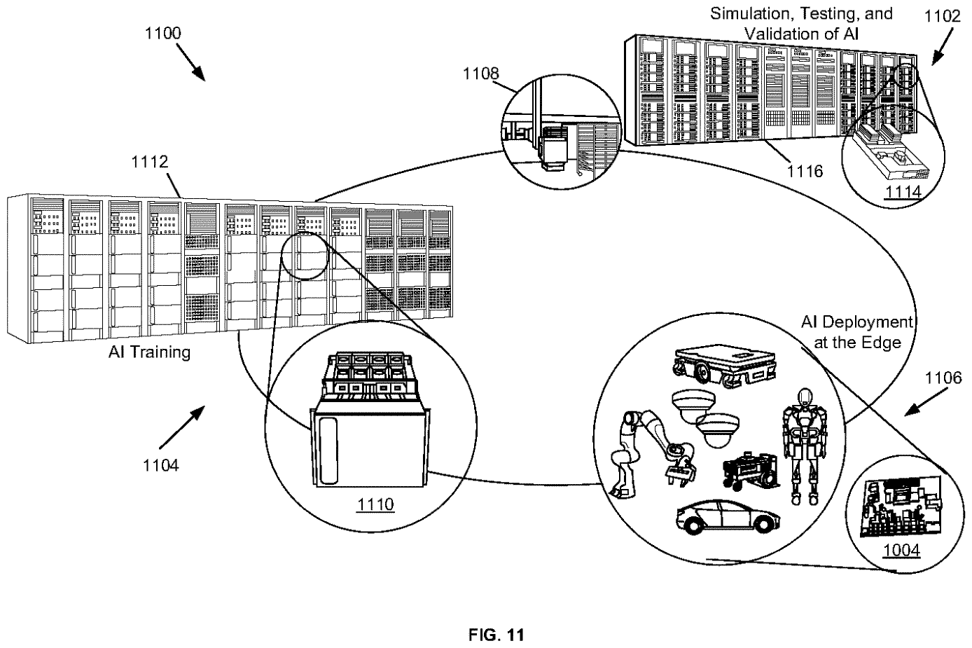

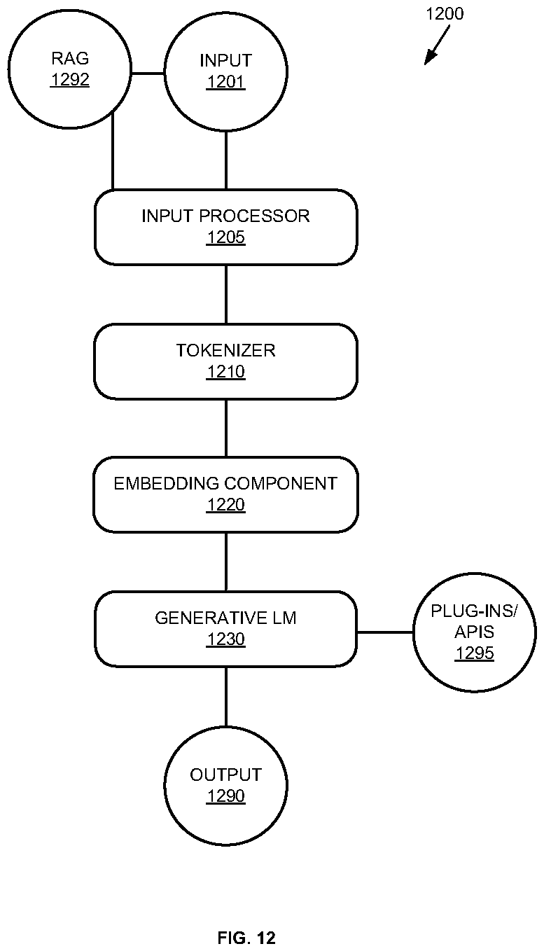

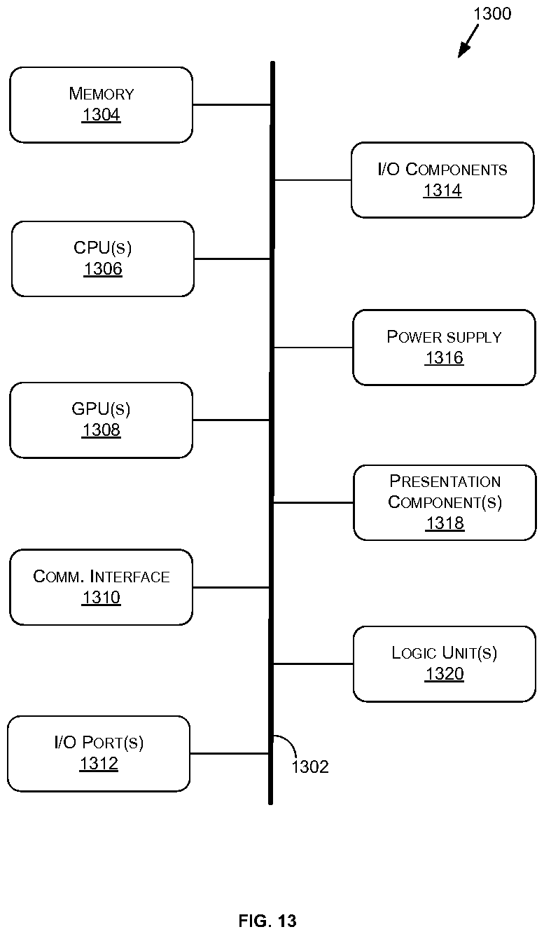

Although the present disclosure may be described with respect to an example autonomous or semi-autonomous vehicle, robot, and/or other machine type 1000 (alternatively referred to herein as “vehicle 1000,” “ego-vehicle 1000,” “machine 1000,” “ego-machine 1000,” “robot 1000,” and/or “ego-robot 1000,” an example of which is described with respect to FIGS. 10A-10E), this is not intended to be limiting. For example, the systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms (e.g., autonomous mobile robots (AMRs), humanoid robots, robotic arms and/or end-effectors, warehouse vehicles, off-road vehicles, vehicles coupled to one or more trailers, flying vessels, watercraft, shuttles (e.g., robotaxis), emergency response vehicles, motorcycles, electric or motorized bicycles, aircraft, construction vehicles, underwater craft (e.g., piloted or unpiloted submarines), drones, and/or other vehicle, robot, or machine types. In addition, although the present disclosure may be described with respect to explicit detection or prediction of an open-door for collision detection and avoidance herein, this is not intended to be limiting, and the systems and methods described herein may be used in augmented reality (AR), virtual reality (VR), mixed reality (MR), robotics, security and surveillance (e.g., smart cities), autonomous or semi-autonomous machine applications, industrial manufacturing, simulation, and/or any other technology spaces where explicit detection or prediction of an open-door for collision detection and avoidance herein may be used. In some embodiments, the systems, methods, and/or processes described herein may be executed using similar components, features, and/or functionality to those of example machine 1000 of FIGS. 10A-10E, example computing ecosystem 1100 of FIG. 11, example generative language model system 1200 of FIG. 12, and/or example computing device 1300 of FIG. 13.

In some embodiments, the systems and methods described herein may be performed within a simulation environment (e.g., NVIDIA's DriveSIM, ISAAC Sim, ISAAC Gym, ISAAC Lab, etc.) using simulated data (e.g., simulated environmental data and simulated sensor data of simulated sensors of a virtual or simulated vehicle, robot, or machine within the simulated environment). For example, simulated input data (e.g., map data, perception data, ego-motion data, tactile data, and/or any other data described herein) may be used to perform explicit detection or prediction of an open-door for collision detection and avoidance herein, and which may be used to perform operations associated with the virtual machine within the simulation environment. These simulated operations may be used to test performance of the underlying algorithms, systems, and/or processes prior to deploying them in the real-world. In some instances, the simulation may be used to generate synthetic training data—e.g., sensors from within the simulation. The synthetic training data (in addition to or alternatively from real-world data) may then be used or processed for explicit detection or prediction of an open-door for collision detection and avoidance herein.

In any example, such as where a simulation environment is used for testing, validation, training, etc., the simulation environment and/or associated training data may be rendered or otherwise generated using one or more light transport simulation algorithms—such as one or more ray-tracing and/or path-tracing algorithms. Where light transport simulation is used, the simulation system may employ one or more dedicated ray-tracing hardware accelerators and/or processors (e.g., NVIDIA's RTX, or another real-time ray-tracing GPU, such as those that include one or more ray tracing (RT) cores) optimized for performing real-time or near real-time light transport simulation operations in conjunction with one or more other processors of the system (e.g., GPUs, CPUs, accelerators, etc.). In some embodiments, the simulation environment and/or one or more objects, features, or components thereof may be generated or managed within a three-dimensional (3D) content collaboration platform (e.g., NVIDIA's OMNIVERSE) that may be optimized or suitable for industrial digitalization, generative physical artificial intelligence, and/or other use cases, applications, and/or services. For example, the content collaboration platform or system may include a system for using or developing universal scene descriptor (USD) (e.g., OpenUSD) data for managing objects, features, scenes, etc. within a simulated environment, digital environment, etc. The platform may include real physics simulation (e.g., using NVIDIA's PhysX software developer kit (SDK)), in order to simulate real physics and physical interactions with simulations hosted by the platform. The platform may integrate OpenUSD along with ray tracing/path tracing/light transport simulation (e.g., NVIDIA's RTX rendering technologies) into software tools and simulation workflows for building, training, deploying, and/or testing AI systems-such as systems for testing, validating, training (e.g., machine learning models, neural networks, etc.), and/or other tasks related to automobiles, robots, other machine types, and/or other systems and applications. In some examples, the simulation environment may include a digital twin of a real environment, such as a digital twin of a specific stretch of roadway, a warehouse, a datacenter, an airport, a geographic area, a marine area, and/or any other real environment where autonomous or semi-autonomous vehicles or machines may operate.

In some embodiments, teleoperation or remote control of a vehicle, robot, and/or other machine may be performed using a remote control or teleoperation system. For example, the systems and methods described herein may be used explicit detection or prediction of an open-door for collision detection and avoidance herein, that may be included in a visualization or mapping of an environment to aid a remote operator in controlling- or providing waypoints or other indications of control or navigation—an autonomous or semi-autonomous machine through an environment. As such, the remote operator may use the visual, audible, textual, and/or other clues or indicators generated using the systems and methods described herein to aid in navigating the vehicle, robot, machine, etc. through a real-world environment using the teleoperation system.

In some embodiments, the system and methods described herein may be deployed in a robotics application. For example, a robot or robotic system may include one or more onboard processors (e.g., CPUs, GPUs, hardware-based deep learning accelerators (DLAs), deep learning accelerator clusters (XNNs), neural processing units (NPUs), neural network accelerators (NNAs), hardware-based programmable vision accelerators (PVAs)—which may include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models). The robotic system may use these processors to execute one or more machine learning models (e.g., language models, vision language models (VLMs), large language models (LLMs), vision-language-action (VLA) models, multi-modal language models (MMLMs), etc.) that allow it to perform complex tasks autonomously or semi-autonomously, such as interacting with and/or manipulating static and/or dynamic objects, or navigating environments using sensors such as cameras, LiDAR, RADAR, ultrasonic sensors, and more. The system may use sensor fusion techniques to combine data from multiple sensors (e.g., cameras, infrared, LiDAR, RADAR, accelerometers) to create a comprehensive model of the robot's surroundings. This data may be processed locally on the robot or sent to remote servers for more computationally intensive tasks, such as 3D mapping or SLAM (Simultaneous Localization and Mapping). In one or more embodiments, data from individual robots (e.g., sensor data, task status, or environmental conditions) may be uploaded to the cloud, where centralized AI models can analyze and distribute optimized commands to an entire fleet. In some embodiments, the machine learning model(s) (e.g., language models, VLMs, VLAs, LLMs, MMLMs, diffusion models, NeRF models, DNNs, etc.) described herein may be used to allow the robot to perceive and reason about the environment and/or communicate with one or more other robots and/or persons in an environment. In some embodiments, the robot may communicate (e.g., using one or more network interface cards (NICs) and/or data processing units (DPUs)) with one or more locally hosted servers/computing devices and/or with one or more remotely located servers/computing devices (e.g., in one or more datacenters).

In some embodiments, the system and methods described herein may be deployed in an in-vehicle infotainment (IVI) system or in-cabin experience (IX) application. For example, the infotainment system within a vehicle (e.g., cars, trucks, drones, construction equipment, robots, semi-autonomous vehicles, or autonomous vehicles) may include one or more onboard processors (e.g., CPUs, GPUs, hardware-based deep learning accelerators (DLAs), deep learning accelerator cluster (XNNs), neural processing units (NPUs), neural network accelerators (NNAs), hardware-based programmable vision accelerators (PVAs)—which may include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models). and memory and/or storage (e.g., for storing entertainment content, navigation data, and user preferences). The system may use these processors to execute one or more machine learning models (e.g., language models) to enable features such as voice control, personalized media recommendations, dynamic navigation, and real-time communication with other services through network connectivity. The in-vehicle infotainment system may also use natural language processing (NLP) models to enable voice-based interaction. The one or more machine learning models may be stored locally or accessed through one or more APIs that connect to cloud services, enabling the system to process requests in real time or near real-time.

In some examples, the machine learning model(s) (e.g., deep neural networks, language models, LLMs, VLMs, multi-modal language models, vision-language-action (VLA) models, perception models, tracking models, fusion models, transformer models, diffusion models, encoder-only models, decoder-only models, encoder-decoder models, neural rendering field (NERF) models, etc.) described herein may be packaged as a microservice-such an inference microservice (e.g., NVIDIA NIMs)—which may include a container (e.g., an operating system (OS)—level virtualization package) that may include an application programming interface (API) layer, a server layer, a runtime layer, and/or a model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples—such as where the model(s) is large—the model(s) may be hosted/stored in the cloud (e.g., in a datacenter) and/or may be hosted on-premises and/or at the edge (e.g., on a local server or computing device, but outside of the container). In such embodiments, the model(s) may be accessible via one or more APIs-such as REST APIs. As such, and in some embodiments, the machine learning model(s) described herein may be deployed as an inference microservice to accelerate deployment of a model(s) on any cloud, datacenter, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications-such as NVIDIA's TensorRT), and/or enterprise management data for telemetry (e.g., including identity, metrics, health checks, and/or monitoring). The machine learning model(s) described herein may be included as part of the microservice along with an accelerated infrastructure with the ability to deploy with a single command and/or orchestrate and auto-scale with a container orchestration system on accelerated infrastructure (e.g., on a single device up to datacenter scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

Although examples may be described herein with respect to using machine learning models, such as neural networks, this is not intended to be limiting. For example, and without limitation, any of the various machine learning models and/or neural networks described herein may include any type of machine learning model, such as a machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoder neural networks, artificial neural networks (ANNs), convolutional neural networks (CNNs), recurrent neural networks (RNNs), perceptrons, Long/Short Term Memory (LSTM) networks, multi-layer perceptron (MLP) networks, deep stacking networks (DSNs), generative pre-training (GPT) models or networks, feed forward networks, radial basis function ANNs, self-organizing maps (SOMs), Kohonen maps, Hopfield networks, Boltzmann machine, deep belief neural networks, deconvolutional neural networks, generative adversarial networks (GANs), liquid state machines, modular neural networks, liquid state machines, sequence-to-sequence models, networks using transformer architectures, state space models (SSMs) (e.g., networks using Mamba architectures (e.g., Mamba-1, Mamba 2, etc.), networks using selective state space models, networks using structured state space sequence models, etc.), diffusion models (e.g., diffusion probabilistic models, score-based generative models, etc.), neural radiance field (NeRF) models, Gaussian splat models, Kolmogorov-Arnold networks (KANs), models with encoder-only architectures, models with decoder-only architectures, models with encoder-decoder architectures, generative machine learning models, language models, large language models (LLMs), vision language models (VLMs), multi-modal language models (MMLMs), large action models (LAMs), vision-language-action (VLA) models, etc.), and/or other types of machine learning models.

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, watercraft, shuttles (e.g., robotaxis), emergency response vehicles, motorcycles, electric or motorized bicycles, aircraft, construction vehicles, underwater craft (e.g., piloted or unpiloted submarines), drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, datacenter processing, conversational AI, light transport simulation (e.g., ray-tracing, path tracing, etc.), collaborative content creation for 3D assets (e.g., NVIDIA's Omniverse), cloud computing, and/or any other suitable applications.

Disclosed embodiments may be comprised in a variety of different systems such as automotive systems (e.g., a control system for an autonomous or semi-autonomous machine, a perception system for an autonomous or semi-autonomous machine, etc.), systems implemented using a robot, aerial systems, medial systems, boating systems, smart area monitoring systems, systems for performing deep learning operations, systems for performing simulation operations, systems for performing digital twin operations, systems implemented using an edge device, systems implementing language models-such as large language models (LLMs), vision language models (VLMs), vision-language-action (VLA) models, and/or multi-modal language models, systems using or deploying one or more inference microservices, systems that incorporate deploy one or more machine learning models in a service or microservice along with an OS-level virtualization package (e.g., a container), systems incorporating one or more virtual machines (VMs), systems for performing synthetic data generation operations, systems implemented at least partially in a datacenter, systems for performing conversational AI operations, systems for performing light transport simulation, systems for performing collaborative content creation for 3D assets, systems for performing generative AI operations, systems implemented at least partially using cloud computing resources, and/or other types of systems.

With reference to FIG. 1A-2B, 4, and 8-13, and in accordance with some embodiments of the present disclosure. It should be understood that this and other arrangements described herein are set forth only as examples. Other arrangements, components, features, and elements (e.g., machines, interfaces, functions, orders, groupings of functions, etc.) may be used in addition to or instead of those shown, and some elements may be omitted altogether. Further, many of the arrangements, components, features, elements, etc. described herein are functional entities that may be implemented as discrete or distributed components or in conjunction with other components, and in any suitable combination and location (e.g., on a local device, vehicle, or machine at the edge, on-premises—such as locally hosted servers, remotely located-such as in one or more computing or server devices in one or more datacenters in the cloud, and/or at other locations). Various functions described herein as being performed by entities may be carried out by hardware, firmware, and/or software. For instance, various functions may be carried out using one or more processors (e.g., central processing units (CPU(s)), graphics processing units (GPU(s)), microprocessors, microcontrollers, embedded processors, digital signal processors (DSPs), image signal processors (ISPs), physics processing units (PPUs), field-programmable gate arrays (FPGAs), accelerator(s) (e.g., deep learning accelerators (DLAs), deep learning accelerator cluster (XNNs), neural network accelerators (NNAs), and/or neural processing units (NPUs), programmable vision accelerators (PVAs), optical flow accelerators (OFAs), etc.), application specific integrated circuits (ASICs), data processing units (DPUs), quantum processors, etc.) executing instructions stored in memory. In some embodiments, the systems, methods, and processes described herein may be executed using similar components, features, and/or functionality to those of example machine 1000 of FIGS. 10A-10E, example computing ecosystem 1100 of FIG. 11, example generative language model system 1200 of FIG. 12, and/or example computing device 1300 of FIG. 13.

Further, each block of the methods described herein comprises a computing process that may be performed using any combination of hardware, firmware, and/or software. For instance, various functions may be carried out using one or more processors (such as, but not limited to, those described herein) executing instructions stored in one or more memories or memory systems. In some embodiments, the computer processes may also be embodied as computer-usable instructions stored on computer storage media. The methods may be provided by a standalone application, a service or hosted service (standalone or in combination with another hosted service), an application programming interface (API) and/or a plug-in to another product, etc. In addition, the methods described may be performed, by way of example, with respect to any of the systems in FIGS. 1A-4, and 8-13. These methods may additionally or alternatively be executed by any one system, or any combination of systems, including, but not limited to, those described herein.

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, watercraft, shuttles (e.g., robotaxis), emergency response vehicles, motorcycles, electric or motorized bicycles, aircraft, construction vehicles, underwater craft (e.g., piloted or unpiloted submarines), drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, datacenter processing, conversational AI, light transport simulation (e.g., ray-tracing, path tracing, etc.), collaborative content creation for 3D assets (e.g., NVIDIA's Omniverse), cloud computing, and/or any other suitable applications.

Disclosed embodiments may be comprised in a variety of different systems such as automotive systems (e.g., a control system for an autonomous or semi-autonomous machine, a perception system for an autonomous or semi-autonomous machine, etc.), systems implemented using a robot, aerial systems, medial systems, boating systems, smart area monitoring systems, systems for performing deep learning operations, systems for performing simulation operations, systems for performing digital twin operations, systems implemented using an edge device, systems implementing language models-such as large language models (LLMs), vision language models (VLMs), and/or multi-modal language models, systems using or deploying one or more inference microservices, systems that incorporate deploy one or more machine learning models in a service or microservice along with an OS-level virtualization package (e.g., a container), systems incorporating one or more virtual machines (VMs), systems for performing synthetic data generation operations, systems implemented at least partially in a datacenter, systems for performing conversational AI operations, systems for performing light transport simulation, systems for performing collaborative content creation for 3D assets, systems for performing generative AI operations, systems implemented at least partially using cloud computing resources, and/or other types of systems.

### Example Autonomous or Semi-Autonomous Machine

FIG. 10A is an example of sensor locations having corresponding fields of view or sensory fields for an autonomous or semi-autonomous vehicle 1000A, an autonomous mobile robot (AMR) 1000A, and a humanoid robot 1000C, in accordance with some embodiments of the present disclosure. Although three types of machines 1000 are illustrated, this is not intended to be limiting, and the machine(s) 1000 described herein may include a vehicle, a car, a truck, a bus, a first responder vehicle, a shuttle, an electric or motorized bicycle, a motorcycle, a fire truck, a police or emergency vehicle, an ambulance, a watercraft, a construction vehicle, an underwater craft, a robot (e.g., AMR, humanoid, robotic arm, end-effector, forklift, etc.), a drone, an aircraft, a vehicle coupled to a trailer (e.g., a semi-tractor-trailer truck used for hauling cargo), and/or another type of vehicle or machine (e.g., that is unmanned and/or that accommodates one or more passengers). The vehicle 1000A, AMR 1000B, humanoid robot 1000C, and/or other machine types may be referred to herein collectively as machine 1000, in some instances.

With respect to vehicles 1000A, autonomous and semi-autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The machine 1000 may be capable of functionality in accordance with one or more of Level 3-Level 5 of the autonomous driving levels. The machine 1000 may be capable of functionality in accordance with one or more of Level 1-Level 5 of the autonomous driving levels. For example, the machine 1000 may be capable of driver assistance (Level 1), partial automation (Level 2, Level 2+, Level 2++), conditional automation (Level 3), high automation (Level 4), and/or full automation (Level 5), depending on the embodiment. The term “autonomous,” as used herein, may include any and/or all types of autonomy for the machine 1000 or other machine, such as being fully autonomous, being highly autonomous, being conditionally autonomous, being partially autonomous, providing assistive autonomy, being semi-autonomous, being primarily autonomous, or other designation.

With respect to FIG. 10A, the sensors and their respective fields of view (not illustrated for clarity purposes) or sensory fields (not illustrated for clarity purposes) are one example embodiment and are not intended to be limiting. Although not illustrated, each sensor may have a corresponding field of view (e.g., a 360 degree field of view of a surround camera 1068D, a 180 degree field of view of a wide-view camera 1068, a 360 degree sensory field of a LiDAR sensor 1064, etc.). For example, only a subset of the sensors illustrated may be included, additional sensors may be included, alternative sensors may be included, the number of each sensor modality may differ, the sensor modalities may differ (e.g., may not include LiDAR or RADAR, may include SONAR, thermal sensors, etc.), the sensor locations may be different from those illustrated on the vehicle 1000A, AMR 1000B, and/or humanoid robot 1000C, etc. For example, with respect to the vehicle 1000A, depending on the type (e.g., SUV, truck, sedan, robot, motorcycle, etc.), size (e.g., 18-wheeler, moving van, small sedan, etc.), and related functionality (e.g., L2 vs. L5), the locations, numbers, modalities, and/or other sensor information may differ. Similarly, for the AMR 1000B and/or humanoid robot 1000C, the shape, size, purpose, implementation, model, etc. may dictate the number and types of sensors used.

As illustrated in FIG. 10A, the autonomous or semi-autonomous vehicle 1000A, the AMR 1000B, and the humanoid robot 1000C may include different sensor types, number, and locations. For a non-limiting example, the vehicle 1000A may include twelve cameras 1068, such as a front wide camera (e.g., 120 degree field of view (FOV)), a front telephoto camera (e.g., 30 degree fOV), a side rear left camera (e.g., 70 degree fOV), a side rear right camera (e.g., 70 degree fOV), a front fisheye camera (e.g., 200 degree fOV), a rear fisheye camera (e.g., 200 degree fOV), a left fisheye camera (e.g., 200 degree fOV), a right fisheye camera (e.g., 200 degree fOV), a front telephoto satellite camera (e.g., 30 degree fOV), a rear telephoto camera (e.g., 30 degree fOV), a cross left camera (e.g., 120 degree fOV), and a cross right camera (e.g., 120 degree fOV). The camera(s) 1068 may use, in embodiments, a gigabit multimedia serial link (GMSL) interface—such as GMSL2—as input/output (I/O).

In some embodiments, although not illustrated in FIG. 10A, the vehicle 1000A may include an in-cabin occupant and/or driver monitoring system, that may include various different sensors. For example, the in-cabin sensors may include various cameras 1068, such as a driver monitoring camera (e.g., 55 degree fOV positioned forward of and facing toward the driver seat), a front occupant monitoring camera (e.g., 190 degree fOV positioned forward of and facing the front occupant(s) seat(s)), and a rear occupant monitoring camera (e.g., 190 degrees positioned forward of and facing the rear occupant(s) seat(s)). Similar to the external facing camera(s) 1068, the internal camera(s) 1068 may, in embodiments, use a GMSL (such as GMSL2) interface for I/O.

As another non-limiting example, the vehicle 1000A may further include nine RADAR sensors 1060. For example, the vehicle 1000A may include a front center imaging RADAR sensor (e.g., 120 degree fOV or sensory field), a corner front left RADAR sensor (e.g., 160 degree fOV or sensory field), a corner front right RADAR sensor (e.g., 160 degree fOV or sensory field), a corner rear right RADAR sensor (e.g., 160 degree fOV or sensory field), a side left RADAR sensor (e.g., 160 degree fOV or sensory field), a side right RADAR sensor (e.g., 160 degree fOV or sensory field), a rear left RADAR sensor (e.g., 50 degree fOV or sensory field), and rear right RADAR sensor (e.g., 50 degree fOV or sensory field). The RADAR sensor(s) 1060 may use, in embodiments, an Ethernet interface as I/O.

The vehicle(s) 1000A may further include, as a non-limiting example, twelve ultrasonic sensors 1062. As illustrated in FIG. 10A, the ultrasonic sensors may be positioned along the front and rear bumpers of the vehicle 1000A, and along the side of the vehicle 1000A, and may be used to detect objects (static and dynamic) in close proximity to the vehicle 1000A. In some embodiments, the ultrasonic sensor(s) 1062 may use a DS13 interface as I/O.

The vehicle(s) 1000A may further include, as a non-limiting example, a LiDAR sensor 1064, such as a front center LiDAR sensor (e.g., 120 degree horizontal FOV or sensory field and 30 degree vertical FOV or sensor field). In some embodiments, such as where additional or alternative LiDAR sensors are used, the LiDAR sensor may have differing horizontal and vertical fields of view or sensory fields. For example, a LiDAR sensor 1064 may include a 360 degree horizontal FOV or sensory field (such as in a spinning LiDAR sensor) and a 90 degree vertical FOV or sensory field. In some embodiment, the LiDAR sensor(s) 1064 may use an Ethernet interface as I/O.

The autonomous mobile robot (AMR) 1000B may include, as a non-limiting example, three LiDAR sensors 1064. For example, the top-most illustrated LiDAR sensor 1064 may include a beam or 3D LiDAR sensor (e.g., 360 degree horizontal and 90 degree vertical FOV or sensory field), and the front and rear LiDAR sensors may include planar or 2D LiDAR sensors (e.g., 180 degree horizontal FOV or sensory field).

The AMR 1000B may further include, as a non-limiting embodiment, eight cameras 1068, such as a front stereo camera (e.g., 120 degree fOV), a rear stereo camera (e.g., 120 degree fOV), a left stereo camera (e.g., 120 degree fOV), a right stereo camera (e.g., 120 degree fOV), a front fisheye camera (e.g., 202 degree+−3 degree fOV), a rear fisheye camera (e.g., 202 degree+−3 degree fOV), a left fisheye camera (e.g., 202 degree+−3 degree fOV), and a right fisheye camera (e.g., 202 degree+−3 degree fOV).

The AMR 1000B may further include a charging port, charging port contacts, a status indicator light, one or more (e.g., four) RGB LEDs, one or more IMU sensors 1066, a magnetometer, and a barometer. The AMR 1000B is capable of high-precision time synchronization between sensors using hardware time stamping, and PTP over Ethernet with less than 10 microseconds for sensor acquisition time. The AMR 1000B provides simultaneous camera capture across all cameras 1068 within 100 microseconds from a single hardware trigger, in embodiments, and can write to disk at 4 GB/second for sensor capture to bag writing (e.g., writing to ROSbags for the robot operation system (ROS)). As such, the AMR 1000B is capable of running the ROS (such as NVIDIA's Isaac ROS), can be teleoperated (as described herein), can map an environment, and can navigate within an environment using visual cameras 1068, LiDARs 1064, and/or other sensor types or modalities.

The humanoid robot 1000C may include, as a non-limiting example, one LiDAR sensor 1064. For example, the LiDAR sensor 1064 may include a beam or 3D LiDAR sensor (e.g., 360 degree horizontal and 90 degree vertical FOV or sensory field), or may include a planar or 2D LiDAR sensor (e.g., 180 degree horizontal FOV or sensory field).

The humanoid robot 1000C may further include, as a non-limiting embodiment, four cameras 1068, such as a front stereo camera (e.g., 120 degree fOV), a rear stereo camera (e.g., 120 degree fOV), a front fisheye camera (e.g., 202 degree+−3 degree fOV), and a rear fisheye camera (e.g., 202 degree+−3 degree fOV).

The humanoid robot 1000C may further include, as a non-limiting embodiment, four ultrasonic sensors 1062, such as a left arm ultrasonic sensor, a right arm ultrasonic sensor, a left leg ultrasonic sensor, and right leg ultrasonic sensor.

The humanoid robot 1000C may further include any number of actuators-such as to allow control and maneuverability of joints. For example, the humanoid robot 1000C may include actuators that allow for various degrees of freedom (DoF) depending on the design. In a non-limiting embodiment, the humanoid robot 1000C may have 40 total degrees of freedom (DoF) (e.g., 6 DoF x 2 for the arms, 6 DoF x 2 for the hands, 6 DoF x 2 for the legs, 2 DoF for the torso, and 2 DoF for the neck). The actuators may convert energy into physical motion, allowing for actions such as joint movements, locomotion, and gripping/manipulation. For example, joint movements may be performed using motors and servos to control the rotation of joints in an arm or manipulator, and to allow for reaching, grabbing, and manipulating objects. Locomotion may be accomplished using wheels, tracks, or other locomotion devices (robotic legs) to move around the environment. Gripping and manipulation may be performed using end-effectors or hands/fingers, which may be equipped with actuators to grip objects, apply force, and perform specific tasks. In some examples, the humanoid robot 1000C may include position and orientation sensors, such as encoders, gyroscopes, and the like, to determine the position of the robot 1000C in space, allowing for location determination and movement tracking. The humanoid robot 1000C may include force and pressure sensors, in embodiments, to detect environment interactions, allowing the robot 1000C to grasp objects with the right force and to avoid obstacles along the way. The perception sensors (e.g., cameras, LiDARs, RADARS, ultrasonic, SONAR, etc.) may be used along with tactile sensors to allow the robot 1000C to perceive objects, shapes, and textures, and to understand when touch is initiated and stopped (along with force sensors that regulate the force used during touch). As a non-limiting example, the humanoid robot 1000C may have a height of about 1-2 meters (e.g., 1.7 meters or 5′ 6″), a weight of 50-70 kg, be capable of moving at a speed of 8 or more km/h, and be able to carry payloads anywhere from 20-100 kg, depending on the design and requirements of the system.

The humanoid robot 1000C, in embodiments, may include a conversational system—such as a conversational system powered by language models (e.g., LLMs, VLMs, MMLMs, VLAs, etc.)—in order to help understand the environment, reason, and communicate with humans, animals, devices, and/or other robots, and/or make planning, control, and navigation decisions. As such, in addition to performing various tasks, the humanoid robot 1000C may use onboard sensors, microphones, and speakers to understanding speech, audio and visual cues, etc., while also being able to communicate back to the environment.

With reference to cameras 1068 of the machine(s) 1000, the camera types for the cameras 1068 may include, but are not limited to, digital cameras that may be adapted for use with the components and/or systems of the machine 1000. For a vehicle 1000A implementation, the camera(s) 1068 may operate at automotive safety integrity level (ASIL) B and/or at another ASIL. The camera types may be capable of any image capture rate, such as 30 frames per second (fps), 60 fps, 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

Cameras with a field of view that include portions of the environment in front of the machine 1000 (e.g., front-facing cameras) may be used for surround view, to help identify forward facing paths and obstacles, as well aid in, with the help of one or more controllers 1036 and/or control SoCs, providing information critical to generating an occupancy grid and/or determining the preferred machine movements, trajectories, and/or paths. Front-facing cameras may be used to perform many of the same ADAS functions as LiDAR, including emergency braking, pedestrian detection, and collision avoidance with aspects applied for explicit detection or prediction of an open-door for collision detection and avoidance herein and using data from such cameras. Front-facing cameras may also be used for ADAS functions and systems including Lane Departure Warnings (“LDW”), Autonomous Cruise Control (“ACC”), and/or other functions such as traffic sign recognition.

A variety of cameras may be used in a front-facing configuration, including, for example, a monocular camera platform that includes a complementary metal oxide semiconductor (“CMOS”) color imager. Another example may be a wide-view camera(s) 1068B that may be used to perceive objects coming into view from the periphery (e.g., pedestrians, warehouse vehicles, other robots, crossing traffic, or bicycles). In addition, any number of long-range camera(s) 1068E (e.g., a long-view stereo camera pair) may be used for depth-based object detection, especially for objects for which a neural network has not yet been trained. The long-range camera(s) 1068E may also be used for object detection and classification, as well as basic object tracking.

Any number of stereo cameras 1068A may also be included in a front-facing and/or other (e.g., rear-facing) configuration. In at least one embodiment, one or more of stereo camera(s) 1068A may include an integrated control unit comprising a scalable processing unit, which may provide a programmable logic (“FPGA”) and a multi-core micro-processor with an integrated Controller Area Network (“CAN”) or Ethernet interface on a single chip. Such a unit may be used to generate a 3D map of the machine's 1000 environment, including a distance estimate for points in the image (e.g., a disparity or depth image). An alternative stereo camera(s) 1068A may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 1068A may be used in addition to, or alternatively from, those described herein. For example, in some embodiments, stereo depth estimation may be performed using other than stereo cameras, such as two monocular cameras having at least partially overlapping fields of view.

Cameras with a field of view that include portions of the environment to the side of the machine 1000 (e.g., side-view cameras) may be used, for example, for surround view, providing information used to create and update the occupancy grid, as well as to generate side impact collision warnings and/or to indicate to an AMR 1000B or humanoid robot 1000C, for example, that there are objects, features, and/or persons present to the side. For example, surround camera(s) 1068D may be positioned on the machine 1000. The surround camera(s) 1068D may include wide-view camera(s) 1068B, fisheye camera(s), 360 degree camera(s), and/or the like. For example, four fisheye cameras may be positioned on the machine's 1000 front, rear, and sides. In an alternative arrangement, the machine 1000 may use three surround camera(s) 1068D (e.g., left, right, and rear), and may leverage one or more other camera(s) (e.g., a forward-facing camera) as a fourth surround view camera.

Cameras 1068 with a field of view that include portions of the environment to the rear of the machine 1000 (e.g., rear-view cameras) may be used for gaining an understanding of objects, features, persons, and/or other information to the rear of the machine 1000, such as for park assistance, surround view, rear collision warnings, planning, control, and navigation determinations, and/or creating and updating an occupancy grid, BEV image representing the environment, height map, etc. A wide variety of cameras 1068 may be used including, but not limited to, cameras 1068 that are also suitable as a front-facing camera(s) (e.g., long-range and/or mid-range camera(s) 1068E, stereo camera(s) 1068A), infrared camera(s) 1068C, etc.), rear-facing camera(s), side-facing camera(s), downward facing camera(s), upward facing camera(s), and/or the like, as described herein.

Similarly, for LiDAR sensors 1064, RADAR sensors 1060, ultrasonic sensors 1062, and/or other sensor modalities or types, the location and placement of the sensors, and their corresponding fields of view or sensory fields may be determined based on the use case, implementation, or design of the particular machine 1000.

For example, the machine(s) 1000 include RADAR sensor(s) 1060 that may be used by the machine 1000 for long-range object detection, even in darkness and/or severe weather conditions. RADAR functional safety levels may be ASIL B, in embodiments. The RADAR sensor(s) 1060 may use the CAN and/or the bus 1002 (e.g., to transmit data generated by the RADAR sensor(s) 1060) for control and to access object tracking data, with access to Ethernet to access raw data in some examples. A wide variety of RADAR sensor types may be used. For example, and without limitation, the RADAR sensor(s) 1060 may be suitable for front, rear, and side RADAR use. In some example, Pulse Doppler RADAR sensor(s) are used.

The RADAR sensor(s) 1060 may include different configurations, such as long range with narrow field of view, short range with wide field of view, short range side coverage, etc. In some examples, long-range RADAR may be used for adaptive cruise control (ACC) functionality. The long-range RADAR systems may provide a broad field of view realized by two or more independent scans, such as within a 250 m range. The RADAR sensor(s) 1060 may help in distinguishing between static and moving objects, and may be used by ADAS systems for emergency brake assist and forward collision warning, by robots for detecting dynamic objects in various environments—such as those with lower or no lighting. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the machine's 1000 surroundings at higher speeds with minimal interference from the periphery (e.g., from traffic in adjacent lanes). The other two antennae may expand the field of view, making it possible to quickly detect objects entering or leaving the machine's immediate path (e.g., lane).

Mid-range RADAR systems may include, as an example, a range of up to 1060 m (front) or 80 m (rear), and a field of view of up to 42 degrees (front) or 150 degrees (rear). Short-range RADAR systems may include, without limitation, RADAR sensors designed to be installed at both ends of a lateral surface (e.g., a rear bumper) such that two beams may be used to constantly monitor the blind spot in the rear and next to the machine 1000 (e.g., vehicle, robot, etc.). As such, short-range RADAR systems may be used in an ADAS system for blind spot detection and/or lane change assist.

The machine 1000 may further include ultrasonic sensor(s) 1062. The ultrasonic sensor(s) 1062, which may be positioned at the front, back, and/or the sides of the machine 1000, may be used for assisting with near-field perception, such as for park assist, collision avoidance (e.g., for robotic parts), and/or to create and update an occupancy grid, evidence grid map (EGM), height map, BEV image, and/or other representation of objects and features in an environment of the machine 1000. A wide variety of ultrasonic sensor(s) 1062 may be used, and different ultrasonic sensor(s) 1062 may be used for different ranges of detection (e.g., 2.5 m, 4 m). The ultrasonic sensor(s) 1062 may operate at functional safety levels of ASIL B, as an example.

The machine 1000 may include LiDAR sensor(s) 1064. The LiDAR sensor(s) 1064 may be used for object and feature detection, pedestrian and other robot detection, emergency braking, collision avoidance, simultaneous localization and mapping (SLAM), free-space detection, and/or other functions. The LiDAR sensor(s) 1064 may be functional safety level ASIL B, in embodiments. In some examples, the machine 1000 may include multiple LiDAR sensors 1064 (e.g., two, four, six, etc.) that may use Ethernet (e.g., to provide data to a Gigabit Ethernet switch).

In some examples, the LiDAR sensor(s) 1064 may be capable of providing a list of objects and their distances for a 360-degree field of view. Commercially available LiDAR sensor(s) 1064 may have an advertised range of approximately 1000 m, with an accuracy of 2 cm-3 cm, and with support for a 1000 Mbps Ethernet connection, for example. In some examples, one or more non-protruding LiDAR sensors 1064 may be used. In such examples, the LiDAR sensor(s) 1064 may be implemented as a small device that may be embedded into the front, rear, sides, top, and/or corners of the machine 1000. The LiDAR sensor(s) 1064, in such examples, may provide up to a 120-degree horizontal and 35-degree vertical field-of-view, with a 200 m range even for low-reflectivity objects. Front-mounted LiDAR sensor(s) 1064 may be configured for a horizontal field of view between 45 degrees and 135 degrees.

In some examples, LiDAR technologies, such as 3D flash LiDAR, may also be used. 3D Flash LiDAR uses a flash of a laser as a transmission source, to illuminate vehicle surroundings up to approximately 200 m. A flash LiDAR unit includes a receptor, which records the laser pulse transit time and the reflected light on each pixel, which in turn corresponds to the range from the vehicle to the objects. Flash LiDAR may allow for highly accurate and distortion-free images of the surroundings to be generated with every laser flash. In some examples, four flash LiDAR sensors may be deployed, one at each side of the machine 1000. Available 3D flash LiDAR systems include a solid-state 3D staring array LiDAR camera with no moving parts other than a fan (e.g., a non-scanning LiDAR device). The flash LiDAR device may use a 5 nanosecond class I (eye-safe) laser pulse per frame and may capture the reflected laser light in the form of 3D range point clouds and co-registered intensity data. By using flash LiDAR, and because flash LiDAR is a solid-state device with no moving parts, the LiDAR sensor(s) 1064 may be less susceptible to motion blur, vibration, and/or shock.

FIG. 10B is an illustration of sensor and component locations of an example autonomous or semi-autonomous vehicle 1000A (alternatively referred to herein as “vehicle 1000,” “ego-vehicle 1000,” “ego-machine 1000,” or “machine 1000,”), in accordance with some embodiments of the present disclosure. Although the vehicle 1000A is illustrated, this is not intended to be limiting, and similar components and/or sensors may be included on any other machine type without departing from the scope of the present disclosure. For example, similar sensors and/or components may be used for a vehicle, a car, a truck, a bus, a first responder vehicle, a shuttle, an electric or motorized bicycle, a motorcycle, a fire truck, a police vehicle, an ambulance, a watercraft, a construction vehicle, an underwater craft, a robot (e.g., AMR, humanoid, robotic arm, end-effector, forklift, etc.), a drone, an aircraft, a vehicle coupled to a trailer (e.g., a semi-tractor-trailer truck used for hauling cargo), and/or another type of vehicle or machine (e.g., that is unmanned and/or that accommodates one or more passengers).

FIG. 10C is a block diagram of an example system architecture for a machine 1000, such as autonomous or semi-autonomous vehicle 1000A, autonomous mobile robot (AMR) 1000B, humanoid robot 1000C, and/or other types of machines, in accordance with some embodiments of the present disclosure. It should be understood that this and other arrangements described herein are set forth only as examples. Other arrangements, components, features, and elements (e.g., machines, interfaces, functions, orders, groupings of functions, etc.) may be used in addition to or instead of those shown, and some elements may be omitted altogether. Further, many of the arrangements, components, features, elements, etc. described herein are functional entities that may be implemented as discrete or distributed components or in conjunction with other components, and in any suitable combination and location (e.g., on a local device, vehicle, or machine at the edge, on-premises-such as locally hosted servers, remotely located-such as in one or more computing or server devices in one or more datacenters in the cloud, and/or at other locations). Various functions described herein as being performed by entities may be carried out by hardware, firmware, and/or software. For instance, various functions may be carried out using one or more processors (e.g., central processing units (CPU(s)), graphics processing units (GPU(s)), microprocessors, microcontrollers, embedded processors, digital signal processors (DSPs), image signal processors (ISPs), physics processing units (PPUs), field-programmable gate arrays (FPGAs), accelerator(s) (e.g., deep learning accelerators (DLAs, deep learning accelerator cluster (XNNs), neural network accelerators (NNAs), and/or neural processing units (NPUs), programmable vision accelerators (PVAs), optical flow accelerators (OFAs), etc.), application-specific integrated circuits (ASICs), data processing units (DPUs), quantum processors, etc.) executing instructions stored in memory. In some embodiments, the systems, methods, and processes described herein may be executed using similar components, features, and/or functionality to those of example machine 1000 of FIGS. 10A-10E, example computing ecosystem 1100 of FIG. 11, example generative language model system 1200 of FIG. 12, and/or example computing device 1300 of FIG. 13.

Each of the components, features, and systems of the machine 1000 in FIG. 10C are illustrated as being connected via bus 1002 (alternatively referred to as a “machine communications network 1002,” or just “communications network 1002”). The bus 1002 may include a Controller Area Network (CAN) data interface (alternatively referred to herein as a “CAN bus”). A CAN may be a network inside the machine 1000 used to aid in control of various features and functionality of the machine 1000, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant. In some embodiments, in addition to or alternatively from a CAN bus, the bus 1002 may include FlexRay, an embedded bus (e.g., SPI, I2C), local interconnect link (LIN), NVIDIA's NVLink, USB (2.0, 3.0, onward), radio frequency (RF), Ethernet (e.g., 10BASE/100BASE, 1000BASE, 10G, etc.), and/or another communication protocol or functionality. Additionally, although a single line is used to represent the bus 1002, this is not intended to be limiting. For example, there may be any number of busses 1002, which may include one or more CAN busses, one or more FlexRay busses, one or more Ethernet busses, and/or one or more other types of busses using a different protocol. In some examples, two or more busses 1002 may be used to perform different functions, and/or may be used for redundancy. For example, a first bus 1002 may be used for collision avoidance functionality and a second bus 1002 may be used for actuation control. In any example, each bus 1002 may communicate with any of the components of the machine 1000, and two or more busses 1002 may communicate with the same components. In some examples, each SoC 1004, each controller 1036, and/or each computer or compute engine within the machine 1000 may have access to the same input data (e.g., inputs from sensors of the machine 1000), and may be connected to a common bus, such as a CAN bus.

The machine 1000 may include components such as a chassis, a vehicle body, wheels (e.g., 2, 4, 6, 8, 18, etc.), tires, axles, batteries, side-view mirrors, and/or other components of a vehicle or machine. The machine 1000 may include a propulsion system 1050, such as an internal combustion engine, hybrid electric power plant, an all-electric engine, a hydrogen-fueled engine, and/or another propulsion system type. The propulsion system 1050 may be connected to a drive train of the machine 1000, which may include a transmission, to enable the propulsion of the machine 1000. The propulsion system 1050 may be controlled in response to receiving signals from the throttle/accelerator 1052.

A steering system 1054, which may include a steering wheel and/or other steering device (e.g., remote steering and/or local steering), may be used to steer the machine 1000 (e.g., along a desired path or route) when the propulsion system 1050 is operating (e.g., when the vehicle is in motion). The steering system 1054 may receive signals from a steering actuator 1056. In some embodiments, a steering wheel or other steering mechanism may not be included, such as for a machine 1000 capable of full automation (e.g., Level 5) functionality.

The brake sensor system 1046 may be used to operate the vehicle brakes in response to receiving signals from the brake actuators 1048 and/or brake sensors.

The machine 1000 may include one or more controller(s) 1036, such as those described herein with respect to FIG. 10A. The controller(s) 1036 may be used for a variety of functions, and may be coupled to any of the various other components and systems of the machine 1000. For example, the controllers 1036 may be used for control of the machine 1000, artificial intelligence executing on the machine 1000, infotainment for the machine 1000, and/or the like. For example, one controller 1036 may be used for some or all of the functionality, or different controllers 1036 may be used for different functionalities—e.g., to ensure availability and a safety separation between various controllers for different tasks. For example, the controller(s) 1036 may use plans computed by the system—e.g., paths or trajectories for vehicles 1000A or AMRs 1000B, or movements, components trajectories, movement locations or displacements, etc. for joints or components (e.g., of manipulators, end effectors, limbs, hands, fingers, legs, feet, etc.), of a humanoid robot 1000C—to control the machine(s) 1000 in the environment. In some instances, the controller(s) 1036 may include a proportional-integral-derivative (PID) controller, a fuzzy logic controller, a neural controller (e.g., a controller embodied as one or more neural networks), a force control controller, a programmable logic controller (PLC), and/or another type of controller. In a humanoid robot 1000C, for example, the controller(s) 1036 may act as the brain, responsible for analyzing sensor data, making decisions, and sending commands to the actuators. The controller(s) 1036 may include a low-level controller that handles basic motor control, ensuring accurate and precise movements of individual joints and actuators. The controller(s) 1036 may include a high-level controller to coordinate multiple actuators and sensors, planning complex motions and adapting to changing environments.

The controller(s) 1036 may include an artificial intelligence controller, in embodiments, that may use AI algorithms (e.g., DNNs, MLMs, etc.) to learn, make decisions, and autonomously perform tasks for the machine 1000. In some embodiments, the controller(s) 1036 may use an open-loop control algorithm that is fixed and does not adjust actions to the environment. In other embodiments, closed-loop control may be used that incorporates feedback mechanisms to monitor the robot's performance and make necessary adjustments. In examples, the controller(s) 1036 may implement reactive control in order to respond directly to sensory inputs, allowing for quick reflexes and real-time changes. Further, deliberative control may be implemented in some examples, using internal models and planning algorithms to generate high-level actions, which may be suited for complex tasks that require reasoning, decision making, and long-term planning.

Controller(s) 1036, which may include one or more systems on chip (SoCs) 1004 (FIGS. 10C and 10D), CPUs, GPU(s), accelerator(s), etc., may provide signals (e.g., representative of commands or messages) to one or more components and/or systems of the machine 1000. Although the controller(s) 1036 is listed separately from the SoC(s) 1004, this is not intended to be limiting, and in some embodiments one or more components of the SoC(s) 1004 may perform the operations of the controller(s) 1036. For example, the controller(s) may send signals to operate the machine brakes via one or more brake actuators 1048, to operate the steering system 1054 via one or more steering actuators 1056, to operate the propulsion system 1050 via one or more throttle/accelerators 1052, etc. The controller(s) 1036 may include one or more onboard (e.g., integrated) computing devices (e.g., supercomputers) that process sensor signals, and output operation commands (e.g., signals representing commands) to enable autonomous or semi-autonomous navigation and movement and/or to assist a human operator using the machine 1000. The controller(s) 1036 may include a first controller 1036 for autonomous control and navigation functions, a second controller 1036 for functional safety functions, a third controller 1036 for artificial intelligence functionality (e.g., computer vision), a fourth controller 1036 for infotainment functionality, a fifth controller 1036 for redundancy in emergency conditions, and/or other controllers. For example, the hardware used for safety monitoring and other safety functions (such as a functional safety island) may be discrete or partitioned (physically or via separation of processing) with respect to hardware used for processing sensor data for perception and making vehicle control decisions. Similarly, hardware (e.g., a controller, an SOC, etc.) for controlling in-vehicle infotainment and/or in-cabin monitoring may be discrete or separate from the hardware used for vehicle perception and control. In some examples, a single controller 1036 may handle two or more of the above functionalities, two or more controllers 1036 may handle a single functionality, and/or any combination thereof.

The controller(s) 1036 may provide the signals for controlling one or more components and/or systems of the machine 1000 in response to sensor data received from one or more sensors (e.g., sensor inputs). The sensor data may be received from, for example and without limitation, global navigation satellite systems (“GNSS”) sensor(s) 1058 (e.g., Global Positioning System sensor(s)), RADAR sensor(s) 1060, ultrasonic sensor(s) 1062, LiDAR sensor(s) 1064, inertial measurement unit (IMU) sensor(s) 1066 (e.g., accelerometer(s), gyroscope(s), magnetic compass(es), magnetometer(s), etc.), microphone(s) 1096, camera(s) 1068 (e.g., stereo camera(s) 1068A, wide-view camera(s) 1068B (e.g., fisheye cameras), infrared camera(s) 1068C, surround camera(s) 1068D (e.g., 360 degree cameras), long-range and/or mid-range camera(s) 1068E, and/or other camera types), speed sensor(s) 1044 (e.g., for measuring the speed of the machine 1000), vibration sensor(s) 1042, steering sensor(s) 1040, brake sensor(s) (e.g., as part of the brake sensor system 1046), actuators, and/or other sensor types.

One or more of the controller(s) 1036 may receive inputs (e.g., represented by input data) from an instrument cluster 1032 of the machine 1000 and provide outputs (e.g., represented by output data, display data, etc.) via a human-machine interface (HMI) display 1034 (e.g., screen, heads-up display, mirror display, facial display, robotic display, etc.), an audible annunciator, a loudspeaker, a speaker, and/or via other components of the machine 1000. The outputs may include information such as machine velocity, speed, time, map data corresponding to a map(s) 1022 of FIG. 10C (e.g., from a navigation map, a Standard Definition (SD) map, a High Definition (“HD”) map, etc.), location data (e.g., the machine's 1000 location, such as on a map 1022), direction, location of other vehicles (e.g., an occupancy map, height map, bird's eye view (BEV) image, grid, etc.), information about objects and status of objects as perceived by the system, system status information, etc. For example, the HMI display(s) 1034 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The machine 1000 may include one or more systems on a chip (SoCs) 1004 (described in more detail in FIG. 10D). The SoC(s) 1004 may include CPU(s) 1006, GPU(s) 1008, processor(s) 1010, cache(s) 1012, accelerator(s) 1014, data store(s) 1016, and/or other components and features. The SoC(s) 1004 may be used to process and provide data for various operations, such as navigation, planning, reasoning, inference, perception, control, and/or actuation operations of the machine 1000 in a variety of platforms and systems. For example, the SoC(s) 1004 may process live perception data (e.g., from camera, LiDAR, RADAR, ultrasonic, etc.) in addition to map data corresponding to one or more maps 1022 (e.g., HD map, SD map, navigational map, occupancy map, etc.) in order to make or aid in performing various operations of the machine 1000. Where a map and/or AI is used, map and/or AI (e.g., model parameter updates, fine-tuning, etc.) refreshes and/or updates via a network interface 1024 from one or more servers (e.g., server(s) 1078 of FIG. 10E)—such as one or more servers of a cloud-based datacenter.

Although an SoC(s) 1004 is illustrated throughout FIGS. 10A-10E, additional or alternative components and/or architectures may be used-such as multi-chip modules (MCMs), application-specific integrated circuits (ASICs), system-in-packages (SiPs), field programmable gate arrays (FPGAs), heterogeneous integration (HI), single-board computers (SBCs)—without departing from the scope of the present disclosure. For example, depending on the type of machine 1000, use of the machine 1000, model of the machine 1000, and required capabilities of the machine 1000, one or more SoCs 1004 and/or alternative architectures and/or components may be used to satisfy the particular implementation.

The machine 1000 may include a CPU(s) 1018 (e.g., discrete CPU(s), or dCPU(s)), that may be coupled to the SoC(s) 1004 via a high-speed interconnect (e.g., PCIe). The CPU(s) 1018 may include an X86 processor, for example. The CPU(s) 1018 may be used to perform any of a variety of functions, including arbitrating potentially inconsistent results between ADAS sensors and the SoC(s) 1004, and/or monitoring the status and health of the controller(s) 1036 and/or infotainment SoC 1030, for example.

The machine 1000 may include a GPU(s) 1020 (e.g., discrete GPU(s), or dGPU(s)), that may be coupled to the SoC(s) 1004 via a high-speed interconnect (e.g., NVIDIA's NVLink). The GPU(s) 1020 may provide additional artificial intelligence functionality, such as by executing redundant and/or different neural networks, and may be used to train and/or update neural networks based on input (e.g., sensor data) from sensors of the machine 1000.

The machine 1000 may further include the network interface 1024 which may include one or more wireless antennas 1026 and/or modems (e.g., one or more wireless antennas for different communication protocols, such as a cellular antenna, a Bluetooth antenna, etc.). The network interface 1024 may be used to enable wireless connectivity over the Internet with the cloud (e.g., with the server(s) 1078 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the machine 1000 information about vehicles in proximity to the machine 1000 (e.g., vehicles in front of, on the side of, and/or behind the machine 1000). This functionality may be part of a cooperative adaptive cruise control functionality of the machine 1000.

The network interface 1024 may include a SoC that provides modulation and demodulation functionality and enables the controller(s) 1036 to communicate over wireless networks. The network interface 1024 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. For example, the network interface 1024 may be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA2000”), fifth generation of mobile communications technology (5G), sixth generation of mobile communications technology (6G), and/or other cellular and/or wireless communication standards. The wireless antenna(s) 1026 may also enable communication between objects in the environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc.

The machine 1000 may further include data store(s) 1028 which may include off-chip (e.g., off the SoC(s) 1004) storage. The data store(s) 1028 may include one or more storage elements including RAM, SRAM, DRAM, VRAM, Flash, hard disks, and/or other components and/or devices that may store at least one bit of data.

The machine 1000 may further include GNSS sensor(s) 1058. The GNSS sensor(s) 1058 (e.g., GPS, assisted GPS sensors, differential GPS (DGPS) sensors, etc.), to assist in mapping, perception, occupancy grid generation, and/or path planning functions. Any number of GNSS sensor(s) 1058 may be used, including, for example and without limitation, a GPS using a USB connector with an Ethernet to Serial (RS-232) bridge.

The machine 1000 may further include IMU sensor(s) 1066. The IMU sensor(s) 1066 may be located at a center of the rear axle of the machine 1000, in some examples. The IMU sensor(s) 1066 may include, for example and without limitation, an accelerometer(s), a magnetometer(s), a gyroscope(s), a magnetic compass(es), and/or other sensor types. In some examples, such as in six-axis applications, the IMU sensor(s) 1066 may include accelerometers and gyroscopes, while in nine-axis applications, the IMU sensor(s) 1066 may include accelerometers, gyroscopes, and magnetometers.

In some embodiments, the IMU sensor(s) 1066 may be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 1066 may enable the machine 1000 to estimate heading without requiring input from a magnetic sensor by directly observing and correlating the changes in velocity from GPS to the IMU sensor(s) 1066. In some examples, the IMU sensor(s) 1066 and the GNSS sensor(s) 1058 may be combined in a single integrated unit.

The vehicle may include one or more microphone 1096 placed in and/or around the machine 1000. The microphone(s) 1096 may be used for emergency vehicle detection and identification, among other things.

The machine 1000 may further include vibration sensor(s) 1042. The vibration sensor(s) 1042 may measure vibrations of components of the machine, such as the arms or legs of a humanoid robot 1000C, or the axle(s) of a vehicle 1000A or AMR 1000B. For example, changes in vibrations may indicate a change in road, walking, or traversable surfaces. In another example, when two or more vibration sensors 1042 are used, the differences between the vibrations may be used to determine friction or slippage of the surface (e.g., when the difference in vibration is between a power-driven axle and a freely rotating axle).

The machine 1000 may include an ADAS system 1038-such as when the machine 1000 is a vehicle 1000A. The ADAS system 1038 may include a dedicated SoC(s), in some examples. The ADAS system 1038 may include autonomous/adaptive/automatic cruise control (ACC), cooperative adaptive cruise control (CACC), forward crash or collision warning (FCW), automatic emergency braking (AEB), lane departure warning (LDW), lane keep assist (LKA), blind spot warning (BSW), blind spot monitoring (BSM), rear cross-traffic warning (RCTW), pedestrian detection, driver monitoring, collision warning systems (CWS), traffic sign recognition, speed limit detection, automatic parking, lane centering (LC), high beam safety system, and/or other features and functionality.

The machine 1000 may further include the infotainment SoC 1030 (e.g., an in-vehicle infotainment system (IVI)). Although illustrated and described as a SoC, the infotainment system may not be an SoC, and may include one or more discrete components, such as multi-chip modules (MCMs), application-specific integrated circuits (ASICs), system-in-packages (SiPs), heterogeneous integration (HI), single-board computers (SBCs), etc. The infotainment SoC 1030 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., wireless, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the machine 1000. For example, the infotainment SoC 1030 may radios, disk players, navigation systems, video players, USB and Bluetooth connectivity, carputers, in-car entertainment, Wi-Fi, steering wheel audio controls, hands free voice control, a heads-up display (HUD), an HMI display 1034, a telematics device, a control panel (e.g., for controlling and/or interacting with various components, features, and/or systems), and/or other components. The infotainment SoC 1030 may further be used to provide information (e.g., visual and/or audible) to a user(s) of the vehicle, such as information from the ADAS system 1038, autonomous driving information such as planned vehicle maneuvers, trajectories, surrounding environment information (e.g., intersection information, vehicle information, road information, etc.), and/or other information.

The infotainment SoC 1030 may include GPU functionality. The infotainment SoC 1030 may communicate over the bus 1002 (e.g., CAN bus, Ethernet, etc.) with other devices, systems, and/or components of the machine 1000. In some examples, the infotainment SoC 1030 may be coupled to a supervisory MCU such that the GPU of the infotainment system may perform some self-driving functions in the event that the primary controller(s) 1036 (e.g., the primary and/or backup computers of the machine 1000) fail. In such an example, the infotainment SoC 1030 may put the machine 1000 into a chauffeur to safe stop mode, as described herein.

In some embodiments, the infotainment system may provide a digital or virtual assistant, that may be voice only, or may have a visual component (e.g., in the form of a digital human or digital avatar). The assistant may provide basic functions, like texting, adjusting vehicle settings, music or video control, navigation features, etc., and/or may provide more advanced features such as those supported by one or more language models—such as large language models (LLMs), vision language models (VLMs), multi-modal language models (MMLMs), etc. For example, the driver and/or occupants may be able to interact with the assistant similar to how a user may interact with a language model, such as to ask general questions, specific questions, to request restaurant, gas station, and/or other recommendations and/or locations, to learn about the vehicle functionality or troubleshooting (e.g., to ask tire pressure information, oil change information, battery exchange information, etc.). As such, the machine 1000—whether a vehicle 1000A, AMR 1000B, humanoid robot 1000C, and/or other type of machine—may include a locally stored language model(s) and/or communicate to a remotely hosted language model (e.g., via one or more APIs) to provide more detailed and in-depth communication features to the users of the machine(s) 1000.

In some examples, an infotainment SoC 1030, the SoC(s) 1004, and/or another SoC or computing/processing system may perform in-cabin driver and/or occupant monitoring. For example, the computing system may perform facial recognition and vehicle owner identification may use data from camera and/or other sensors to identify the presence of an authorized driver and/or owner of the machine 1000. The always on sensor processing engine may be used to unlock the vehicle when the owner approaches the driver door and turn on the lights, and, in security mode, to disable the vehicle when the owner leaves the vehicle. In this way, the SoC(s) 1004 provide for security against theft and/or carjacking.

In some embodiments, an in-cabin monitoring camera sensor may be monitored using one or more neural networks running on another or dedicated SoC-such as an in-vehicle infotainment or in-vehicle monitoring SoC, configured to identify in cabin events and respond accordingly. An in-cabin system may perform lip reading to activate cellular service and place a phone call, dictate emails, change the vehicle's destination, activate or change the vehicle's infotainment system and settings, or provide voice-activated web surfing. The in-cabin system may further include one or more in-cabin AI agents or assistants, which may use one or more APIs or plug-ins to interact with one or more LLMs, VLMs, MMLMs, etc. in the cloud. For example, the in-cabin AI agents or assistants may provide directions, vehicle or machine feedback information, answer general questions, handle music/video and/or other requests, activate windows, doors, and/or other vehicle components, etc. As such, one or more dedicated SoCs and/or sets of processors may be used to perform the in-cabin infotainment and/or in-cabin monitoring (e.g., as an occupant monitoring system (OMS)) for the machine 1000.

The machine 1000 may further include an instrument cluster 1032 (e.g., a digital dash, an electronic instrument cluster, a digital instrument panel, etc.). The instrument cluster 1032 may include a controller and/or supercomputer (e.g., a discrete controller or supercomputer). The instrument cluster 1032 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 1030 and the instrument cluster 1032. In other words, the instrument cluster 1032 may be included as part of the infotainment SoC 1030, or vice versa.

FIG. 10D is a block diagram of an example architecture of a computing system (a subset of the system described with respect to FIG. 10C), in accordance with at least some embodiments of the present disclosure. Although illustrated as an SoC(s) 1004, this is not intended to be limiting, and the computing system may additionally or instead include multi-chip modules (MCMs), application-specific integrated circuits (ASICs), system-in-packages (SiPs), heterogeneous integration (HI), single-board computers (SBCs), and/or other components and/or architectures, without departing from the scope of the present disclosure.

The SoC(s) 1004 may be an end-to-end platform with a flexible architecture that spans automation levels 2-5, or the SoC(s) 1004 may be specifically designed for a specific automation level (e.g., a first SoC 1004 for level 2 to level 2++, a second SoC 1004 for level 3, a third SoC 1004 for level 4, etc.), thereby providing a comprehensive functional safety architecture that leverages and makes efficient use of computer vision, neural network inferencing, robotic planning, control, and navigation, ADAS techniques, and the like, with diversity and redundancy, to provide a platform for a flexible, reliable driving or robotic control software stack, along with deep learning tools. The SoC(s) 1004 may be faster, more reliable, and even more energy-efficient and space-efficient than conventional systems. For example, the accelerator(s) 1014, when combined with the CPU(s) 1006, the GPU(s) 1008, and the data store(s) 1016, may provide for a fast, efficient platform for level 2-5 autonomous vehicles as well as for safe planning, navigation, and control of AMRs 1000B, humanoid robots 1000C, and/or other robot or machine types.

In some embodiments, such as where the SoC(s) 1004 include a GPU 1008 with 2000 or more cores (e.g., 2048 cores), 60 or more tensor cores (e.g., 64 tensor cores), and a GPU max frequency of over 1 GHz (e.g., 1.3 GHZ), a CPU 1006 including 10 or more cores (e.g., 12 cores), with 64 bits, 3 MB L2 and 6 MB L3 cache memory, and a max frequency of 2 or more GHz (e.g., 2.2 GHz), one or more deep learning accelerators (DLAs), deep learning accelerator clusters (XNNs), neural network accelerators (NNAs), or neural processing units (NPUs) 1009 (e.g., 2 DLAs/XNNs/NNAs/NPUs 1009), and a vision accelerator-such as a programmable vision accelerator (PVA) 1007, a single SoC 1004) may be capable of 275 tera operations per second (TOPS) of AI performance. For example, NVIDIA's Jetson AGX Orin 64 GB SoC satisfies these criteria, and achieves this performance.

Similarly, in embodiments where the SoC(s) 1004 include a GPU 1008 with 1700 or more cores (e.g., 1792 cores), 50 or more tensor cores (e.g., 56 tensor cores), and a GPU max frequency of over 900 MHZ (e.g., 930 MHz), a CPU 1006 including 8 or more cores (e.g., 8 cores), with 64 bits, 2 MB L2 and 4 MB L3 cache memory, and a max frequency of 2 or more GHz (e.g., 2.2 GHz), one or more deep learning accelerators (DLAs), deep learning accelerator clusters (XNNs), neural network accelerators (NNAs), or neural processing units (NPUs) 1009 (e.g., 2 DLAs/XNNs/NNAs/NPUs 1009), and a vision accelerator-such as a programmable vision accelerator (PVA) 1007, a single SoC 1004) may be capable of 200 tera operations per second (TOPS) of AI performance. For example, NVIDIA's Jetson AGX Orin 32 GB SoC satisfies these criteria, and achieves this performance.

In some embodiments, such as where the SoC(s) 1004 include a GPU 1008 with 1000 or more cores (e.g., 1024 cores), 28 or more tensor cores (e.g., 32 tensor cores), and a GPU max frequency of over 900 MHz (e.g., 1173 MHZ), a CPU 1006 including 8 or more cores (e.g., 8 cores), with 64 bits, 2 MB L2 and 4 MB L3 cache memory, and a max frequency of 2 or more GHz (e.g., 2 GHz), one or more deep learning accelerators (DLAs), deep learning accelerator clusters (XNNs), neural network accelerators (NNAs), or neural processing units (NPUs) 1009 (e.g., 1 DLA/XNN/NNA/NPU 1009), and a vision accelerator-such as a programmable vision accelerator (PVA) 1007, a single SoC 1004) may be capable of 157 tera operations per second (TOPS) of AI performance. For example, NVIDIA's Jetson AGX Orin NX 16 GB SoC satisfies these criteria, and achieves this performance.

In various embodiments, such as where the SoC(s) 1004 include a GPU 1008 with 1000 or more cores (e.g., 1024 cores), 28 or more tensor cores (e.g., 32 tensor cores), and a GPU max frequency of over 900 MHz (e.g., 1020 MHz), a CPU 1006 including 6 or more cores (e.g., 6 cores), with 64 bits, 1.5 MB L2 and 4 MB L3 cache memory, and a max frequency of 1.5 or more GHz (e.g., 1.7 GHZ), a single SoC 1004) may be capable of 67 tera operations per second (TOPS) of AI performance. For example, NVIDIA's Jetson Orin Nano 8 GB SoC satisfies these criteria, and achieves this performance.

The SoC(s) 1004 may include one or more CPUs 1006. The CPU(s) 1006 may include a CPU cluster or CPU complex (alternatively referred to herein as a “CCPLEX”), in embodiments. The CPU(s) 1006 may include multiple cores and/or (e.g., L2, L3) caches. For example, in some embodiments, the CPU(s) 1006 may include twelve cores in a coherent multi-processor configuration. In some embodiments, the CPU(s) 1006 may include four dual-core clusters where each cluster has a dedicated L2 cache (e.g., a 3 MB L2 cache). The CPU(s) 1006 (e.g., the CCPLEX) may be configured to support simultaneous cluster operation enabling any combination of the clusters of the CPU(s) 1006 to be active at any given time.

The SoC(s) 1004 may include any type and number of GPUs 1008. For example, an integrated GPU(s) (alternatively referred to herein as an “iGPU(s)”) may be used in some embodiments. The GPU(s) 1008 may be programmable and may be efficient for parallel workloads. The GPU(s) 1008, in some examples, may use an enhanced tensor instruction set. The GPU(s) 1008 may include one or more streaming microprocessors, where each streaming microprocessor may include a cache (e.g., an L1 cache with at least 96 KB storage capacity), and two or more of the streaming microprocessors may share an L2 cache (e.g., an L2 cache with a 512 KB storage capacity). In some embodiments, the GPU(s) 1008 may include at least eight streaming microprocessors. The GPU(s) 1008 may use compute application programming interface(s) (API(s)). In addition, the GPU(s) 1008 may use one or more parallel computing platforms and/or programming models (e.g., NVIDIA's CUDA).

The GPU(s) 1008 may be power-optimized for best performance in automotive, robotics, and/or other embedded use cases. For example, the GPU(s) 1008 may be fabricated on a Fin field-effect transistor (FinFET). However, this is not intended to be limiting and the GPU(s) 1008 may be fabricated using other semiconductor manufacturing or fabrication processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an (e.g., L0) instruction cache, a warp scheduler, a dispatch unit, and/or a (e.g., 64 KB) register file. In addition, the streaming microprocessors may include independent parallel integer and floating-point data paths to provide for efficient execution of workloads with a mix of computation and addressing calculations. The streaming microprocessors may include independent thread scheduling capability to enable finer-grain synchronization and cooperation between parallel threads. The streaming microprocessors may include a combined L1 data cache and shared memory unit in order to improve performance while simplifying programming.

The GPU(s) 1008 may include a high bandwidth memory (HBM) and/or a (e.g., 16 GB) HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 1008 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 1008 to access the CPU(s) 1006 page tables directly. In such examples, when the GPU(s) 1008 memory management unit (MMU) experiences a miss, an address translation request may be transmitted to the CPU(s) 1006. In response, the CPU(s) 1006 may look in its page tables for the virtual-to-physical mapping for the address and transmits the translation back to the GPU(s) 1008. As such, unified memory technology may allow a single unified virtual address space for memory of both the CPU(s) 1006 and the GPU(s) 1008, thereby simplifying the GPU(s) 1008 programming and porting of applications to the GPU(s) 1008.

The SoC(s) 1004 may include any number of cache(s) 1012, including those described herein. For example, the cache(s) 1012 may include L0 caches, L1 caches, L2 caches, L3 caches (e.g., that are available to both the CPU(s) 1006 and the GPU(s) 1008 (e.g., that is connected both the CPU(s) 1006 and the GPU(s) 1008)), etc. The cache(s) 1012 may include a write-back cache that may keep track of states of lines, such as by using one or more cache coherence protocol (e.g., MEI, MESI, MSI, etc.). The (e.g., L3) cache may include 4 MB or more, depending on the embodiment, although smaller or larger cache sizes may be used.

The SoC(s) 1004 may include one or more arithmetic logic units (ALUs) 1065 which may be leveraged in performing processing with respect to any of the variety of tasks or operations of the machine 1000—such as computer vision, machine learning or deep learning processing, world model management, etc. In addition, the SoC(s) 1004 may include a floating point unit(s) (FPU(s)) 1067—or other math coprocessor or numeric coprocessor types—for performing mathematical operations within the system. For example, the SoC(s) 1004 may include one or more FPUs 1067 integrated as execution units within a CPU(s) 1006 and/or GPU(s) 1008.

The SoC(s) 1004 may include one or more accelerators 1014 (e.g., hardware accelerators, software accelerators, or a combination thereof). For example, the SoC(s) 1004 may include a hardware acceleration cluster that may include optimized hardware accelerators and/or large on-chip memory. The large on-chip memory 1015 (e.g., 4 MB of SRAM, 32 GB and/or 64 GB 256-bit LPDDR5 at 204.8 GB/s, 8 GB and/or 16 GB 128-bit LPDDR5 at 102.4 GB/s, and/or other memory types and sizes), may enable the hardware acceleration cluster to accelerate neural network processing, transformer processing, optical flow processing, vision processing, and/or other calculations or processing. The hardware acceleration cluster may be used to complement the GPU(s) 1008 and to off-load some of the tasks of the GPU(s) 1008 (e.g., to free up more cycles of the GPU(s) 1008 for performing other tasks). As an example, the accelerator(s) 1014 may be used for targeted workloads (e.g., perception, convolutional neural networks (CNNs), deep neural networks (DNNs), language models (LLMs, VLMs, MMLMs, VLAs, etc.), transformer models, diffusion models, encoder-only models, encoder-decoder models, etc. that are stable enough to be amenable to acceleration.

The accelerator(s) 1014 (e.g., the hardware acceleration cluster) may include a deep learning accelerator(s) (DLA) 1009 (alternatively referred to herein as “a deep learning accelerator cluster (XNN) 1009,” “neural network accelerator (NNA) 1009,” or “neural processing unit (NPU) 1009”). The DLA(s) 1009 may include one or more Tensor processing units (TPUs) 1041 that may be configured to provide an additional, e.g., ten trillion operations per second for deep learning applications and inferencing. The TPUs 1041 may be accelerators configured to, and optimized for, performing image processing functions (e.g., for CNNs, RCNNs, DNNs, etc.). The DLA(s) 1009 may further be optimized for a specific set of neural network types and floating point operations, as well as inferencing. The design of the DLA(s) may provide more performance per millimeter than a general-purpose GPU, and vastly exceeds the performance of a CPU. The TPU(s) 1041 may perform several functions, including a single-instance convolution function, supporting, for example, INT8, INT16, and FP16 data types for both features and weights, as well as post-processor functions. Although the TPU(s) 1041 are described as being included as part of the DLA(s) 1009, this is not intended to be limiting, and the TPU(s) 1041 may be included in additional or alternative accelerator(s) 1014 and/or other components, and/or may be included as a discrete processing component(s).

The DLA(s) 1009 may quickly and efficiently execute neural networks on processed or unprocessed data for any of a variety of functions, including, for example and without limitation: for object and feature identification and detection (e.g., vehicles, pedestrians, other robots, lane lines, road boundary lines, debris, potholes, boxes, warehouse items, etc.) using data from one or more sensor modalities; for distance estimation using data from one or more sensor modalities; for emergency vehicle detection and identification and detection using data from microphones and/or vision-based sensors; for facial recognition; for pick and place operations; for manipulation operations; for occupant monitoring; for vehicle owner identification; and/or other in-cabin operations using data from in-cabin cameras and/or other sensor types; and/or a for security and/or safety related events, to name a few.

The DLA(s) 1009 may perform any function of the GPU(s) 1008, and by using an inference accelerator, for example, a designer may target either the DLA(s) 1009 or the GPU(s) 1008 for any function. For example, the designer may focus processing of DNNs and floating point operations on the DLA(s) 1009 and leave other functions to the GPU(s) 1008 and/or other accelerator(s) 1014. The DLA(s) 1009 may be used to run any type of network to enhance control and safety, including for example, a neural network that outputs a measure of confidence for each object detection.

The accelerator(s) 1014 (e.g., the hardware acceleration cluster) may include a programmable vision accelerator(s) (PVA) 1007, which may alternatively be referred to herein as a computer vision accelerator or generally a vision accelerator. The PVA(s) 1007 may be designed and configured to accelerate computer vision algorithms for the advanced driver assistance systems (ADAS), semi-autonomous driving, autonomous driving, robotics applications, security and surveillance applications, augmented reality (AR), virtual reality (VR), and/or mixed reality (MR) applications, etc. The PVA(s) 1007 may provide a balance between performance and flexibility. For example, each PVA(s) 1007 may include, for example and without limitation, any number of reduced instruction set computer (RISC) cores, direct memory access (DMA) systems, pixel processing engines (PPEs), vector processors or vector processing units (VPUs), and/or other components. The PVA engine may include an advanced very long instruction word (VLIW), single instruction multiple data (SIMD) digital signal processor. The PVA(s) 1007 may be optimized for the tasks of image processing and computer vision algorithm acceleration. For example, the PVA(s) 1007 provides excellent performance with extremely low power consumption, and can be used asynchronously and concurrently with the CPU(s) 1006, GPU(s) 1008, and/or other accelerators in the system (e.g., vehicle, robot, etc.) as part of a heterogeneous compute pipeline.

The PVA(s) 1007 may include one or more (e.g., two) vector processing subsystems (VPS), where each VPS may include one or more vector processing unit (VPU) cores, one or more decoupled look-up units (DLUTs), one or more shared or vector memories (VMEMs), and one or more instruction caches (I-caches). The VPU core(s) may be the main processing unit, and may include a vector SIMD VLIW DSP 1043 optimized for computer vision. The VPU core(s) may fetch instructions through the I-cache(s), and may access data through the VMEM(s). The DLUT(s) may include a specialized hardware component that enhances the efficiency of parallel lookup operations. For example, the DLUT(s) allow parallel lookups using a single copy of the lookup table by executing these lookups in a decoupled pipeline, independent of the primary processor pipeline. By doing so, the DLUT(s) minimize or reduce memory usage and enhance throughput while avoiding data-dependent memory bank conflicts—ultimately leading to improved overall system performance. The VPU VMEM(s) may provide local data storage for the VPU, allowing efficient implementation of various image processing and computer vision algorithms. The VPU VMEM(s) may support access from outside-VPS hosts such as direct memory access (DMA) and the CPU(s) 1006 (e.g., ARM Cortex-R5 processor), facilitating data exchange with the CPU(s) 1006 and other system-level components. The VPU I-cache may supply instruction data to the VPU(s) when requested, may request missing instruction data from system memory, and/or may maintain temporary instruction storage for the VPU. For each VPU task, the CPU(s) 1006 may configures the DMA system, optionally prefetch the VPU program into VPU I-cache, and/or kick off each VPU-DMA pair to process a task. The PVA(s) 1007 may also include an L2 SRAM memory to be shared between the one or more (e.g., two) sets of VPS and DMA. In some embodiments, one or more (e.g., two) DMA devices are used to move data among external memory, PVA L2 memory, the VMEMs (e.g., one in each VPS), CPU(s) tightly coupled memory (TCM), DMA descriptor memory, and/or PVA-level config registers. In a lightly loaded system, two parallel DMA accesses to DRAM can achieve a read/write bandwidth of up to 15 GB/s each and, in a heavily loaded system, this bandwidth can reach up to 10 GB/s each. With respect to compute compacity, the INT8 Giga Multiply-Accumulate Operations per Second (GMACs) may be 2048 or greater, excluding the DLUT. The FP32 GMACs may include 32 per PVA instance.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA system may enable components of the PVA(s) 1007 to access the system memory independently of the CPU(s) 1006. The DMA may support any number of features used to provide optimization to the PVA(s) 1007 including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors or VPUs may be programmable processors that may be designed to efficiently and flexibly execute programming for computer vision algorithms and provide signal processing capabilities. In some examples, the PVA(s) 1007 may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA(s) 1007, and may include one or more vector processing units (VPUs), one or more pixel processing engines (PPEs)—which may include a 2D layout of interconnected (e.g., for north, south, east, west intercommunication) processing elements, one or more instruction caches, and/or one or more shared or vector memories (e.g., VMEMs). A VPU core may include a digital signal processor such as, for example, a single instruction, multiple data (SIMD), very long instruction word (VLIW) digital signal processor. The combination of the SIMD and VLIW may enhance throughput and speed.

In some embodiments, each of the vector processors may include an instruction cache and may be coupled to dedicated memory. As a result, in some examples, each of the vector processors may be configured to execute independently of the other vector processors. In other examples, the vector processors that are included in a particular PVA(s) 1007 may be configured to employ data parallelism. For example, in some embodiments, the plurality of vector processors included in a single PVA(s) 1007 may execute the same computer vision algorithm, but on different regions of an image. In other examples, the vector processors included in a particular PVA(s) 1007 may simultaneously execute different computer vision algorithms, on the same image, or even execute different algorithms on sequential images or portions of an image. Among other things, any number of PVAs 1007 may be included in the hardware acceleration cluster and any number of vector processors may be included in each of the PVAs. In addition, the PVA(s) 1007 may include additional error correcting code (ECC) memory, to enhance overall system safety.

The accelerator(s) 1014 (e.g., the hardware accelerator cluster) have a wide array of uses for autonomous and semi-autonomous machine control. The PVA(s) 1007 may be a programmable vision accelerator that may be used for key processing stages in perception, robotics understanding and reasoning, ADAS, semi-autonomous, and autonomous vehicles, etc. The PVA's 1007 capabilities are a good match for algorithmic domains needing predictable processing, at low power and low latency. In other words, the PVA(s) 1007 performs well on semi-dense or dense regular computation, even on small data sets, which need predictable run-times with low latency and low power. Thus, in the context of platforms for autonomous vehicles and robotics, the PVAs 1007 are designed to run classic computer vision algorithms, as they are efficient at object detection and operating on integer math.

For example, according to one embodiment of the technology, the PVA 1007 is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA(s) 1007 may perform computer stereo vision function on inputs from two monocular cameras.

In some examples, the PVA(s) 1007 may be used to perform dense optical flow. According to process raw RADAR data (e.g., using a 4D Fast Fourier Transform) to provide Processed RADAR. In other examples, the PVA(s) 1007 is used for time-of-flight depth processing, by processing raw time of flight data to provide processed time of flight data, for example.

Although the VPU(s), DMA(s), RISC Core(s), VMEM(s), and decoupled co-processors (e.g., the DLUT(s)) are described as being included within the PVA(s) 1007, this is not intended to be limiting. In some embodiments, these components may be included in alternative or additional processing components and/or accelerator(s) 1014, and/or may be included as discrete components of the SoC(s) 1004 and/or other computing system architecture(s).

In some examples, the SoC(s) 1004 may include a real-time ray-tracing hardware accelerator (RTA) 1051 that may be used to quickly and efficiently determine the positions and extents of objects (e.g., within a world model), to generate real-time or near-real time visualization simulations, for RADAR signal interpretation, for sound propagation synthesis and/or analysis, for simulation of SONAR, RADAR, LiDAR, camera, and/or other sensor modalities within a simulation, for general wave propagation simulation, for comparison to LiDAR data for purposes of localization, to generate realistic training data for training neural networks, and/or other functions and uses. In some embodiments, one or more tree traversal units (TTUs) may be used for executing one or more ray-tracing related operations. For example, the machine 1000 (or another machine or device) may be simulated within a simulation environment, and the simulation environment may be generated using one or more light transport simulation algorithms (e.g., ray-tracing, path-tracing, etc.). These ray-tracing algorithms may thus be accelerated using a ray-tracing accelerator 1051 and/or a ray-tracing optimized GPU 1008—such as NVIDIA's RTX GPU.

The accelerator(s) 1014 (e.g., in the hardware acceleration cluster) may include one or more optical flow accelerators (OFAs) 1011. For example, the OFA(s) 1011 may be used for computing optical flow and stereo disparity between frames of sensor data (e.g., images). Optical flow may be accelerated on the OFA(s) 1011 for uses such as object detection and tracking, and/or for stereo depth estimation where used for computing stereo disparity between stereo image frames (e.g., two or more frames captured using two or more image sensors with at least partially overlapping fields of view).

The SoC(s) 1004 may include one or more camera serial interfaces (CSIs) 1023. For example, the CSI(s) 1023 may include a mobile industry processor interface (MIPI) camera serial interface (CSI) for receiving video and input from cameras, a high-speed interface, and/or a video input block that may be used for camera and related pixel input functions. The SoC(s) 1004 may further include an input/output controller(s) that may be controlled by software and may be used for receiving I/O signals that are uncommitted to a specific role. For example, the CSI 1023 may include a MIPI CSI-2 connector—e.g., a 16 lane MIPI CSI-2 connector, D-PHY 2.1 (up to 40 Gbps), and C-PHY 2.0 (up to 164 Gbps) for supporting 16 virtual channels and six or more cameras, an 8 lane MIPI CSI-2 connector, D-PHY 2.1 (up to 20 Gbps for supporting 8 virtual channels and 4 or more cameras, and/or a 2x MIPI CSI-2, 22 pin camera connector, depending on the embodiment and implementation.

The accelerator(s) 1014 (e.g., the hardware acceleration cluster) may include a computer vision network on-chip (CVNOC) 1063 and SRAM, for providing a high-bandwidth, low latency SRAM for the accelerator(s) 1014. In some examples, the on-chip memory may include at least 4 MB SRAM, consisting of, for example and without limitation, eight field-configurable memory blocks, that may be accessible by the PVA 1007, OFA 1011, DLA 1009, and/or other accelerator(s) 1014. Each pair of memory blocks may include an advanced peripheral bus (APB) interface, configuration circuitry, a controller, and a multiplexer. Any type of memory 1015 may be used. The PVA 1007, OFA 1011, DLA 1009, and/or other accelerator(s) 1014 may access the memory via a backbone that provides the accelerator(s) 1014 with high-speed access to memory. The backbone may include a computer vision network on-chip that interconnects the accelerator(s) 1014 to the memory (e.g., using the APB).

The CVNOC 1063 may include an interface that determines, before transmission of any control signal/address/data, that the accelerator(s) 1014 provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

The SoC(s) 1004 may include data store(s) 1016 and/or memory 1015. The data store(s) 1016 may be on-chip memory 1015 of the SoC(s) 1004, which may store neural networks and/or other algorithms to be executed on the CPU(s) 1006, the GPU(s) 1008, and/or one or more of the accelerator(s) 1014. In some examples, the data store(s) 1016 may be large enough in capacity to store multiple instances of neural networks for redundancy and safety. The data store(s) 1012 may comprise L2 and/or L3 cache(s) 1012, for example. The memory (ies) 1015 may include SRAM, LPDDR5, and/or other memory types. For example, the memory (ies) 1015 may include 4 MB of SRAM, 32 GB and/or 64 GB 256-bit LPDDR5 at 204.8 GB/s, 8 GB and/or 16 GB 128-bit LPDDR5 at 102.4 GB/s, and/or other memory types and sizes. Reference to the data store(s) 1016 may include reference to the memory associated with the PVA 1007, OFA 1011, DLA 1009, and/or other accelerator(s) 1014, as described herein.

The data store(s) 1016 may include various storage types, such as eMMC, NVMe, etc. For example, the SoC(s) 1004 may include storage in the form of an embedded multimedia card (eMMC) (e.g., 64 GB eMMC 5.1) and/or an SD card slot, with external NVM express (NVMe) capability, e.g., via M.2 Key M. For example, the data store(s) 1016 and/or other storage may be accessed via, e.g., NVMe, using PCI Express (PCIe), RDMA, TCP, and/or other protocols.

The SoC(s) 1004 may include one or more processor(s) 1010 (e.g., embedded processors). The processor(s) 1010 may include a boot and power management processor (BPMP) 1053, that may be a dedicated processor and subsystem to handle boot power and management functions and related security enforcement. The BPMP 1053 may be a part of the SoC(s) 1004 boot sequence and may provide runtime power management services. The BPMP 1053 may provide clock and voltage programming, assistance in system low power state transitions, management of SoC(s) 1004 thermals and temperature sensors, and/or management of the SoC(s) 1004 power states. Each temperature sensor may be implemented as a ring-oscillator whose output frequency is proportional to temperature, and the SoC(s) 1004 may use the ring-oscillators to detect temperatures of the CPU(s) 1006, GPU(s) 1008, accelerator(s) 1014, and/or other components. If temperatures are determined to exceed a threshold, BPMP 1053 may enter a temperature fault routine and put the SoC(s) 1004 into a lower power state and/or put the machine 1000 into a chauffeur to safe stop mode (e.g., bring the machine 1000 to a safe stop).

The processor(s) 1010 may further include a set of embedded processors that may serve as an audio processing engine (APE) 1055. The APE 1055 may be an audio subsystem that enables full hardware support for multi-channel audio over multiple interfaces, and a broad and flexible range of audio I/O interfaces. In some examples, the APE 1055 is a dedicated processor core with a digital signal processor with dedicated RAM.

The processor(s) 1010 may further include an always on processor engine (AOPE) 1057 that may provide necessary hardware features to support low power sensor management and wake use cases. The AOPE 1057 may include a processor core, a tightly coupled RAM, supporting peripherals (e.g., timers and interrupt controllers), various I/O controller peripherals, and routing logic.

The processor(s) 1010 may further include a safety processor(s) 1013 (alternatively referred to as “safety island 1013”), which may include a safety cluster engine that includes a dedicated processor or processor subsystem to handle safety management for automotive, robotics, and/or other applications. The safety processor(s) 1013—and/or safety cluster engine—may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations. In some embodiments, the safety processor(s) 1013 may include a discrete processor(s), such that fault of other system components may not impact the performance and availability of the safety processor 1013.

The processor(s) 1010 may further include a real-time or near real-time sensor engine (SE) 1059 that may include a dedicated processor subsystem for handling real-time or near real-time camera, LiDAR, RADAR, and/or other sensor modality management.

The processor(s) 1010 may further include one or more image signal processors (ISPs) 1027, which may include a high-dynamic range signal processor and/or a hardware engine that is part of one or more sensor processing pipelines.

The processor(s) 1010 may include a video image compositor (VIC) 1061 that may be a processing block (e.g., implemented on a microprocessor) that implements video post-processing functions needed by a video playback application to produce the final image for the player window. The VIC 1061 may perform lens distortion correction on wide-view camera(s) 1068B, surround camera(s) 1068D, in-cabin monitoring camera sensors, and/or other camera sensors with distorted fields of view.

A VIC 1061 may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

A VIC 1061 may also be configured to perform stereo rectification on input stereo lens frames. The video image compositor may further be used for user interface composition when the operating system desktop is in use, and the GPU(s) 1008 is not required to continuously render new surfaces. Even when the GPU(s) 1008 is powered on and active doing 3D rendering, the video image compositor may be used to offload the GPU(s) 1008 to improve performance and responsiveness.

The SoC(s) 1004 may further include a broad range of peripheral interfaces for input/output (I/O) 1025, such as to enable communication with peripherals, audio codecs, power management, and/or other devices. The SoC(s) 1004 may be used to process data from cameras (e.g., connected over Gigabit Multimedia Serial Link and/or Ethernet), sensors (e.g., LiDAR sensor(s) 1064, RADAR sensor(s) 1060, etc. that may be connected over Ethernet), data from bus 1002 (e.g., speed of machine 1000, steering wheel position, etc.), data from GNSS sensor(s) 1058 (e.g., connected over Ethernet or CAN bus). The SoC(s) 1004 may further include dedicated high-performance mass storage controllers that may include their own DMA engines, and that may be used to free the CPU(s) 1006 from routine data management tasks. In some embodiments, the SoC(s) 1004 I/O 1025 may include a header (e.g., a 40 pin header, or 40 pin expansion header) with support for universal asynchronous receiver/transmitter (UART), serial peripheral interface (SPI), inter-integrated circuit sound (I2S), inter-integrated circuit (I2C), controller area network (CAN), pulse width modulation (PWM), digital microphone interface (DMIC), digital speaker station (DSPK), general purpose I/O (GPIO), etc., an automation header (e.g., 12 pin automation header), an audio panel header (e.g., a 10 pin audio panel header), a joint test action group (JTAG) header (e.g., a 10 pin JTAG header), a fan header (e.g., a 4 pin fan header), an RTC battery backup connector (e.g., a 2 pin battery backup connector), a microSD slot, a DC power jack, power, force, recovery, and reset buttons, one or more display connectors (e.g., DisplayPort (DP), such as a DP 1.4A (+MST), an eDP 1.41, an HDMI 2.1, and/or a 4K30 multi-model DP 1.2 (+MST) connector), and/or other I/O 1025 elements, components, or features.

The SoC(s) 1004 may include in-machine networking capability using, for example, Ethernet (e.g., automotive Ethernet), SERDES, controller area network (CAN), FlexRay, local interconnect network (LIN), low voltage differential signaling (LVDS), media oriented system transport (MOST), another networking type, and/or a combination thereof. For example, the SoC(s) 1004 may include an RJ45 connector with up to 10 GbE, a 1 GbE connector, and/or other networking connector types.

The SoC(s) 1004 may include one or more digital signal processors (DSPs) 1043. For example, the DSP(s) 1043 may include a dedicated or specialized microprocessor chip optimized for digital signal processing—such as in audio signal processing, telecommunications, digital image processing, RADAR, SONAR, LiDAR, and/or other sensor processing, speech recognition, and/or other applications.

The SoC(s) 1004 may include one or more video encoders 1019 and/or one or more video decoders 1021. For example, the video encoder(s) 1019 may include a hardware-based (e.g., as part of the GPU(s) 1008) video encoder (e.g., supporting H.264, H.265, etc., and being HEVC compliant, such as NVIDIA's NVENC) that may process image inputs (e.g., as YUV, RGB, etc.) to generate a video bit stream. The video decoder(s) 1021 may include a video decoder engine that may provide fully-accelerated hardware video decoding capabilities (e.g., supporting decoding of bitstreams in various formats, such as AV1, H.264, H.265, VP8, VP9, MPEG-1, MPEG-2, MPEG-4, VC-1, etc, and being HEVC compliant, such as NVIDIA's NVDEC). In some examples, the video decoder(s) 1021 may be hardware-based (e.g., as part of the GPU(s) 1008).

The SoC(s) 1004 may include one or more general compute acceleration clusters (GCAC(s)) 1029. For example, the GCAC(s) 1029 may include various processor types that may be used to accelerate compute, such as one or more vector microcode processors (VMPs) 1033, one or more multi-threaded processing clusters (MPCs) 1031, one or more programmable macro arrays (PMA(s)) 1035, and/or one or more other processor types. For example, the GCAC(s) 1029 may include a PMA 1035, two VMPs 1033, and 2 MPCs 1031.

The SoC(s) 1004 may include one or more vector microcode processors (VMPs) 1033. The VMP(s) 1033, in embodiments, may include a wide vector (very long instruction word (VLIW) and single instruction multiple data (SIMD))) machine with performing various operations, such as short integral type operations common in computer vision and deep learning algorithms.

The SoC(s) 1004 may include one or more multi-threaded processing clusters (MPCs) 1031. The MPC(s) 1031 may include a processing cluster that be, in embodiments, more versatile than a GPU, and with higher efficiency than a CPU. For example, the MPC(s) 1031 may include a multi-threaded processor that allows multiple threads to share resources and execute instructions concurrently.

The SoC(s) 1004 may include one or more programmable macro arrays (PMA(s)) 1035. The PMA(s) 1035 may include a coarse-grained reconfigurable architecture (CGRA) dataflow machine, having a unique architecture that delivers strong performance on dense computer vision and deep learning algorithms that may be unachievable in classic digital signal processing (DSP) architectures.

The SoC(s) 1004 may include one or more display processing units (DPUs) 1045 for performing hardware-accelerated image processing. For example, the DPU(s) 1045 may retrieve pixel data from memory 1015 and send it to a display peripheral through standard interfaces. As such, the DPU(s) 1045 may handle display processing and rendering for in-machine and/or on-machine displays.

The SoC(s) 1004 may include one or more application processing units (APUs) 1039. For example, the APU(s) 1039 may include a quad or dual-core processor with 48 KB/32 KB L1 cache with parity and ECC, along with a 1 MB L2 cache with ECC. The APU(s) 1039 may support NEON instructions and single and double precision floating point operations.

The SoC(s) 1004 may include one or more real-time processing units (RTPUs) 1069. The RTPU(s) 1069 may include a dual-core processor with 32 KB/32 KB L1 cache, and 256 KB TCM with ECC. The RTPU(s) 1069 may support single and double precision floating point operations.

The SoC(s) 1004 may include one or more built-in self-test (BIST) components 1037. For example, the BIST component(s) 1037 may include memory BIST (MBIST) to test memories of the system and/or logic BIST (LBIST) to test logic of the system. The BIST components 1037 may include embedded logic for directly testing logic and/or memory of the system.

The SoC(s) 1004 may include one or more dynamically reconfigurable processors (DRPs) 1071. For example, the DRP(s) 1071 may be used for accelerating various computing operations. For example, the DRP(s) 1071 may be combined, in embodiments, with a MAC unit for use as an AI accelerator. In embodiments, the DRP(s) 1071 may execute applications while dynamically switching the circuit connection configuration of the arithmetic units (e.g., ALUs) on the chip at each operating clock according to the content to be processed. Since only the necessary arithmetic circuits are used, the DRP(s) 1071 may consume less power than with CPU processing and can achieve higher speed. Furthermore, compared to CPUs, where frequent external memory accesses due to cache misses and other causes will degrade performance, the DRP(s) 1071 can build the necessary data paths in hardware ahead of time, resulting in less performance degradation and less variation in operating speed (jitter) due to memory accesses. The DRP(s) 1071 may include a dynamic loading function that switches the circuit connection information each time the algorithm changes, enabling processing with limited hardware resources, even in robotic/automotive applications that require processing of multiple algorithms.

In some embodiments, the accelerator(s) 1014 may include an OpenCV accelerator for speeding up processing of OpenCV, an open-source industry standard library for computer vision processing. In some embodiments, the combination of one or more DRP(s) 1071 deployed as an AI accelerator along with an OpenCV accelerator(s) may enhance AI computing and image processing algorithms, enabling complex and compute-heavy operations such as Visual simultaneous localization and mapping (SLAM).

In contrast to conventional systems, by providing a CPU complex, GPU complex, and a hardware acceleration cluster, the technology described herein allows for multiple neural networks to be performed simultaneously (e.g., at least partially in parallel) and/or sequentially, and for the results to be combined together to enable Level 2-5 autonomous driving functionality and/or autonomous robotics movement, control, planning, and/or navigation operations. In addition, because the SoC(s) 1004 may include various compute engines (e.g., processors 1010, CPUs 1006, GPU(s) 1008, accelerator(s) 1014, etc.), tasks may be distributed between and among the compute engines, in some instances without common cause failures due to the discrete footprint of the compute engines. Further, because the SoC(s) 1004 may include a dedicated safety processor(s) 1013 (or safety island 1013), critical safety or redundant operations may be performed without common cause failures from the main processing components or compute engines of the SoC(s) 1004. Due to these features, the SoC(s) 1004 and/or the underlying systems of the machine 1000 may be capable of satisfying higher levels of safety-such as automotive safety integrity level (ASIL) D from the ISO 26262 standard.

FIG. 10E is a system diagram for communication between a cloud-based server(s) (e.g., in a datacenter, such as those described herein) and the example autonomous or semi-autonomous vehicle or machine 1000 of FIG. 10A, in accordance with some embodiments of the present disclosure. The system 1076 may include a server(s) 1078, a network(s) 1090, and a machine(s) 1000. The server(s) 1078 may include a plurality of GPUs 1084(A)-1084(H) (collectively referred to herein as GPUs 1084), switches 1082(A)-1082(H) (such as PCIe 4.0/5.0/etc switches, M.2 slots, thunderbolt, USB4, NVIDIA's NVLink, NVIDIA's NVSwitch, GPUDirect RDMA, GPUDirect Storage, etc.), CPUs 1080(A)-1080(B) (collectively referred to herein as CPUs 1080), accelerators, and/or other processor types. The GPUs 1084, the CPUs 1080, and the PCIe switches may be interconnected with high-speed interconnects such as, for example and without limitation, NVLink interfaces 1088 developed by NVIDIA and/or PCIe connections 1086. In some examples, the GPUs 1084 are connected via NVLink and/or NVSwitch SoC and the GPUs 1084 and the PCIe switches 1082 are connected via PCIe interconnects. Although eight GPUs 1084, two CPUs 1080, and two PCIe switches are illustrated, this is not intended to be limiting. Depending on the embodiment, each of the server(s) 1078 may include any number of GPUs 1084, CPUs 1080, and/or PCIe switches. For example, the server(s) 1078 may each include eight, sixteen, thirty-two, and/or more GPUs 1084.

The server(s) 1078 may receive, over the network(s) 1090 and from the machine(s) 1000, sensor data indicating information about new or previously unexplored locations, and/or sensor data indicating changes to previously seen/stored locations (e.g., unexpected or changed road conditions, such as recently commenced road-work). The server(s) 1078 may transmit, over the network(s) 1090 and to the machine(s) 1000, neural networks 1092, updated neural networks 1092, map information 1094, etc., including information regarding traffic and road conditions. The updates to the map information 1094 may include updates for the HD map 1022, SD map, navigation map, etc., such as information regarding construction sites, potholes, detours, flooding, and/or other obstructions. In some examples, the neural networks 1092, the updated neural networks 1092, the map information 1094, and/or the other information may have resulted from new training and/or experiences represented in data received from any number of machine(s) 1000 in the environment, and/or based on training performed at a datacenter (e.g., using the server(s) 1078 and/or other servers).

The server(s) 1078 may be used to train machine learning models (e.g., neural networks) based on training data. The training data may be generated by the machine(s) 1000, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self-learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the machine(s) 1000 (e.g., transmitted to the machine(s) 1000 over the network(s) 1090, and/or the machine learning models may be used by the server(s) 1078 to remotely monitor and/or control the machine(s) 1000.

In some examples, the server(s) 1078 may receive data from the machine(s) 1000 and apply the data to up-to-date real-time neural networks for real-time intelligent inferencing. The server(s) 1078 may include deep-learning supercomputers and/or dedicated AI computers powered by GPU(s) 1084, such as a DGX and DGX Station machines developed by NVIDIA. However, in some examples, the server(s) 1078 may include deep learning infrastructure that use only CPU-powered datacenters.

The deep-learning infrastructure of the server(s) 1078 may be capable of fast, real-time inferencing, and may use that capability to evaluate and verify the health of the processors, software, and/or associated hardware in the machine 1000. For example, the deep-learning infrastructure may receive periodic updates from the machine 1000, such as a sequence of images and/or objects that the machine 1000 has located in that sequence of images (e.g., via computer vision and/or other machine learning object classification techniques). The deep-learning infrastructure may run its own neural network to identify the objects and compare them with the objects identified by the machine 1000 and, if the results do not match and the infrastructure concludes that the AI in the machine 1000 is malfunctioning, the server(s) 1078 may transmit a signal to the machine 1000 instructing a fail-safe computer of the machine 1000 to assume control, notify the passengers, and complete a safety maneuver or operation-such as to slow down, hand control back to a driver, come to a stop, and/or pull over/shut down.

For inferencing, the server(s) 1078 may include the GPU(s) 1084 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

### Computing Ecosystem for Generating, Training, and Deploying AI

FIG. 11 is a system diagram illustrating a three computer ecosystem 1100, including a first computing system 1102 for generating or creating artificial intelligence (AI)—such as AI training and validation data, a second computing system 1104 for training artificial intelligence, and a third computing system 1106 (which may include or correspond to the SoC(s) 1004 of FIGS. 10A-10E) deploying the AI at the edge, in accordance with at least some embodiments of the present disclosure. For example, to develop and deploy embodied or physical AI, the three computer ecosystem 1100 may be used, including three accelerated computer systems to handle physical AI training, simulation, and runtime (e.g., edge deployment). These systems may generate training data for and train multimodal foundation models (and/or other model types) using scalable, physically based simulations of the machine(s) 1000 and their worlds. By doing so, simulation of machine(s) 1000 may be performed at scale, allowing for refinement, testing, and optimization of skills (e.g., robot skills) in a virtual world (e.g., using NVIDIA's OMNIVERSE) that mimics the laws of physics-helping to reduce real-world data acquisition costs and ensuring the machine(s) 1000 can perform safely in controlled settings.

The computing system 1104 (e.g., NVIDIA's DGX Platform) may be used to train and fine-tune powerful foundation and generative AI models. Models, such as general purpose foundation models (e.g., NVIDIA's Project GROOT), may be used to enable robots and other machine(s) 1000 to understand natural language and emulate movements by observing human actions. The computing system 1104 may include a platform that incorporates software, infrastructure, and expertise in a modern, unified AI development and training solution. The computing system 1104 may include individual computing devices 1110 (e.g., NVIDIA's DGX B200, H200, etc.) and/or any number of computing devices 1110 in a datacenter infrastructure 1112 (e.g., NVIDIA's DGX SuperPOD).

For example, the individual computing devices 1110 may include GPUs (e.g., 8 GPUS with 1,440 GB total GPU memory) and CPUs (e.g., 2 CPUs with 112 cores total, 2.1 GHz, or 4 GHz (with boost)) that provide upwards of 72 petaFLOPS for training and 144 petaFLOPS for inference. The computing devices 1110 may include memory (e.g., 4 TB memory, and storage (e.g., OS storage of 2×1.9 TB NVMe M.2, and internal storage of 8×3.84 TB NVMe U.2). The computing devices 1110 may include various networking and network management components, such as OSFP ports (e.g., 4 OSFP ports) serving single-port smart host channel adapters (e.g., 8 single port ConnextX-7 virtual protocol interconnects (VPIs)), providing up to 400 GB/s Infiniband/Ethernet. The computing devices 1110 may further include, e.g., dual port quad small form-factor pluggable (QSFFP) data processing units (DPUs) (e.g., 2 dual-port QSFP112 DPUs such as NVIDIA's BlueField-3 DPUs), providing up to 400 Gb/s InfiniBand/Ethernet. The computing device(s) 1110 may include an onboard network interface card (NIC) (e.g., 10 Gb/s onboard NIC with RJ45), a dual-port Ethernet NIC (e.g., 100 GB/s dual-port Ethernet NIC), and/or a host baseboard management controller (MBC) (e.g., with RJ45). In some embodiments, the NICs used for the computing device(s) 1110 may include SuperNICs (e.g., NVIDIA's ConnectX-8 SuperNIC) to provide up to 800 Gb/s of data throughput for in-network computing acceleration engines to deliver the performance and robust feature set needed to power trillion-parameter scale AI factories and scientific computing workloads. In other embodiments, the computing device(s) 1110 may include a smart host channel adapter (HCA) (e.g., NVIDIA's ConnectX-7) to provide ultra-low latency, 400 Gb/s throughput for in-network computing acceleration engines.

The datacenter infrastructure 1112 may include any number of the computing devices 1110, along with an operating system (OS) (e.g., DGX OS extensions for Linux distributions) to maximize system uptime, security, and reliability, network/storage acceleration libraries and management to accelerate end-to-end infrastructure performance, cluster management to scale and manage one node (e.g., one computing device 1110) to thousands, job scheduling and orchestration to ensure hassle-free execution of every developer's job, AI workflow management and machine learning operations (MLOps) to move more models from prototype to production, and enterprise software to speed developer success.

The computing system 1102 (e.g., NVIDIA's OVX servers) may provide a development and simulation platform for testing and optimizing physical AI with APIs and frameworks for simulation (e.g., NVIDIA's DriveSIM, ISAAC Sim, ISAAC Gym, ISAAC Lab etc.). The computing system 1102 allows developers to use simulation frameworks to simulate and validate robot models, and/or to generate massive amounts of physically-based synthetic data to bootstrap model training. The computing system 1102 may support learning frameworks that power robot reinforcement learning and imitation learning, to accelerate robot policy training and refinement. For example, the computing system 1102 may be used to generate any number of simulations 1108-such as within NVIDIA's OMNIVERSE. The computing system 1102 may be used optimized for accelerating an entire software stack, from training, fine-tuning, and deploying generative AI to powering industrial digitalization within a content collaboration platform of APIs, software developer kits (SDKs), and services that allow for integration of OpenUSD, ray-tracing rendering technologies (e.g., NVIDIA's RTX), and generative physical AI into existing software tools and simulation workflows for, e.g., industrial and robotics use cases (e.g., NVIDIA's OMNIVERSE). As such, the computing system 1102 may host or support a native OpenUSD software platform enabling enterprises to connect 3D pipelines and develop advanced, real-time 3D applications for industrial digitalization. With powerful ray-tracing-accelerated AI and graphics capabilities, the computing system 1102 delivers powerful performance for workloads like extended reality (XR), multi-user design collaboration, and digital twins. This allows creation of physically accurate models with high-fidelity ray-traced and path-traced rendering of materials, operation of large-scale, AI-enabled simulations, and generation of photorealistic 3D synthetic data for training. The computing system 1102 may include individual computing devices 1114 (e.g., NVIDIA's OVX L40S Server) and/or any number of computing devices 1114 in a datacenter infrastructure 1116 (e.g., NVIDIA's OVX Systems).

The computing device(s) 1114 (which may include a server) may include CPUs (e.g., 2 CPUs with 32 cores each), and GPUs (e.g., 4 or 8 GPUs, each including 48 GB GDDR6 with ECC memory, 864 GB/s memory bandwidth, PCIe Gen4×16:64 GB/s bidirectional interconnect interface, 18,176 CUDA cores, 142 ray tracing (RT) cores, and 568 tensor cores). The computing devices 1114 may include various networking and network management components, such as smart host channel adapters (HCA) (e.g., 2 or 4 single port ConnextX-7 at 200 Gb/s each, providing up to 800 Gb/s Infiniband/Ethernet), one or more DPUs (e.g., a dual-port QSFP112 DPUs-such as an NVIDIA BlueField-3 DPU), providing up to 400 Gb/s InfiniBand/Ethernet. In some embodiments, the NICs used for the computing device(s) 1114 may include SuperNICs (e.g., NVIDIA's ConnectX-8 SuperNIC) to provide up to 800 Gb/s of data throughput for in-network computing acceleration engines to deliver the performance and robust feature set needed to power trillion-parameter scale AI factories and scientific computing workloads. In other embodiments, the computing device(s) 1114 may include a smart host channel adapter (HCA) (e.g., NVIDIA's ConnectX-7) to provide ultra-low latency, 400 Gb/s throughput for in-network computing acceleration engines. The computing device(s) 1114 may include a host memory (e.g., 384 Gb DDR5 ECC for 4 GPUs, or 768 Gb DDR5 ECC for 8 GPUs), and may include a dual in-line memory module (DIMM) slot(s), a host boot drive (e.g., 1 TB NVMe), and/or a host storage (e.g., 2 4 TB NVMe).

Similar to the datacenter infrastructure 1112, the datacenter infrastructure 1116 may allow for any number of computing device(s) 1114 to be combined in cluster configuration according to a reference architecture.

The computing system 1106 may be used to deploy trained AI models on a runtime computer—such as the SoC(s) 1004 described herein. For example, these computing systems 1106 may be designed for compact, on-board computing needs, including an ensemble of models for control policy, vision and language models, etc., deployed on a power-efficient on-board edge computing system 1106. Details of components, features, and capabilities of the computing system 1106 may be described in more detail herein with respect to FIGS. 10A-10E.

### Example Generative Models

In at least some embodiments, language models, such as large language models (LLMs), vision language models (VLMs), multi-modal language models (MMLMs), vision-language-action (VLA) models, and/or other types of generative artificial intelligence (AI) may be implemented. These models may be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries. These language models may be considered “large,” in embodiments, based on the models being trained on massive datasets and having architectures with large number of learnable network parameters (weights and biases)—such as millions or billions of parameters. The LLMs/VLMs/MMLMs/etc. may be implemented for summarizing textual data, analyzing and extracting insights from data (e.g., textual, image, video, etc.), and generating new text/image/video/etc. in user specified styles, tones, and/or formats. The LLMs/VLMs/MMLMs/etc. of the present disclosure may be used exclusively for text processing, in embodiments, whereas in other embodiments, multi-modal LLMs may be implemented to accept, understand, and/or generate text and/or other types of content like images, audio (sounds, synthetic speech, etc.), 2D and/or 3D data (e.g., in USD formats), and/or video. For example, vision language models (VLMs), or more generally multi-modal language models (MMLMs), may be implemented to accept image, video, sensor, audio, textual, 3D design (e.g., CAD), and/or other inputs data types and/or to generate or output image, video, audio, textual, 3D design, and/or other output data types.

Various types of LLMs/VLMs/MMLMs/etc. architectures may be implemented in various embodiments. For example, different architectures may be implemented that use different techniques for understanding and generating outputs-such as text, audio, video, image, 2D and/or 3D design or asset data, etc. In some embodiments, LLMs/VLMs/MMLMs/etc. architectures such as recurrent neural networks (RNNs) or long short-term memory networks (LSTMs) may be used, while in other embodiments transformer architectures-such as those that rely on self-attention and/or cross-attention (e.g., between contextual data and textual data) mechanisms—may be used to understand and recognize relationships between words or tokens and/or contextual data (e.g., other text, video, image, design data, USD, etc.). One or more generative processing pipelines that include LLMs/VLMs/MMLMs/etc. may also include one or more diffusion block(s) (e.g., denoisers). The LLMs/VLMs/MMLMs/etc. of the present disclosure may include encoder and/or decoder block(s). For example, discriminative or encoder-only models like BERT (Bidirectional Encoder Representations from Transformers) may be implemented for tasks that involve language comprehension such as classification, sentiment analysis, question answering, and named entity recognition. As another example, generative or decoder-only models like GPT (Generative Pretrained Transformer) may be implemented for tasks that involve language and content generation such as text completion, story generation, and dialogue generation. LLMs/VLMs/MMLMs/etc. that include both encoder and decoder components like T5 (Text-to-Text Transformer) may be implemented to understand and generate content, such as for translation and summarization. These examples are not intended to be limiting, and any architecture type-including but not limited to those described herein—may be implemented depending on the particular embodiment and the task(s) being performed using the LLMs/VLMs/MMLMs/etc.

In various embodiments, the LLMs/VLMs/MMLMs/etc. may be trained using unsupervised learning, in which an LLMs/VLMs/MMLMs/etc. learns patterns from large amounts of unlabeled text/audio/video/image/design/USD/etc. data. Due to the extensive training, in embodiments, the models may not require task-specific or domain-specific training. LLMs/VLMs/MMLMs/etc. that have undergone extensive pre-training on vast amounts of unlabeled data may be referred to as foundation models and may be adept at a variety of tasks like question-answering, summarization, filling in missing information, translation, image/video/design/USD/data generation. Some LLMs/VLMs/MMLMs/etc. may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some embodiments, the LLMs/VLMs/MMLMs/etc. of the present disclosure may be implemented using various model alignment techniques. For example, in some embodiments, guardrails may be implemented to identify improper or undesired inputs (e.g., prompts) and/or outputs of the models. In doing so, the system may use the guardrails and/or other model alignment techniques to either prevent a particular undesired input from being processed using the LLMs/VLMs/MMLMs/etc., and/or preventing the output or presentation (e.g., display, audio output, etc.) of information generating using the LLMs/VLMs/MMLMs/etc. In some embodiments, one or more additional models—or layers thereof—may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/implementation. As a result, the LLMs/VLMs/MMLMs/etc. of the present disclosure may be less likely to output language/text/audio/video/design data/USD data/etc. that may be offensive, vulgar, improper, unsafe, out of domain, and/or otherwise undesired for the particular application/implementation.

In some embodiments, the LLMs/VLMs/etc. may be configured to or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., 3rd party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires a mathematical computation, the model may access one or more math plug-ins or APIs for help in solving the problem(s), and may then use the response from the plug-in and/or API in the output from the model. This process may be repeated—e.g., recursively—for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources—such as APIs, plug-ins, and/or the like.

In some embodiments, multiple language models (e.g., LLMs/VLMs/MMLMs/etc., multiple instances of the same language model, and/or multiple prompts provided to the same language model or instance of the same language model may be implemented, executed, or accessed (e.g., using one or more plug-ins, user interfaces, APIs, databases, data stores, repositories, etc.) to provide output responsive to the same query, or responsive to separate portions of a query. In at least one embodiment, multiple language models e.g., language models with different architectures, language models trained on different (e.g. updated) corpuses of data may be provided with the same input query and prompt (e.g., set of constraints, conditioners, etc.). In one or more embodiments, the language models may be different versions of the same foundation model. In one or more embodiments, at least one language model may be instantiated as multiple agents—e.g., more than one prompt may be provided to constrain, direct, or otherwise influence a style, a content, or a character, etc., of the output provided. In one or more example, non-limiting embodiments, the same language model may be asked to provide output corresponding to a different role, perspective, character, or having a different base of knowledge, etc.—as defined by a supplied prompt.

In any one of such embodiments, the output of two or more (e.g., each) language models, two or more versions of at least one language model, two or more instanced agents of at least one language model, and/or two more prompts provided to at least one language model may be further processed, e.g., aggregated, compared or filtered against, or used to determine (and provide) a consensus response. In one or more embodiments, the output from one language model—or version, instance, or agent—maybe be provided as input to another language model for further processing and/or validation. In one or more embodiments, a language model may be asked to generate or otherwise obtain an output with respect to an input source material, with the output being associated with the input source material. Such an association may include, for example, the generation of a caption or portion of text that is embedded (e.g., as metadata) with an input source text or image. In one or more embodiments, an output of a language model may be used to determine the validity of an input source material for further processing, or inclusion in a dataset. For example, a language model may be used to assess the presence (or absence) of a target word in a portion of text or an object in an image, with the text or image being annotated to note such presence (or lack thereof). Alternatively, the determination from the language model may be used to determine whether the source material should be included in a curated dataset, for example and without limitation.

FIG. 12 is a block diagram of an example generative language model system 1200 suitable for use in implementing at least some embodiments of the present disclosure. In the example illustrated in FIG. 12, the generative language model system 1200 includes a retrieval augmented generation (RAG) component 1292, an input processor 1205, a tokenizer 1210, an embedding component 1220, plug-ins/APIs 1295, and a generative language model (LM) 1230 (which may include an LLM, a VLM, a MMLM, a VLA model, etc.).

At a high level, the input processor 1205 may receive an input 1201 comprising text and/or other types of input data (e.g., audio data, video data, image data, sensor data (e.g., LiDAR, RADAR, ultrasonic, etc.), 3D design data, CAD data, universal scene descriptor (USD) data-such as OpenUSD, etc.), depending on the architecture of the generative LM 1230 (e.g., LLM/VLM/MMLM/etc.). In some embodiments, the input 1201 includes plain text in the form of one or more sentences, paragraphs, and/or documents. Additionally or alternatively, the input 1201 may include numerical sequences, precomputed embeddings (e.g., word or sentence embeddings), and/or structured data (e.g., in tabular formats, JSON, or XML). In some implementations in which the generative LM 1230 is capable of processing multi-modal inputs, the input 1201 may combine text (or may omit text) with image data, audio data, video data, design data, USD data, and/or other types of input data, such as but not limited to those described herein. Taking raw input text as an example, the input processor 1205 may prepare raw input text in various ways. For example, the input processor 1205 may perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 1205 may remove stopwords to reduce noise and focus the generative LM 1230 on more meaningful content. The input processor 1205 may apply text normalization (TN), for example, by converting all characters to lowercase, removing accents, and/or or handling special cases like contractions or abbreviations to ensure consistency (e.g., converting ¼ to one quarter). Similarly, the input processor 1205 and/or a post-processor may perform inverse text normalization (ITN) in order to convert plain language back to canonical or other forms (e.g., to convert one quarter to ¼). These are just a few examples, and other types of input and/or output processing may be applied.

In some embodiments, a RAG component 1292 (which may include one or more RAG models, and/or may be performed using the generative LM 1230 itself) may be used to retrieve additional information to be used as part of the input 1201 or prompt. RAG may be used to enhance the input to the LLM/VLM/MMLM/etc. with external knowledge, so that answers to specific questions or queries or requests are more relevant-such as in a case where specific knowledge is required. The RAG component 1292 may fetch this additional information (e.g., grounding information, such as grounding text/image/video/audio/USD/CAD/etc.) from one or more external sources, which can then be fed to the LLM/VLM/MMLM/etc. along with the prompt to improve accuracy of the responses or outputs of the model.

For example, in some embodiments, the input 1201 may be generated using the query or input to the model (e.g., a question, a request, etc.) in addition to data retrieved using the RAG component 1292. In some embodiments, the input processor 1205 may analyze the input 1201 and communicate with the RAG component 1292 (or the RAG component 1292 may be part of the input processor 1205, in embodiments) in order to identify relevant text and/or other data to provide to the generative LM 1230 as additional context or sources of information from which to identify the response, answer, or output 1290, generally. For example, where the input indicates that the user is interested in a desired tire pressure for a particular make and model of vehicle, the RAG component 1292 may retrieve-using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 1292 may retrieve a prior stored conversation history- or at least a summary thereof- and include the prior conversation history along with the current ask/request as part of the input 1201 to the generative LM 1230.

The RAG component 1292 may use various RAG techniques. For example, naïve RAG may be used where documents are indexed, chunked, and applied to an embedding model to generate embeddings corresponding to the chunks. A user query may also be applied to the embedding model and/or another embedding model of the RAG component 1292 and the embeddings of the chunks along with the embeddings of the query may be compared to identify the most similar/related embeddings to the query, which may be supplied to the generative LM 1230 to generate an output.

In some embodiments, more advanced RAG techniques may be used. For example, prior to passing chunks to the embedding model, the chunks may undergo pre-retrieval processes (e.g., routing, rewriting, metadata analysis, expansion, etc.). In addition, prior to generating the final embeddings, post-retrieval processes (e.g., re-ranking, prompt compression, etc.) may be performed on the outputs of the embedding model prior to final embeddings being used as comparison to an input query.

As a further example, modular RAG techniques may be used, such as those that are similar to naïve and/or advanced RAG, but also include features such as hybrid search, recursive retrieval and query engines, StepBack approaches, sub-queries, and hypothetical document embedding.

As another example, Graph RAG may use knowledge graphs as a source of context or factual information. Graph RAG may be implemented using a graph database as a source of contextual information sent to the LLM/VLM/MMLM/etc. Rather than (or in addition to) providing the model with chunks of data extracted from larger sized documents—which may result in a lack of context, factual correctness, language accuracy, etc.—graph RAG may also provide structured entity information to the LLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/VLM/MMLM/etc. to answer using them. The knowledge graph, in such embodiments, may contain relevant textual content and metadata about the knowledge graph as well as be integrated with a vector database. In some embodiments, the graph RAG may use a graph as a subject matter expert, where descriptions of concepts and entities relevant to a query/prompt may be extracted and passed to the model as semantic context. These descriptions may include relationships between the concepts. In other examples, the graph may be used as a database, where part of a query/prompt may be mapped to a graph query, the graph query may be executed, and the LLM/VLM/MMLM/etc. may summarize the results. In such an example, the graph may store relevant factual information, and a query (natural language query) to graph query tool (NL-to-Graph-query tool) and entity linking may be used. In some embodiments, graph RAG (e.g., using a graph database) may be combined with standard (e.g., vector database) RAG, and/or other RAG types, to benefit from multiple approaches.

In any embodiments, the RAG component 1292 may implement a plugin, API, user interface, and/or other functionality to perform RAG. For example, a graph RAG plug-in may be used by the LLM/VLM/MMLM/etc. to run queries against the knowledge graph to extract relevant information for feeding to the model, and a standard or vector RAG plug-in may be used to run queries against a vector database. For example, the graph database may interact with a plug-in's REST interface such that the graph database is decoupled from the vector database and/or the embeddings models.

The tokenizer 1210 may segment the (e.g., processed) text data into smaller units (tokens) for subsequent analysis and processing. The tokens may represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 1230 to understand morphological variations and handle out-of-vocabulary words more effectively. Character-based tokenization represents each character as a separate token, enabling the generative LM 1230 to process text at a fine-grained level. The choice of tokenization strategy may depend on factors such as the language being processed, the task at hand, and/or characteristics of the training dataset. As such, the tokenizer 1210 may convert the (e.g., processed) text into a structured format according to tokenization schema being implemented in the particular embodiment.

The embedding component 1220 may use any known embedding technique to transform discrete tokens into (e.g., dense, continuous vector) representations of semantic meaning. For example, the embedding component 1220 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 1201 includes image data/video data/etc., the input processor 1201 may resize the data to a standard size compatible with format of a corresponding input channel and/or may normalize pixel values to a common range (e.g., 0 to 1) to ensure a consistent representation, and the embedding component 1220 may encode the image data using any known technique (e.g., using one or more convolutional neural networks (CNNs) to extract visual features). In some implementations in which the input 1201 includes audio data, the input processor 1201 may resample an audio file to a consistent sampling rate for uniform processing, and the embedding component 1220 may use any known technique to extract and encode audio features-such as in the form of a spectrogram (e.g., a mel-spectrogram). In some implementations in which the input 1201 includes video data, the input processor 1201 may extract frames or apply resizing to extracted frames, and the embedding component 1220 may extract features such as optical flow embeddings or video embeddings and/or may encode temporal information or sequences of frames. In some implementations in which the input 1201 includes multi-modal data, the embedding component 1220 may fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 1230 and/or other components of the generative LM system 1200 may use different types of neural network architectures depending on the implementation. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, linear-time sequence modeling with selective state space modeling (SSM) architectures (e.g., Mamba LLM architectures), and/or others. As such, depending on the implementation and architecture, the embedding component 1220 may apply an encoded representation of the input 1201 to the generative LM 1230, and the generative LM 1230 may process the encoded representation of the input 1201 to generate an output 1290, which may include responsive text and/or other types of data.

As described herein, in some embodiments, the generative LM 1230 may be configured to access or use—or capable of accessing or using—plug-ins/APIs 1295 (which may include one or more plug-ins, application programming interfaces (APIs), databases, data stores, repositories, etc.). For example, for certain tasks or operations that the generative LM 1230 is not ideally suited for, the model may have instructions (e.g., as a result of training, and/or based on instructions in a given prompt, such as those retrieved using the RAG component 1292) to access one or more plug-ins/APIs 1295 (e.g., 3rd party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 1295 to the plug-in/API 1295, the plug-in/API 1295 may process the information and return an answer to the generative LM 1230, and the generative LM 1230 may use the response to generate the output 1290. This process may be repeated—e.g., recursively—for any number of iterations and using any number of plug-ins/APIs 1295 until an output 1290 that addresses each ask/question/request/process/operation/etc. from the input 1201 can be generated. As such, the model(s) may not only rely on its own knowledge from training on a large dataset(s) and/or from data retrieved using the RAG component 1292, but also on the expertise or optimized nature of one or more external resources-such as the plug-ins/APIs 1295.

In some embodiments, one or more transformer engines (TEs) may be implemented. The transformer engine may use micro-tensor scaling to optimize performance and accuracy-such as to enable 16-bit floating point (FP16), 8-bit floating point (FP8), and/or 4-bit floating point (FP4) artificial intelligence processing. For example, the transformer engine may use 16-bit or 8-bit floating point precision and an 8-bit or 4-bit floating point data format combined with software algorithms for increasing AI performance and capabilities. By reducing math operations to 8-bits or 4-bits, the TE allows for training larger networks faster without compromising accuracy. For example, the TEs may include a library for accelerating transformer models on processing devices-such as GPUs—to provide better performance with lower memory utilization in both training and inference. When the TE is combined with other technologies, such as high-speed interconnects between nodes (e.g., using switches—such as NVLink Switches) and tensor cores (which enable mixed-precision computing, such as micro-scaling precision support), server clusters may be more capable of training enormous networks (e.g., billions of parameters) at high speeds. As such, tensor core precisions of FP64, TF32, BF16, FP16, FP8, INT8, FP6, and FP4 may be supported, as well as CUDA core precisions of FP64, FP32, FP16, and BF16.

These and other architectures for LLMs/VLMs/MMLMs/VLAs/etc. described herein are meant simply as examples, and other suitable architectures may be implemented within the scope of the present disclosure.

### Example Computing Device

FIG. 13 is a block diagram of an example computing device(s) 1300 suitable for use in implementing some embodiments of the present disclosure. Computing device 1300 may include an interconnect system 1302 that directly or indirectly couples the following devices: memory 1304, one or more central processing units (CPUs) 1306, one or more graphics processing units (GPUs) 1308, a communication interface 1310, input/output (I/O) ports 1312, input/output components 1314, a power supply 1316, one or more presentation components 1318 (e.g., display(s), speaker(s), etc.), and one or more logic units 1320. In at least one embodiment, the computing device(s) 1300 may comprise one or more virtual machines (VMs), and/or any of the components thereof may comprise virtual components (e.g., virtual hardware components). For non-limiting examples, one or more of the GPUs 1308 may comprise one or more vGPUs, one or more of the CPUs 1306 may comprise one or more vCPUs, and/or one or more of the logic units 1320 may comprise one or more virtual logic units. As such, a computing device(s) 1300 may include discrete components (e.g., a full GPU dedicated to the computing device 1300), virtual components (e.g., a portion of a GPU dedicated to the computing device 1300), or a combination thereof.

Although the various blocks of FIG. 13 are shown as connected via the interconnect system 1302 with lines, this is not intended to be limiting and is for clarity only. For example, in some embodiments, a presentation component 1318, such as a display device, may be considered an I/O component 1314 (e.g., if the display is a touch screen). As another example, the CPUs 1306 and/or GPUs 1308 may include memory (e.g., the memory 1304 may be representative of a storage device in addition to the memory of the GPUs 1308, the CPUs 1306, and/or other components). As such, the computing device of FIG. 13 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 13.

The interconnect system 1302 may represent one or more links or busses, such as an address bus, a data bus, a control bus, or a combination thereof. The interconnect system 1302 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1306 may be directly connected to the memory 1304. Further, the CPU 1306 may be directly connected to the GPU 1308. Where there is direct, or point-to-point connection between components, the interconnect system 1302 may include a PCIe link to carry out the connection. In these examples, a PCI bus need not be included in the computing device 1300.

The memory 1304 may include any of a variety of computer-readable media. The computer-readable media may be any available media that may be accessed by the computing device 1300. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1304 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1300. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1306 may be configured to execute at least some of the computer-readable instructions to control one or more components of the computing device 1300 to perform one or more of the methods and/or processes described herein. The CPU(s) 1306 may each include one or more cores (e.g., one, two, four, eight, twenty-eight, seventy-two, etc.) that are capable of handling a multitude of software threads simultaneously. The CPU(s) 1306 may include any type of processor, and may include different types of processors depending on the type of computing device 1300 implemented (e.g., processors with fewer cores for mobile devices and processors with more cores for servers). For example, depending on the type of computing device 1300, the processor may be an Advanced RISC Machines (ARM) processor implemented using Reduced Instruction Set Computing (RISC) or an x86 processor implemented using Complex Instruction Set Computing (CISC). The computing device 1300 may include one or more CPUs 1306 in addition to one or more microprocessors or supplementary co-processors, such as math co-processors.

In addition to or alternatively from the CPU(s) 1306, the GPU(s) 1308 may be configured to execute at least some of the computer-readable instructions to control one or more components of the computing device 1300 to perform one or more of the methods and/or processes described herein. One or more of the GPU(s) 1308 may be an integrated GPU (e.g., with one or more of the CPU(s) 1306 and/or one or more of the GPU(s) 1308 may be a discrete GPU. In embodiments, one or more of the GPU(s) 1308 may be a coprocessor of one or more of the CPU(s) 1306. The GPU(s) 1308 may be used by the computing device 1300 to render graphics (e.g., 3D graphics) or perform general purpose computations. For example, the GPU(s) 1308 may be used for General-Purpose computing on GPUs (GPGPU). The GPU(s) 1308 may include hundreds or thousands of cores that are capable of handling hundreds or thousands of software threads simultaneously. The GPU(s) 1308 may generate pixel data for output images in response to rendering commands (e.g., rendering commands from the CPU(s) 1306 received via a host interface). The GPU(s) 1308 may include graphics memory, such as display memory, for storing pixel data or any other suitable data, such as GPGPU data. The display memory may be included as part of the memory 1304. The GPU(s) 1308 may include two or more GPUs operating in parallel (e.g., via a link). The link may directly connect the GPUs (e.g., using NVLINK) or may connect the GPUs through a switch (e.g., using NVSwitch). When combined together, each GPU 1308 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1306 and/or the GPU(s) 1308, the logic unit(s) 1320 may be configured to execute at least some of the computer-readable instructions to control one or more components of the computing device 1300 to perform one or more of the methods and/or processes described herein. In embodiments, the CPU(s) 1306, the GPU(s) 1308, and/or the logic unit(s) 1320 may discretely or jointly perform any combination of the methods, processes and/or portions thereof. One or more of the logic units 1320 may be part of and/or integrated in one or more of the CPU(s) 1306 and/or the GPU(s) 1308 and/or one or more of the logic units 1320 may be discrete components or otherwise external to the CPU(s) 1306 and/or the GPU(s) 1308. In embodiments, one or more of the logic units 1320 may be a coprocessor of one or more of the CPU(s) 1306 and/or one or more of the GPU(s) 1308.

Examples of the logic unit(s) 1320 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Deep Learning Accelerator Clusters (XNNs), Neural Processing Units (NPUs), Neural Network Accelerators (NNAs), Programmable Vision Accelerators (PVAs)—which may include one or more direct memory access (DMA) systems, one or more vision or vector processing units (VPUs), one or more pixel processing engines (PPEs)—e.g., including a 2D array of processing elements that each communicate north, south, east, and west with one or more other processing elements in the array, one or more decoupled accelerators or units (e.g., decoupled lookup table (DLUT) accelerators or units), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1310 may include one or more receivers, transmitters, and/or transceivers that allow the computing device 1300 to communicate with other computing devices via an electronic communication network, included wired and/or wireless communications. The communication interface 1310 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1320 and/or communication interface 1310 may include one or more data processing units (DPUs) to transmit data received over a network and/or through interconnect system 1302 directly to (e.g., a memory of) one or more GPU(s) 1308.

The I/O ports 1312 may allow the computing device 1300 to be logically coupled to other devices including the I/O components 1314, the presentation component(s) 1318, and/or other components, some of which may be built in to (e.g., integrated in) the computing device 1300. Illustrative I/O components 1314 include a microphone, mouse, keyboard, joystick, game pad, game controller, satellite dish, scanner, printer, wireless device, etc. The I/O components 1314 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1300. The computing device 1300 may be include depth cameras, such as stereoscopic camera systems, infrared camera systems, RGB camera systems, touchscreen technology, and combinations of these, for gesture detection and recognition. Additionally, the computing device 1300 may include accelerometers or gyroscopes (e.g., as part of an inertia measurement unit (IMU)) that allow detection of motion. In some examples, the output of the accelerometers or gyroscopes may be used by the computing device 1300 to render immersive augmented reality or virtual reality.

The power supply 1316 may include a hard-wired power supply, a battery power supply, or a combination thereof. The power supply 1316 may provide power to the computing device 1300 to allow the components of the computing device 1300 to operate.

The presentation component(s) 1318 may include a display (e.g., a monitor, a touch screen, a television screen, a heads-up-display (HUD), other display types, or a combination thereof), speakers, and/or other presentation components. The presentation component(s) 1318 may receive data from other components (e.g., the GPU(s) 1308, the CPU(s) 1306, DPUs, etc.), and output the data (e.g., as an image, video, sound, etc.).

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1300 of FIG. 13—e.g., each device may include similar components, features, and/or functionality of the computing device(s) 1300. In addition, where backend devices (e.g., servers, NAS, etc.) are implemented, the backend devices may be included as part of a datacenter (such as, but not limited to, those described herein).

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more datacenters that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1300 described herein with respect to FIG. 13. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a talking kiosk, a remote control, an appliance, a consumer electronic device, a workstation, an edge device, any combination of these delineated devices, or any other suitable device.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of the following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items” indicates multiple items). In at least one embodiment, number of items in a plurality is at least two, but may be more when so indicated either explicitly or by context. Further, unless stated otherwise or otherwise clear from context, phrase “based on” means “based at least in part on” and not “based solely on.”

Operations of processes described herein may be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors.

In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

In at least one embodiment, an arithmetic logic unit is a set of combinational logic circuitry that takes one or more inputs to produce a result. In at least one embodiment, an arithmetic logic unit is used by a processor to implement mathematical operation such as addition, subtraction, or multiplication. In at least one embodiment, an arithmetic logic unit is used to implement logical operations such as logical AND/OR or XOR. In at least one embodiment, an arithmetic logic unit is stateless, and made from physical switching components such as semiconductor transistors arranged to form logical gates. In at least one embodiment, an arithmetic logic unit may operate internally as a stateful logic circuit with an associated clock. In at least one embodiment, an arithmetic logic unit may be constructed as an asynchronous logic circuit with an internal state not maintained in an associated register set. In at least one embodiment, an arithmetic logic unit is used by a processor to combine operands stored in one or more registers of the processor and produce an output that may be stored by the processor in another register or a memory location.

In at least one embodiment, as a result of processing an instruction retrieved by the processor, the processor presents one or more inputs or operands to an arithmetic logic unit, causing the arithmetic logic unit to produce a result based at least in part on an instruction code provided to inputs of the arithmetic logic unit. In at least one embodiment, the instruction codes provided by the processor to the ALU are based at least in part on the instruction executed by the processor. In at least one embodiment combinational logic in the ALU processes the inputs and produces an output which is placed on a bus within the processor. In at least one embodiment, the processor selects a destination register, memory location, output device, or output storage location on the output bus so that clocking the processor causes the results produced by the ALU to be sent to the desired location.

Accordingly, in at least one embodiment, computer systems are configured to implement one or more services that singly or collectively perform operations of processes described herein and such computer systems are configured with applicable hardware and/or software that allow performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing component, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. In at least one embodiment, process of obtaining, acquiring, receiving, or inputting analog and digital data may be accomplished in a variety of ways such as by receiving data as a parameter of a function call or a call to an application programming interface. In at least one embodiment, processes of obtaining, acquiring, receiving, or inputting analog or digital data may be accomplished by transferring data via a serial or parallel interface. In at least one embodiment, processes of obtaining, acquiring, receiving, or inputting analog or digital data may be accomplished by transferring data via a computer network from providing entity to acquiring entity. References may also be made to providing, outputting, transmitting, sending, or presenting analog or digital data. In at least one embodiment, processes of providing, outputting, transmitting, sending, or presenting analog or digital data may be accomplished by transferring data as an input or output parameter of a function call, a parameter of an application programming interface or interprocess communication mechanism.

Although descriptions herein set forth example implementations of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

The descriptions herein may be supported by at least the following example clauses:

Clause 1. At least one processor configured to: predict an open-door of a vehicle based in part on a bounding box applied to a representation of the vehicle used with a first machine learning (ML) model trained using bounding boxes for different vehicles having one or more of closed doors or open doors; and classify the open-door as a specific type based in part on at least one portion of the representation used with a second ML model trained with classes of different types of the open doors for the different vehicles.

Clause 2. The at least one processor of clause 1, further configured to: provide, using a two-dimensional (2D) sensor, the representation in 2D information; and use a 2D-to-three-dimensional (3D) conversion sub-system to illustrate the open-door of the vehicle in 3D information based in part on an output of the second ML model.

Clause 3. The at least one processor of clause 2, wherein the at least one processor is comprised in the 2D-to-3D conversion sub-system which is used to generate or support an illustration of a top-down or bird's eye view (BEV) representation the open-door of the vehicle.

Clause 4. The at least one processor of clause 2, wherein the 2D sensor is an onboard camera of an autonomous semi-autonomous vehicle.

Clause 5. The at least one processor of clause 2, wherein the at least one processor is comprised in or supports a driving sub-system of an autonomous or semi-autonomous vehicle, and wherein the at least one processor is further configured to perform or recommend a reaction to the open-door.

Clause 6. The at least one processor of clause 5, further to: perform, as part of the driving sub-system, a go around, a slow drive by, a stop, or maintain a distance from the vehicle, as part of the reaction to the open-door.

Clause 7. The at least one processor of clause 1, wherein the specific type is one of a left passenger door open, a right passenger door open, a left driver door open, a right driver door open, a left door open, a right door open, a rear door open, a moonroof or sunroof open, or a bonnet open.

Clause 8. The at least one processor of clause 1, wherein the at least one portion of the representation is a part of the representation having extended dimensions, with respect to the bounding boxes in the first ML model, or is a predetermined part of the representation as determined from an edge of at least one dimension of the bounding box.

Clause 9. The at least one processor of clause 1, wherein the at least one portion of the representation comprises one of: an extended dimension taken with reference to the bounding box and with respect to the bounding boxes; or a predetermined width from an edge of the bounding box.

Clause 10. The at least one processor of clause 1, further configured to: train the first ML model using first data generated from the bounding boxes which are around one or more of the closed doors or the open doors of the different vehicles, wherein the first ML model is to generate an output representing the prediction of the open-door for the vehicle; and train a second ML model using second data generated from different bounding boxes which are specifically around different types of the open doors for the different vehicles, wherein the second ML model is to generate an output representing a classification of the open-door as the specific type for the vehicle from the different types.

Clause 11. The at least one processor of clause 1, further configured to: use a two-dimensional (2D) sensor to provide the representation in as 2D information; use depth sensors with the representation in the 2D information to generate at least part of the representation in three-dimensional (3D) information; and use the 2D information as input with the second ML model which is trained using the 2D information and the 3D information to perform the classification of the open-door in a 3D space.

Clause 12. One or more processors to train a machine learning (ML) model to determine a specific type of an open-door of a vehicle using different classes associated with different types of the open doors for different vehicles.

Clause 13. The one or more processors of clause 12, further to train an additional ML model to predict the open-door of the vehicle based in part on different bounding boxes for different vehicles having one or more of closed doors or open doors.

Clause 14. The one or more processors of clause 12, wherein the specific type is one of a left passenger door open, a right passenger door open, a left driver door open, a right driver door open, a left door open, a right door open, a rear door open, a moonroof or sunroof open, or a bonnet open.

Clause 15. One or more processors to determine a specific type of an open-door of a vehicle based in part on a machine learning (ML) model which is trained using different classes associated with different types of open doors for different vehicles.

Clause 16. The one or more processors of clause 15, wherein the one or more processors are comprised in at least one of: a control system for an autonomous or semi-autonomous machine; a perception system for the autonomous or semi-autonomous machine; a system for performing one or more simulation operations; a system for performing one or more digital twin operations; a system for performing light transport simulation; a system for performing collaborative content creation for 3D assets; a system for performing one or more deep learning operations; a system implemented using an edge device; a system implemented using a robot; a system for performing one or more generative AI operations; a system for performing operations using one or more large language models (LLMs); a system for performing operations using one or more vision language models (VLMs); a system for performing operations using one or more multi-modal language models (MMLMs); a system for performing operations using one or more vision-language-action (VLA) models; a system for using or deploying one or more inference microservices; a system for performing one or more conversational AI operations; a system for generating synthetic data; a system for presenting at least one of virtual reality content, augmented reality content, or mixed reality content; a system incorporating one or more virtual machines (VMs); a system implemented at least partially in a datacenter; or a system implemented at least partially using cloud computing resources.

Clause 17. A method comprising: predicting an open-door of a vehicle based in part on a bounding box applied to a representation of the vehicle used with a first machine learning (ML) model trained using bounding boxes for different vehicles having one or more of closed doors or open doors; and classifying the open-door as a specific type based in part on at least one portion of the representation used with a second ML model trained with classes of different types of the open doors for the different vehicles.

Clause 18. The method of clause 17, further comprising: training the first ML model using first data generated from the bounding boxes which are around one or more of the closed doors or the open doors of the different vehicles, wherein the first ML model is to generate an output representing the prediction of the open-door for the vehicle; and training a second ML model using second data generated from different bounding boxes which are specifically around different types of the open doors for the different vehicles, wherein the second ML model is to generate an output representing a classification of the open-door as the specific type for the vehicle from the different types.

Clause 19. The method of clause 17, further comprising one or more of: generating or supporting an illustration of a top-down or bird's eye view (BEV) representation the open-door of the vehicle; performing, by a driving sub-system of an autonomous or semi-autonomous vehicle having at least one processor, a reaction to the open-door; recommending the reaction to the open-door; using, as the specific type for the open-door, one of a left passenger door open, a right passenger door open, a left driver door open, a right driver door open, a left door open, a right door open, a rear door open, a moonroof or sunroof open, or a bonnet open; or performing or recommending, as the reaction, a go around, a slow drive by, a stop, or maintain a distance from the vehicle.

Clause 20. The method of clause 17, wherein the representation is comprised, in part, in two-dimensional (2D) information from a 2D sensor and wherein the method further comprises: using depth sensors with the 2D information to generate at least part of the representation in three-dimensional (3D) information, wherein the 2D information is used as input with the second ML model which is trained using the 2D information and the 3D information to perform the classification of the open-door in a 3D space; or using a 2D-to-3D conversion sub-system to illustrate the open-door of the vehicle in 3D information based in part on an output of the second ML model.

What is claimed is:

1. At least one processor configured to:
predict an open-door of a vehicle based in part on a bounding box applied to a representation of the vehicle used with a first machine learning (ML) model trained using bounding boxes for different vehicles having one or more of closed doors or open doors; and
classify the open-door as a specific type based in part on at least one portion of the representation used with a second ML model trained with classes of different types of the open doors for the different vehicles.

2. The at least one processor of claim 1, further configured to:
provide, using a two-dimensional (2D) sensor, the representation in 2D information; and
use a 2D-to-three-dimensional (3D) conversion sub-system to illustrate the open-door of the vehicle in 3D information based in part on an output of the second ML model.

3. The at least one processor of claim 2, wherein the at least one processor is comprised in the 2D-to-3D conversion sub-system which is used to generate or support an illustration of a top-down or bird's eye view (BEV) representation the open-door of the vehicle.

4. The at least one processor of claim 2, wherein the 2D sensor is an onboard camera of an autonomous semi-autonomous vehicle.

5. The at least one processor of claim 2, wherein the at least one processor is comprised in or supports a driving sub-system of an autonomous or semi-autonomous vehicle, and wherein the at least one processor is further configured to perform or recommend a reaction to the open-door.

6. The at least one processor of claim 5, further to:
perform, as part of the driving sub-system, a go around, a slow drive by, a stop, or maintain a distance from the vehicle, as part of the reaction to the open-door.

7. The at least one processor of claim 1, wherein the specific type is one of a left passenger door open, a right passenger door open, a left driver door open, a right driver door open, a left door open, a right door open, a rear door open, a moonroof or sunroof open, or a bonnet open.

8. The at least one processor of claim 1, wherein the at least one portion of the representation is a part of the representation having extended dimensions, with respect to the bounding boxes in the first ML model, or is a predetermined part of the representation as determined from an edge of at least one dimension of the bounding box.

9. The at least one processor of claim 1, wherein the at least one portion of the representation comprises one of:
an extended dimension taken with reference to the bounding box and with respect to the bounding boxes; or
a predetermined width from an edge of the bounding box.

10. The at least one processor of claim 1, further configured to:
train the first ML model using first data generated from the bounding boxes which are around one or more of the closed doors or the open doors of the different vehicles, wherein the first ML model is to generate an output representing the prediction of the open-door for the vehicle; and
train a second ML model using second data generated from different bounding boxes which are specifically around different types of the open doors for the different vehicles, wherein the second ML model is to generate an output representing a classification of the open-door as the specific type for the vehicle from the different types.

11. The at least one processor of claim 1, further configured to:
use a two-dimensional (2D) sensor to provide the representation in as 2D information;
use depth sensors with the representation in the 2D information to generate at least part of the representation in three-dimensional (3D) information; and
use the 2D information as input with the second ML model which is trained using the 2D information and the 3D information to perform the classification of the open-door in a 3D space.

12. One or more processors to train a machine learning (ML) model to determine a specific type of an open-door of a vehicle using different classes associated with different types of the open doors for different vehicles.

13. The one or more processors of claim 12, further to train an additional ML model to predict the open-door of the vehicle based in part on different bounding boxes for different vehicles having one or more of closed doors or open doors.

14. The one or more processors of claim 12, wherein the specific type is one of a left passenger door open, a right passenger door open, a left driver door open, a right driver door open, a left door open, a right door open, a rear door open, a moonroof or sunroof open, or a bonnet open.

15. One or more processors to determine a specific type of an open-door of a vehicle based in part on a machine learning (ML) model which is trained using different classes associated with different types of open doors for different vehicles.

16. The one or more processors of claim 15, wherein the one or more processors are comprised in at least one of:
a control system for an autonomous or semi-autonomous machine;
a perception system for the autonomous or semi-autonomous machine;
a system for performing one or more simulation operations;
a system for performing one or more digital twin operations;
a system for performing light transport simulation;
a system for performing collaborative content creation for 3D assets;
a system for performing one or more deep learning operations;
a system implemented using an edge device;
a system implemented using a robot;
a system for performing one or more generative AI operations;
a system for performing operations using one or more large language models (LLMs);
a system for performing operations using one or more vision language models (VLMs);
a system for performing operations using one or more multi-modal language models (MMLMs);
a system for performing operations using one or more vision-language-action (VLA) models;
a system for using or deploying one or more inference microservices;
a system for performing one or more conversational AI operations;
a system for generating synthetic data;
a system for presenting at least one of virtual reality content, augmented reality content, or mixed reality content;
a system incorporating one or more virtual machines (VMs);
a system implemented at least partially in a datacenter; or
a system implemented at least partially using cloud computing resources.

17. A method comprising:
predicting an open-door of a vehicle based in part on a bounding box applied to a representation of the vehicle used with a first machine learning (ML) model trained using bounding boxes for different vehicles having one or more of closed doors or open doors; and
classifying the open-door as a specific type based in part on at least one portion of the representation used with a second ML model trained with classes of different types of the open doors for the different vehicles.

18. The method of claim 17, further comprising:
training the first ML model using first data generated from the bounding boxes which are around one or more of the closed doors or the open doors of the different vehicles, wherein the first ML model is to generate an output representing the prediction of the open-door for the vehicle; and
training a second ML model using second data generated from different bounding boxes which are specifically around different types of the open doors for the different vehicles, wherein the second ML model is to generate an output representing a classification of the open-door as the specific type for the vehicle from the different types.

19. The method of claim 17, further comprising one or more of:
generating or supporting an illustration of a top-down or bird's eye view (BEV) representation the open-door of the vehicle;
performing, by a driving sub-system of an autonomous or semi-autonomous vehicle having at least one processor, a reaction to the open-door;
recommending the reaction to the open-door;
using, as the specific type for the open-door, one of a left passenger door open, a right passenger door open, a left driver door open, a right driver door open, a left door open, a right door open, a rear door open, a moonroof or sunroof open, or a bonnet open; or
performing or recommending, as the reaction, a go around, a slow drive by, a stop, or maintain a distance from the vehicle.

20. The method of claim 17, wherein the representation is comprised, in part, in two-dimensional (2D) information from a 2D sensor and wherein the method further comprises:
using depth sensors with the 2D information to generate at least part of the representation in three-dimensional (3D) information, wherein the 2D information is used as input with the second ML model which is trained using the 2D information and the 3D information to perform the classification of the open-door in a 3D space; or
using a 2D-to-3D conversion sub-system to illustrate the open-door of the vehicle in 3D information based in part on an output of the second ML model.
